(19) United States
(12) Patent Application Publication
(10) Pub. No.: US 2022/0380875 A1
(43) Pub. Date: Dec. 1, 2022

(54) SOFT MAGNETIC ALLOY AND MAGNETIC COMPONENT

(71) Applicant: TDK CORPORATION, Tokyo (JP)

(72) Inventors: Kazuhiro YOSHIDOME, Tokyo (JP); Hiroyuki MATSUMOTO, Tokyo (JP); Akito HASEGAWA, Tokyo (JP); Hironobu KUMAOKA, Tokyo (JP)

(73) Assignee: TDK CORPORATION, Tokyo (JP)

(21) Appl. No.: 17/622,526

(22) PCT Filed: May 13, 2021
(86) PCT No.: PCT/JP2021/018300

§ 371 Date: Dec. 23, 2021

(30) Foreign Application Priority Data
Sep. 30, 2020 (JP) 2020-165903

(51) Int. Cl. C22C 38/52; C22C 38/04; C22C 38/00; H01F 1/153; H01F 1/20

(52) U.S. Cl. CPC C22C 38/52; C22C 38/04; C22C 38/002; H01F 1/15308; H01F 1/20; C22C 2202/02; B22F 1/08

(57) ABSTRACT

A soft magnetic alloy and the like which simultaneously satisfy a high saturation magnetic flux density Bs and a high corrosion resistance. A soft magnetic alloy includes Mn and a component expressed by a compositional formula of ((Fe_{(1-(α+β))}Co_{α}Ni_{β})_{1-γ}X1_{γ})_{(1-(a+b+c+d+e))}BₐP_{b}Si_{c}C_{d}Crₑ (atomic ratio). X1 is one or more selected from Ti, Zr, Hf, Nb, Ta, Mo, W, Al, Ga, Ag, Zn, S, Ca, Mg, V, Sn, As, Sb, Bi, N, O, Au, Cu, rare earth elements, and platinum group elements. Further, a to e and α to γ are within predetermined ranges. Mn amount f (at %) is within a range of 0.002≤f<3.0. The soft magnetic alloy satisfies a corrosion potential of −630 mV or more and −50 mV or less and a corrosion current density of 0.3 μA/cm² or more and 45 μA/cm² or less.

### TECHNICAL FIELD

The present invention relates to a soft magnetic alloy and a magnetic component.

### BACKGROUND

Patent Document 1 discloses an invention relating to a high corrosion resistance amorphous alloy. Patent Document 2 discloses an invention relating to an amorphous soft magnetic alloy. Patent Document 3 discloses an invention relating to an amorphous alloy powder.

[Patent Document 1] JP Patent Application Laid Open No. 2009-293099

[Patent Document 2] JP Patent Application Laid Open No. 2007-231415

[Patent Document 3] JP Patent Application Laid Open No. 2014-167139

### SUMMARY

In order to attain a high saturation magnetic flux density Bs, a method of increasing a Fe amount is generally known. However, when the Fe amount is increased, a corrosion resistance tends to decrease easily.

The object of the present invention is to provide a soft magnetic alloy and the like which simultaneously achieves both a high saturation magnetic flux density Bs and a high corrosion resistance.

In order to achieve the above object, the soft magnetic alloy according to the present invention includes Mn and a component expressed by a compositional formula of ((Fe_{(1-(α+β))}Co_{α}Ni_{β})_{1-γ}X1_{γ})_{(1-(a+b+c+d+e>>}BₐP_{b}Si_{c}C_{d}Crₑ (atomic ratio), wherein

Mn amount f (at %) is within a range of 0.002≤f<3.0,

X1 is one or more selected from Ti, Zr, Hf, Nb, Ta, Mo, W, Al, Ga, Ag, Zn, S, Ca, Mg, V, Sn, As, Sb, Bi, N, O, Au, Cu, rare earth elements, and platinum group elements,

a, b, c, d, e, α, β, and γ of the compositional formula are within in ranges of

0.020≤a≤0.200,

0≤b≤0.070,

0≤c≤0.100,

0≤d≤0.050,

0≤e≤0.040,

0.005≤α≤0.700,

0≤β≤0.200,

0≤γ<0.030, and

0.720≤1−(a+b+c+d+e)≤0.900; and

the soft magnetic alloy satisfies a corrosion potential of −630 mV or more and −50 mV or less and a corrosion current density of 0.3 μA/cm² or more and 45 μA/cm² or less which are calculated by Tafel extrapolation method from potential and current measured using LSV method in 0.5 mol/L of NaCl solution when a natural potential is a standard potential, a range of measuring potential is −0.3 V to 0.3 V, and a potential scanning rate is 0.833 mV/s.

In the soft magnetic alloy, 0.003≤f/α(1−γ){1−(a+b+c+d+e)}≤710 may be satisfied.

In the soft magnetic alloy, 0.050≤α≤0.600 may be satisfied.

In the soft magnetic alloy, 0.100≤α≤0.500 and 0.050≤f/α(1−γ){1−(a+b+c+d+e)}≤8.0 may be satisfied.

In the soft magnetic alloy, 0.001≤e≤0.020 and 1.00≤α(1−γ){1−(a+b+c+d+e)}×e×10000≤50.0 may be satisfied.

In the soft magnetic alloy, 0≤b≤0.050 may be satisfied.

In the soft magnetic alloy, 0.780≤1−(a+b+c+d+e)≤0.890 may be satisfied.

In the soft magnetic alloy, 0.001≤β≤0.050 may be satisfied.

In the soft magnetic alloy, 0<γ<0.030 may be satisfied.

In the soft magnetic alloy, an amorphous ratio X shown by below formula (1) may satisfy 85% or more.

X=100−(Ic/(Ic+Ia)×100) (1)

Ic: Crystal scattering integrated intensity

Ia: Amorphous scattering integrated intensity

The soft magnetic alloy according may be in a form of powder.

Particles included in the soft magnetic alloy which is in a form of powder may have an average Wadell's circularity of 0.80 or more.

A magnetic component made of the soft magnetic alloy according to the present invention.

### BRIEF DESCRIPTION OF THE DRAWINGS

FIG. 1 is an example of a chart obtained from X-ray crystallography.

FIG. 2 is an example of a pattern obtained by carrying out profile fitting the chart of FIG. 1.

FIG. 3 is an example of a photo taken after carrying out 60 minutes of an immersion test to a soft magnetic alloy ribbon which does not include Co.

FIG. 4 is an example of a photo taken after carrying out 60 minutes of an immersion test to a soft magnetic alloy ribbon which includes Co.

FIG. 5 is a graph showing differences in circularities depending on a presence of Mn and an amount of Co.

### DETAILED DESCRIPTION

Hereinafter, the embodiment of the present invention is described.

A soft magnetic alloy according to the present embodiment includes Mn and a component expressed by a compositional formula of ((Fe_{(1-(α+β))}Co_{α}Ni_{β})_{1-γ}X1_{γ})_{(1-(a+b+c+d+e>>}BₐP_{b}Si_{c}C_{d}Crₑ (atomic ratio), wherein

Mn amount f (at %) is within a range of 0.002≤f<3.0,

X1 is one or more selected from Ti, Zr, Hf, Nb, Ta, Mo, W, Al, Ga, Ag, Zn, S, Ca, Mg, V, Sn, As, Sb, Bi, N, O, Au, Cu, rare earth elements, and platinum group elements,

a, b, c, d, e, α, β, and γ of the compositional formula are within in ranges of

0.020≤a≤0.200,

0≤b≤0.070,

0≤c≤0.100,

0≤d≤0.050,

0≤e≤0.040,

0.005≤α≤0.700,

0≤β≤0.200,

0≤γ<0.030, and

0.720≤1−(a+b+c+d+e)≤0.900.

The above-mentioned composition is particularly characterized by including Co and Mn within predetermined ranges. The soft magnetic alloy having the above-mentioned composition becomes a soft magnetic alloy having a high saturation magnetic flux density Bs and a high corrosion resistance.

The saturation magnetic flux density Bs may be 1.5 T or more.

Regarding the corrosion resistance, specifically, a corrosion potential is −630 mV or more and −50 mV or less and a corrosion current density is 0.3 μA/cm² or more and 45 μA/cm² or less which are calculated by Tafel extrapolation method from potential and current measured using LSV method in 0.5 mol/L of NaCl solution when a natural potential is a standard potential, a range of measuring potential is −0.3 V to 0.3 V, and a potential scanning rate is 0.833 mV/s.

Hereinbelow, a method of measuring the corrosion potential and a method of measuring the corrosion current density are described.

First, as the soft magnetic alloy used for a measurement, a soft magnetic alloy ribbon having a width of 4 to 6 mm and a thickness of 15 to 25 μm produced by the following method is used. Next, a surface of the soft magnetic alloy is ultrasonic cleaned for 1 minute in 99% denatured ethanol, then 1 minute of ultrasonic cleaning is performed using acetone. Further, a size of the surface of the soft magnetic alloy which is immersed in NaCl solution described in below has width of 4 to 6 mm x length of 9 to 11 mm.

Next, the corrosion potential and a corrosion current of the obtained soft magnetic alloy are measured. For measuring the corrosion potential and the corrosion current, an electrochemical measuring instrument which can be measured by LSV method is used. For example, the measurement may be performed by Tafel extrapolation method using SP-150 which is a potentio-galvanostat made by Bio-Logic and using a software “EC-Lab” which is a software made by Bio-Logic.

Specifically, the soft magnetic alloy is used as a working electrode and immersed in 0.5 mol/L of NaCl solution (25° C.). 10 mL of NaCl solution is poured into an electrochemical test cell made of glass. The electrochemical test cell being used has an outer diameter of 28 mm, a height of 45 mm, and an interelectrode distance of 13 mm. For example, VB2 (made by EC FRONTIER CO., LTD.) which is an electrochemical test cell made of PYREX® is used. As a counter electrode, Pt is used which has a surface area of about the size that does not interfere a reaction rate of the working electrode. The upper limit of the surface area of the counter electrode is not particularly limited. That is, even if the surface area of the counter electrode is enlarged, the corrosion potential and the corrosion current do not change. As a reference electrode, an Ag/AgCl electrode is immersed in oversaturated KCl solution.

After immersing the soft magnetic alloy in a NaCl solution, it is kept still for 20 minutes in order to remove the current flow of NaCl solution. The natural potential after being kept still for 20 minutes is used as a standard potential, and a measuring range is −0.3 V to 0.3 V. A potential and a current are measured using LSV method by a potential scanning rate of 0.833 mV/s in a direction from a basic potential towards a noble potential. From the obtained potential and current, the corrosion potential and the corrosion current are calculated using Tafel extrapolation method. A corrosion potential is a potential having a smallest absolute value of current detected near a natural potential. The corrosion current is obtained from an interception point between a straight line extending vertical from the corrosion potential and a Tafel straight line described in below. The corrosion current density is calculated by a corrosion current per unit area which is obtained from the corrosion current and the surface area of a test sample being measured. Note that, the surface area of the test sample is a total surface area of all parts immersed in the NaCl solution.

Note that, a cathode reaction side is used for the Tafel straight line extrapolated by Tafel extrapolation method. If an anode reaction side is used, obtaining a Tafel straight line is difficult because of the influence from products due to corrosion.

Hereinbelow, relationship between the above-mentioned composition (particularly amounts of Co, Mn, and Cr) and the corrosion resistance of the soft magnetic alloy is described.

First, when a soft magnetic alloy which includes none of Co, Mn, and Cr is immersed in water, rust is formed almost at the same time over the entire surface of the soft magnetic alloy in short period of time. For example, Sample No. 1 which is described in the below section of EXAMPLES exhibited the corrosion potential which was too low, and the corrosion current density which was too high.

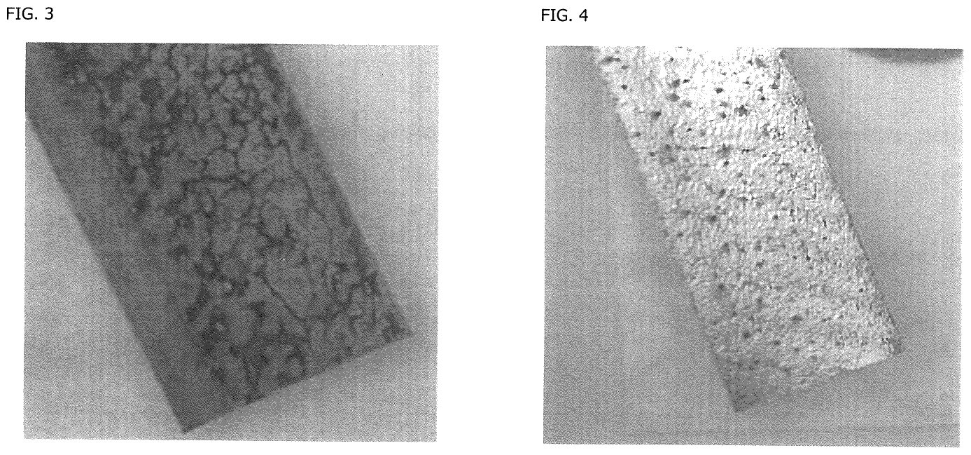

When the soft magnetic alloy having a composition added with Cr to the above-mentioned composition (a composition in which Fe is partially substituted by Cr) is immersed in water, numerous rust spots are formed to the soft magnetic alloy. That is, corrosions are formed unevenly to the soft magnetic alloy. Also, as Cr amount increases, it is known that Bs has tendency to decrease. Specifically, it is known that 0.05 to 0.1 T or so of Bs tends to decrease per 1 at % of Cr. Also, for Cr to exhibit a corrosion resistance improvement effect, it is known that about 5 at % or more of Cr needs to be added. For example, FIG. 3 shows a result of performing 60 minutes of an immersion test to the soft magnetic alloy ribbon including about 1 at % of Cr and not including Co. FIG. 3 is a soft magnetic alloy which corresponds to Sample No. 167 as a comparative example described in below. FIG. 3 shows that a large reddish brown rust is formed over the entire surface of the soft magnetic alloy ribbon. Note that, the immersion test of the soft magnetic alloy is carried out by performing ultrasonic cleaning for 1 minute in 99% denatured ethanol followed by performing ultrasonic cleaning for 1 minute in acetone, then immersing the soft magnetic alloy in distilled water.

Here, when a soft magnetic alloy having a composition added with Co instead of Cr is immersed (a composition in which Fe is partially substituted by Co) in distilled water, it takes longer time to form rust spots compared to a soft magnetic alloy having a composition in which Cr is added but Co is not added. This is because by partially substituting Fe by Co, the corrosion potential of the soft magnetic alloy increases, and it is thought that the corrosion current density decreased. As the corrosion potential increases, corrosion tends to be formed less; and as the corrosion current density decreases, a corrosion rate tends to decrease easily. For example, when Fe of Sample No. 1 is partially substituted by Co, such as in case of Sample No. 13 and Sample No. 25, the corrosion potential has increased and the corrosion current density has decreased compared to Sample No. 1.

When Fe is partially substituted by Co and also Fe is partially substituted by Cr, rust spots decrease even more. This is because when part of Fe in the soft magnetic alloy including Co is substituted by Cr, the corrosion potential increases slightly, and the corrosion current density is thought to decrease significantly. For example, FIG. 4 shows result of performing 60 minutes of an immersion test to a soft magnetic alloy ribbon including about 1 at % of Cr in which Fe is partially substituted by Co. FIG. 4 is a soft magnetic alloy which corresponds to Sample No. 173 as one of examples described in below. As shown in FIG. 4, only several rust spots are formed to the soft magnetic alloy ribbon. The large reddish brown rust spot covering the entire surface of the soft magnetic alloy ribbon which does not include Co as shown in FIG. 3 is not formed.

Here, the corrosion potential increases when 0.002 at % or more and less than 3.0 at % of Mn is added to the soft magnetic alloy.

When Fe is not partially substituted by Co, a degree of increase of the corrosion potential and a degree of decrease in the corrosion current density caused by addition of Mn are small. Therefore, even if Mn is added, the corrosion resistance of the soft magnetic alloy is barely influenced.

However, when Fe is partially substituted by Co within the above-mentioned range, a degree of increase of the corrosion potential and a degree of decrease of the corrosion current density caused by addition of Mn become larger. Further, the corrosion resistance of the soft magnetic alloy increases. Also, when Fe is partially substituted by Co, Bs also increases, however if the substitution amount is too much, Bs decreases.

Hereinbelow, each component of the soft magnetic alloy according to the present embodiment is described in details.

A B amount (a) is within a range of 0.020≤a≤0.200. From the point of improving Bs, the B amount (a) may preferably be within a range of 0.020≤a≤0.150. From the point of improving the corrosion resistance, the B amount (a) may particularly preferably be within a range of 0.050≤a≤0.200. That is, the B amount (a) may preferably be within a range of 0.050≤a≤0.150. If the B amount (a) is too large, Bs tends to decrease easily.

A P amount (b) is within a range of 0≤b≤0.070. That is, P may not be included. The P amount (b) may preferably be within a range of 0≤b≤0.050. Also, from the point of improving the corrosion resistance, the P amount (b) may preferably be 0.001 or more; and from the point of improving Bs, the P amount (b) may preferably be 0.050 or less. As the P amount (b) increases, the corrosion resistance tends to increase; and when the P amount (b) is too large, Bs tends to decrease.

A Si amount (c) is within a range of 0≤c≤0.100. That is, Si may not be included. The Si amount (c) may preferably be within a range of 0≤c≤0.070. When c is too large, Bs tends to decrease easily. Further, as c increases within the above-mentioned range, the corrosion resistance tends to increase. However, when the Si amount (c) is too large, an increase rate of the corrosion potential due to having Co tends to become small, and the decrease in the corrosion current density due to having Co tends to become difficult to attain. As a result, an improvement effect of the corrosion resistance caused by having Co tends to decrease.

A C amount (d) is within a range of 0≤d≤0.050. That is, C may not be included. The C amount (d) may preferably be within a range of 0≤d≤0.030, and more preferably 0≤d≤0.020. When the C amount (d) is too large, Bs tends to decrease easily.

A Cr amount (e) is within a range of 0≤e≤0.040. That is Cr may not be included. The Cr amount (e) may preferably be within a range of 0≤e≤0.020, and may be within a range of 0.001≤e≤0.020. As the Cr amount (e) increases, the corrosion resistance tends to improve, however when the Cr amount (e) is too large, Bs tends to decrease easily.

A Co amount (α) with respect to Fe is within a range of 0.005≤α≤0.700. The Co amount (α) with respect to Fe may preferably be within a range of 0.010≤α≤0.600, may be within a range of 0.030≤α≤0.600, and may be within a range of 0.050≤α≤0.600. By having the Co amount (α) with respect to Fe within the above-mentioned range, Bs and the corrosion resistance improve. From the point of improving Bs, the Co amount (α) with respect to Fe may preferably be within a range of 0.050≤α≤0.500. As the Co amount (α) with respect to Fe increases, the corrosion resistance tends to improve, however when the Co amount (α) with respect to Fe is too large, Bs tends to decrease easily.

Further, when the Co amount (α) with respect to Fe is 0.500 or less, or the B amount (a) is 0.150 or less, Bs tends to become 1.50 T or more.

A Ni amount (β) with respect to Fe is within a range of 0≤β≤0.200. That is, Ni may not be included. The Ni amount (β) with respect to Fe may be within a range of 0.005≤β≤0.200. From the point of improving Bs, the Ni amount (β) with respect to Fe may be within a range of 0≤β≤0.050, may be within a range of, 0.001≤β≤0.050, and may be within a range of 0.005≤β≤0.010. As the Ni amount (β) with respect to Fe increases, the corrosion resistance tends to improve, however when the Ni amount (β) with respect to Fe is too large, Bs decreases.

X1 is one or more selected from Ti, Zr, Hf, Nb, Ta, Mo, W, Al, Ga, Ag, Zn, S, Ca, Mg, V, Sn, As, Sb, Bi, N, O, Au, Cu, rare earth elements, and platinum group elements. X1 may be one or more selected from Ti, Zr, Hf, Nb, Ta, Mo, W, Al, Ga, Ag, Zn, S, Ca, Mg, V, Sn, As, Sb, Bi, N, O, Au, rare earth elements, and platinum group elements. Note that, the rare earth elements include Sc, Y, and lanthanoids. The platinum group elements include Ru, Rh, Pd, Os, Ir, and Pr. X1 may be included as impurities, or it may be intentionally added. A X1 amount (γ) is within a range of 0≤γ<0.030. That is, less than 3.0% of a total amount of Fe, Co, and Ni may be substituted by X1.

The X1 amount (γ) may be within a range of 0<γ<0.030.

Particularly, when the soft magnetic alloy is in a form of ribbon, the X1 amount (γ) may be within a range of 0≤γ≤0.028. Also, particularly when the soft magnetic alloy is in a form of powder, the X1 amount (γ) may be within a range of 0.000≤γ≤0.028.

A total amount (1−(a+b+c+d+e)) of Fe, Co, Ni, and X1 is within a range of 0.720≤1−(a+b+c+d+e)<0.900. The total amount (1−(a+b+c+d+e)) of Fe, Co, Ni, and X1 may be within a range of 0.780≤1−(a+b+c+d+e)≤0.890. When the above-mentioned formula is satisfied, Bs tends to improve easily.

Further, 0.001≤e≤0.020 and 1.00≤α(1−γ){1−(a+b+c+d+e)}×e×10000≤50.0 may be satisfied. That is, the product of the Co amount and the Cr amount may be within a specific range. When the above formulae are satisfied, a high corrosion resistance and a high Bs tend to be both achieved easily.

The soft magnetic alloy according to the present embodiment includes Mn in addition to the composition expressed by the compositional formula of ((Fe_{(1-(α+β))}Co_{α}Ni_{β})_{1-γ}X1_{γ})_{(1-(a+b+c+d+e>>}BₐP_{b}Si_{c}C_{d}Crₑ (atomic ratio). Further, a Mn amount f (at %) is within a range of 0.002≤f<3.0. Note that, the Mn amount is an amount with respect to a total amount of Fe, Co, Ni, X1, B, P, Si, C, and Cr. By having the Mn amount within the above-mentioned range, Bs and the corrosion resistance improve. When Mn amount is too small, the corrosion resistance decreases. When Mn amount is too large, the soft magnetic alloy tends to include coarse crystals and the corrosion resistance decreases.

Also, when the Mn amount is represented by f (at %), 0.003≤f/α(1−γ){1−(a+b+c+d+e)}<710 may be satisfied. That is, the Mn amount ratio to the Co amount with respect to the component expressed by the above-mentioned compositional formula may be within the above-mentioned range.

Further, when the soft magnetic alloy is in a form of powder, circularities of the particles described in below tends to increase easily compared to the case of including Co but not including Mn.

In general, when a soft magnetic alloy powder is produced, the soft magnetic alloy powder is easily affected by an amount of oxygen in a molten compared to the case of producing a soft magnetic alloy ribbon. Further, when the molten includes oxygen, the circularities of the particles described in below tend to decrease easily. Here, when the soft magnetic alloy powder includes Mn, an oxygen amount in the molten tends to be low when the powder is produced by a gas atomization and the like since Mn has a deoxidizing effect. Further, as the oxygen amount decreases, the circularities of the particles described in below tend to increase easily.

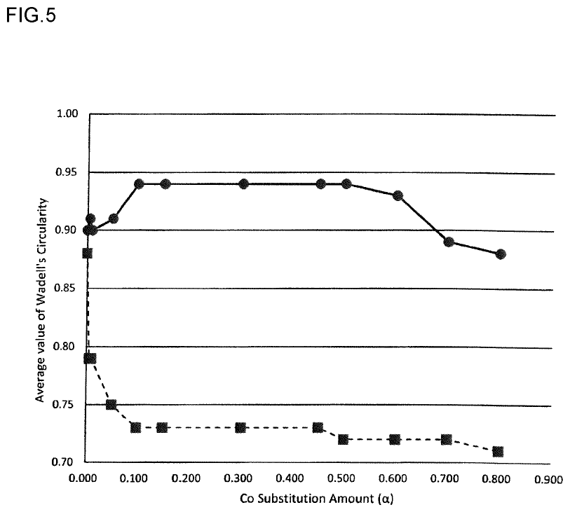

FIG. 5 is a graph showing the composition when f is f=0 (broken line) and when f is f=0.040 (bold line) of Experiment examples of the soft magnetic alloy powders shown in Table 1A to Table 1M. As apparent from the graph, when Mn is not included, the circularities of the particles significantly decrease by including Co. That is, it is difficult to increase the circularities of the particles when Mn is not included and Co is only included. On the contrary to this, when Mn is included, the circularities are maintained good even if Co is included.

The soft magnetic alloy according to the present embodiment may include elements other than mentioned in above as inevitable impurities. For example, 0.1 mass % or less of the inevitable impurities may be included with respect to 100 mass % of the soft magnetic alloy.

Also, the soft magnetic alloy according to the present embodiment may preferably have an amorphous ratio X shown in below of 85% or more. When the soft magnetic alloy has a structure having a high amorphous ratio X, the corrosion potential tends to increase easily and the corrosion current density tends to decrease easily compared to a structure having a low amorphous ratio X. Thus, the corrosion resistance of the soft magnetic alloy tends to increase easily.

X=100−(Ic/(Ic+Ia)×100) (1)

Ic: Crystal scattering integrated intensity

Ia: Amorphous scattering integrated intensity

The structure having a high amorphous ratio X is a structure constituted mostly by amorphous or heteroamorphous. The structure made by heteroamorphous is a structure of which crystals exist inside amorphous. Note that, an average crystal size of the crystals is not particularly limited, and it may be about 0.1 nm or more and 100 nm or less. Also, the crystal size of the crystal due to the Ic (Crystal scattering integrated intensity) component during XRD measurement is not particularly limited.

X ray crystallography is performed to the soft magnetic alloy powder by using XRD, and phases are identified to read peaks of crystallized Fe or crystallized compounds (Ic: Crystal scattering integrated intensity, Ia: Amorphous scattering integrated intensity). Then, a crystallization ratio is determined from these peaks, and the amorphous ratio X is calculated from the above-mentioned formula (1). In below, the method of calculation is described in further detail.

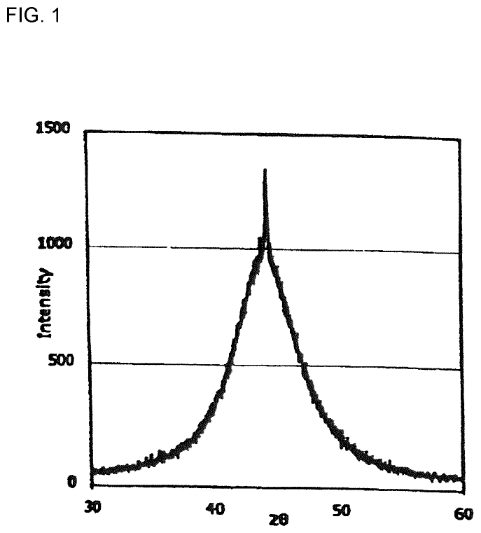

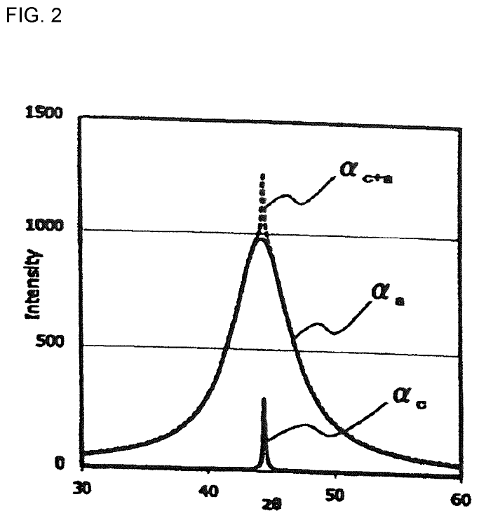

Regarding the soft magnetic metal according to the present embodiment, X ray crystallography is performed by XRD to obtain a chart shown in FIG. 1. Then, profile fitting is performed to this chart using a Lorenz function shown by below formula (2). Thereby, as shown in FIG. 2, a crystal component pattern α_{c} which indicates a crystal scattering integrated intensity, an amorphous component pattern αₐ which indicates an amorphous scattering integrated intensity, and a pattern α_{c+a} which is a combination of these are obtained. According to the obtained crystal scattering integrated intensity pattern and the amorphous scattering integrated intensity pattern, the amorphous ratio X is obtained using the above-mentioned formula (1). Note that, as a range of measurement, the range is within a diffraction angle of 2θ=30° to 60° in which a halo derived from amorphous can be confirmed. Within this range, a difference between the integrated intensity obtained from actual measurement by XRD and the integrated intensity calculated using a Lorenz function is set within 1%.

$$\begin{matrix}[ Formula 1 ] & \\ f ( x ) = \frac{h}{1 + \frac{{( x - u )}^{2}}{{w}^{2}}} + b & ( 2 )\end{matrix}$$

h: Peak height
u: Peak position
w: Half bandwidth
b: Background height

A form of the soft magnetic alloy is not particularly limited, and it may be in a form of powder.

The corrosion potential and the corrosion current density cannot be measured from the soft magnetic alloy in a form of powder (soft magnetic alloy powder). In the present embodiment, the corrosion potential and the corrosion current density of the soft magnetic alloy powder satisfying 0≤γ<0.030 is considered to have the same corrosion potential and the corrosion current density of a soft magnetic alloy ribbon having the same amorphous ratio and composition except that the oxygen amount in terms of γ is set to be 0.003 or less. Hereinafter, the soft magnetic alloy ribbon having the same amorphous ratio and composition except that the oxygen amount in terms of γ is set to be 0.003 or less is referred as a soft magnetic alloy ribbon for measurement.

Also, even if the oxygen amount is varied within the range of 0≤γ<0.030 when the oxygen amount is in terms of γ, various properties do not change significantly. Particularly, Bs is the same whether the soft magnetic alloy is in a form of powder or ribbon. Therefore, usually, the oxygen amount in terms of γ may be considered γ=0.

A method of production of the soft magnetic alloy ribbon for measurement is described.

The soft magnetic alloy ribbon for measurement is produced by a single roll method.

First, a pure substance of each element is prepared and weighed so that the soft magnetic alloy ribbon for measurement having the aiming composition can be obtained at the end. Then, the pure substance of each element is melted to form a mother alloy. Note that, a method of melting the pure substance is not particularly limited, and for example, a method of melting by using a high frequency heating after vacuuming the inside of a chamber may be mentioned. Note that, usually, the mother alloy and the soft magnetic alloy ribbon for measurement obtained at the end have the same compositions.

Next, the produced mother alloy is heated and melted to obtain a molten. A temperature of the molten is 1000 to 1500° C.

In a single roll method, a thickness of the soft magnetic alloy ribbon for measurement can be regulated mainly by adjusting a rotation speed of a roll. Further, the thickness of the soft magnetic alloy ribbon for measurement can also be regulated by adjusting a space between a nozzle and a roll, by adjusting a temperature of the molten, and so on. The thickness of the soft magnetic alloy ribbon for measurement may be 15 to 30 μm.

A temperature of the roll is 20 to 30° C., the rotation speed of the roll is 20 to 30 m/sec, and atmosphere inside the chamber is in the air. Also, a material of the roll is Cu.

Also, by performing heat treatment to the obtained soft magnetic alloy ribbon for measurement, nanocrystals may precipitate and the amorphous ratio can be decreased. By controlling a heat treatment temperature, a heat treatment time, and atmosphere during the heat treatment, and the like, the desired amorphous ratio can be achieved.

The soft magnetic alloy ribbon for measurement is stored under a temperature range of 20° C. to 25° C. in an inert atmosphere such as Ar atmosphere. Further, the corrosion potential and the corrosion current density are measured within 24 hours after the production of the soft magnetic alloy ribbon for measurement.

When the soft magnetic alloy ribbon for measurement is left in active atmosphere, or when it is left in inert atmosphere for long period time, the surface may be oxidized in some cases. When the surface of the soft magnetic alloy ribbon for measurement is oxidized, a passive film may be formed to the surface of the soft magnetic alloy ribbon for measurement in some cases. Further, due to the passive film formed to the surface of the soft magnetic alloy ribbon for measurement, the corrosion potential and the corrosion current density of the soft magnetic alloy ribbon for measurement may change. Thus, the soft magnetic alloy ribbon for measurement is stored in inert atmosphere, and the corrosion potential and the corrosion current density need to be measured without leaving for long period of time after being produced.

The particles included in the soft magnetic alloy powder may have an average Wadell circularity of 0.80 or more. As the average Wadell circularity approaches closer to 1, a shape of the particles included in the soft magnetic alloy powder becomes closer to sphere. Further, the soft magnetic alloy powder having a high average Wadell circularity, for example, tend to have an improved packing property of the powder when a magnetic core is produced. Further, a permeability of the obtained magnetic core tends to improve easily.

The average particle size of the soft magnetic alloy powder is not particularly limited. For example, it may be 1 μm or more and 150 μm or less.

The average Wadell's circularity and the average particle size of the particles included in the soft magnetic alloy powder are evaluated by a Morphologi G3 (made by Malvern Panalytical Ltd). A Morphologi G3 is a device which disperses the powder, and a shape of individual particle is projected, thereby evaluation can be carried out. The particle shape having a particle size approximately within a range of 0.5 μm to several mm by an optical microscope or a laser microscope can be evaluated by a Morphologi G3. Also, when a Morphologi G3 is used, a projection of particle shapes of many particles can be evaluated in one time.

Since a Morphologi G3 can make a projection of many particles in one time for evaluation, shapes of many particles can be evaluated in shorter time compared to a conventional evaluation method such as SEM observation and the like. For example, projections of 20000 particles are produced, and a particle size and a circularity of each particle are automatically calculated, and an average circularity and an average particle size of the particles are calculated. On the contrary to this, it is difficult to evaluate shapes of many particles in short period of time by a conventional SEM observation.

A Wadell's circularity is defined by a ratio of a circle equivalent diameter/a diameter of circumscribed circle in a projection. The circle equivalent diameter is a diameter of a circle having an area equivalent to projected area of the particle cross section. The diameter of circumscribed circle is a diameter of a circle circumscribed to the particle cross section.

Also, a general calculation method of a particle size (particle size distribution) is volume-based. On the contrary to this, when the particle size (particle size distribution) is evaluated using a Morphologi G3, a particle size (particle size distribution) can be evaluated in terms of a volume-based or a number-based.

Also, the average particle size of the soft magnetic alloy powder can be measured by a particle size analyzer using laser diffraction method. In the present embodiment, a volume-based particle size distribution measured by a particle size analyzer using laser diffraction method is considered as an average particle size.

Next, a method of producing a magnetic core from the magnetic powder is described.

The magnetic core can be obtained by compacting the magnetic powder. A method of compacting is not particularly limited. As an example, a method of obtaining a magnetic core by pressure compacting is described.

First, the magnetic powder and a resin are mixed. By mixing the resin and the magnetic powder, a green compact with a higher strength can be obtained by pressure compacting. A type of the resin is not particularly limited. For example, a phenol resin, an epoxy resin, and the like may be mentioned. An amount of added resin is not particularly limited. When the resin is added, the amount of added resin may be 1 mass % or more and 5 mass % or less with respect to the magnetic powder.

A granulated powder is obtained by granulating a mixed product of the magnetic powder and the resin. A method of granulation is not particularly limited. For example, a stirrer may be used for granulation. A particle size of the granulated powder is not particularly limited.

The obtained granulated powder is pressure compacted to obtain the green compact. A compacting pressure is not particularly limited. For example, a surface pressure may be 1 ton/cm² or more and 10 ton/cm² or less. As the compacting pressure increases, the relative permeability of the obtained magnetic core tends to increase easily. However, when the magnetic powder has a broad particle size distribution, a high relative permeability of the magnetic core can be obtained even if the compacting pressure is made lower than usual compacting pressure. This is because the obtained magnetic core tends to densify easily.

Further, by curing the resin included in the green compact, the magnetic core can be obtained. A curing method is not particularly limited. A heat treatment which can cure the used resin may be performed.

Next, a method of evaluating a Wadell's circularity of the magnetic powder particles included in the magnetic core is described.

The particle size distribution and the Wadell's circularity of the magnetic powder particles included in the magnetic core can be measured by SEM observation. Specifically, a particle size (Haywood diameter) and a Wadell's circularity of each one of the magnetic powder particles included in an arbitrary cross section of the magnetic core can be calculated from SEM image. A magnification of SEM observation is not particularly limited as long as the particle sizes of the magnetic powder particles can be measured. Also, an area of the observation field for SEM observation is not particularly limited, and for example the area of the observation field may include 10 particles or more, preferably 100 particles or more, and furthermore 500 particles or more. The observation field may include 100 or more particles of the magnetic powder if possible. A plurality of observation fields may be selected from a plurality of cross sections so that a total number of the magnetic powder particles included in the observation fields are 100 particles or more.

A Wadell's circularity of a magnetic powder particle included in the magnetic cores expressed by an equation 2×(π×S)^{1/2}/L; in which S is an area of the magnetic powder particle in the cross section and L is a circumference length of a magnetic powder particle.

When the magnetic powder particles having various compositions are mixed in the magnetic core, a compositional map is obtained by EDS (Energy Dispersive X-ray analysis). The compositions of the magnetic powder particles are determined by the compositional map. Further, the compositions of the magnetic powder particles used to calculate the average value of the Wadell's circularities are extracted, and the Wadell's circularities are measured.

An average value of the Wadell's circularities of the soft magnetic alloy powder measured using a Morphologi G3 roughly matches with an average value of the Wadell's circularities of the magnetic powder particles extracted from an arbitrary cross section of the magnetic core.

In some cases, it may be difficult to measure Bs of the soft magnetic alloy powder included in the magnetic core of which the soft magnetic alloy powder, the resin, and the like are mixed. However, in such case, by measuring Bs after producing the soft magnetic alloy ribbon for measurement, Bs of the soft magnetic alloy powder included in the magnetic core can be obtained.

The corrosion potential and the corrosion current density of the soft magnetic alloy powder of the magnetic core of which the soft magnetic alloy powder, the resin, and the like are mixed can be measured by producing the soft magnetic alloy ribbon for measurement.

A method of verifying the composition of the soft magnetic alloy is not particularly limited. For example, ICP (Inductively Coupled Plasma) can be used. Also, in case the oxygen amount is difficult to determine by ICP, an impulse heat melting extraction method can be used together. When the carbon amount and the sulfur amount are difficult to determine by ICP, infrared absorption method can be used together.

Regarding, the soft magnetic alloy powder and the like included in the magnetic core of which the soft magnetic alloy powder, the resin, and the like are mixed, in some cases it may be difficult to determine the composition of the soft magnetic alloy by using ICP and the like mentioned in the above. In such case, the composition may be determined by EDS (Energy Dispersive Spectroscopy) analysis or EPMA (Energy Probe Microanalyzer) analysis using an electron microscope. Note that, in some cases, a detailed composition may be difficult to determine by EDS analysis and EPMA analysis. For example, a resin component in the magnetic core may influence the measurement. Also, in case the magnetic core requires processing, such processing itself may influence the measurement.

In case the composition is difficult to determine by the above-mentioned ICP, impulse heat melting extraction method, EDS, and the like; 3DAP (three dimensional atom probe) may be used to determine the composition. In case of using 3DAP, in the area of analysis, the composition of the soft magnetic alloy, that is the composition of the soft magnetic alloy powder can be determined by excluding the influence from the resin component, a surface oxidation, and the like. This is because a small area can be set in the soft magnetic alloy powder to measure an average composition, such as an area of φ20 nm×100 nm can be set to measure an average composition. Also, when 3DAP can be used for the measurement, the composition determined by 3DAP may only be used to produce the soft magnetic alloy ribbon for measurement; and Bs, the corrosion potential, and the corrosion current density can be measured.

A method of verifying an amorphous ratio of the soft magnetic alloy is not particularly limited. In general, as mentioned in above, X-ray crystallography by XRD measurement is performed. However, a XRD measurement is difficult for the magnetic core of which the soft magnetic alloy powder, the resin, and the like are mixed. When a XRD measurement is difficult, an amorphous ratio may be measured using an EBSD (Electron Back Scattered Diffraction). Further, an amorphous ratio may be calculated by analyzing intensities of diffraction spots using a selected area electron diffraction pattern obtained from a wide observation field of φ100 nm to φseveral μm by a transmission electron microscope (TEM).

Hereinafter, a method of producing the soft magnetic alloy according to the present embodiment is described.

The method of producing the soft magnetic alloy according to the present embodiment is not particularly limited. For example, a method of producing a ribbon of the soft magnetic alloy according to the present embodiment by a single roll method may be mentioned. Also, the ribbon may be a continuous ribbon.

In a single roll method, a pure substance of each element included in the soft magnetic alloy obtained at the end is prepared and weighed so to have the same composition as the soft magnetic alloy obtained at the end. Further, the pure substance of each element is melted to produce a mother alloy. Note that, a method of melting the pure metal is not particularly limited, and a method of melting by using a high frequency heating after vacuuming the inside of the chamber may be mentioned. Note that, the composition of the mother alloy and the composition of the soft magnetic alloy are usually the same.

Next, the produced mother alloy is heated and melted to obtain a molten. A temperature of the molten is not particularly limited, and it can be 1000° C. to 1500° C.

In a single roll method, a thickness of the obtained ribbon can be regulated mainly by adjusting a rotation speed of a roll. Further, for example, the thickness of the obtained ribbon can be regulated also by adjusting a space between the nozzle and the roll, a temperature of the molten metal, and so on. A thickness of the ribbon is not particularly limited, and for example it can be 15 to 30 μm.

A temperature of the roll, the rotation speed of the roll, and atmosphere inside the chamber are not particularly limited. The temperature of the roll may preferably be 20° C. to 30° C. so that a structure made of amorphous can be obtained easily. As the rotation speed of the roll becomes faster, an average crystal size of initial fine crystals tends to decrease. Also, by making the rotation speed to 20 to 30 m/sec, the soft magnetic alloy ribbon having a structure made of amorphous can be obtained easily. The atmosphere inside the chamber may preferably be in the air from the point of a cost.

Also, by performing the heat treatment to the soft magnetic alloy having a structure made of amorphous, nanocrystals are formed, and the amorphous ratio X can be decreased. The atmosphere during heat treatment is not particularly limited. It may be inert atmosphere such as in vacuum atmosphere or under Ar gas.

Also, as a method of obtaining the soft magnetic alloy according to the present embodiment, other than a single roll method mentioned in above, for example, a method of obtaining the soft magnetic alloy powder according to the present embodiment by a water atomization method or a gas atomization method may be mentioned.

In a gas atomization method, a molten alloy of 1000° C. to 1500° C. is obtained as similar to the single roll method mentioned in above. Then, the molten alloy is sprayed in the chamber to produce a powder. Specifically, when the melted mother alloy is exhausted from an exhaust port towards a cooling part, a high-pressured gas is sprayed to the exhausted molten metal drop. The molten metal drop is cool solidified by colliding against the cooling part (cooling water), thereby the soft magnetic alloy powder is formed. By changing the amount of the molten metal drop when the powder is formed, the amorphous ratio X can be changed. As the amount of the molten metal drop increases, the amorphous ratio X tends to decrease.

Further, the amorphous ratio X can also decrease by producing nanocrystals by performing heat treatment to the soft magnetic alloy powder having a structure made of amorphous. The atmosphere during the heat treatment is not particularly limited. The heat treatment may be performed under inert atmosphere such as in vacuum or Ar gas.

In the gas atomization method, Mn may be added after obtaining the molten. By adding Mn to the obtained molten, effect of deoxidization of the molten tends to be exhibited easily. Further, a viscosity of the molten tends to decrease easily. As the viscosity of the molten decreases, an average value of the Wadell's circularities tends to increase easily.

By changing the oxygen concentration in the spraying gas, the oxygen amount in the obtained soft magnetic alloy powder can be changed. Note that, a type of the spraying gas is not particularly limited, and N₂ gas, Ar gas, and the like may be mentioned.

Note that, it is difficult to obtain 0.80 or more of the average Wadell's circularity by producing the soft magnetic alloy powder through pulverizing the soft magnetic alloy ribbon.

Hereinabove, an embodiment of the present invention has been described, however the present invention is not limited to the above-described embodiment.

A form of the soft magnetic alloy according to the present embodiment is not particularly limited. As mentioned in above, a ribbon form and a powder form may be mentioned, and other than these, a block form may be mentioned.

The use of the soft magnetic alloy according to the present embodiment is not particularly limited. For example, magnetic components may be mentioned, and among these, a magnetic core, an inductor, and the like may be particularly mentioned.

Particularly, when the magnetic core is produced by using the soft magnetic alloy powder having an amorphous ratio X of 85% or more, a magnetic core having a low iron loss and a high relative permeability can be obtained.

### EXAMPLES

Hereinbelow, the present invention is described in detail based on examples.

### Experiment Example 1

Raw material metals were weighed to form alloy compositions of examples and comparative examples shown in Table 1 to Table 12, then the raw material metals were melted by high frequency heating to produce a mother alloy.

Then, the produced mother alloy was melted to form metal in a molten state of 1300° C., the metal was sprayed to a roll using single roll method of which the roll at 30° C. in the air was rolled at a rotation speed of 25 m/sec, thereby a ribbon was formed. A thickness of the ribbon was 20 to 25 μm, a width of the ribbon was about 5 mm, and a length of the ribbon was about 10 m. A material of the single roll was Cu.

Sample No. 625, 627, and 629 of Table 10 were heat treated to precipitate nanocrystals having crystal sizes of 30 nm or less, and an amorphous ratio X was decreased to 10%. Specifically, the heat treatment was performed at 400° C. to 650° C. for 10 to 60 minutes.

Each obtained ribbon was performed with X-ray crystallography, and an amorphous ratio X was measured. When the amorphous ratio X was 85% or more, the ribbon was considered formed of amorphous. When the amorphous ratio X was less than 85% and the average crystal size was 30 nm or less, then the ribbon was considered formed of nanocrystals. When the amorphous ratio X was less than 85% and the average crystal size was more than 30 nm, the ribbon was considered formed of crystals. Results are shown in below Tables.

ICP analysis confirmed that the composition of the mother alloy was about the same as the composition of the ribbon.

### <Saturation Magnetic Density Bs>

Bs of each ribbon was measured. Bs was measured using a Vibrating Sample Magnetometer (VSM) at a magnetic field of 1000 kA/m. When Bs was 1.50 T or more, it was considered good.

### <Corrosion Potential Ecorr and Corrosion Current Density Icorr>

After processing each ribbon, it was immersed in NaCl solution to measure corrosion potential and corrosion current density. Note that, a ribbon having a thickness of 20 to 25 μm and a width of about 5 mm was used, and the ribbon was processed accordingly so that a part immersed in NaCl solution had a thickness of 20 to 25 μm, a width of about 5 mm, and a length of 10 mm. Note that, the thickness of the ribbon was measured using a micrometer, a width and a length of the ribbon were measured using a digital microscope to calculate a surface area of the part immersed in NaCl solution. The corrosion potential of −630 mV or more was considered good, and the corrosion current density of 45 μA/cm² or less was considered good.

TABLE 1A

| | | (Fe_{(1-α)}Co_{α})_{(1-(a+b+c+d+e))}BₐP_{b}Si_{c}C_{d}Crₑ | | | | | | | |
|---|---|---|---|---|---|---|---|---|---|
| | Example/ | (β = 0) | | | | | | Mn | f /α{1 − |
| Sample | Comparative | | B | P | Si | C | Cr | f | (a + b + |
| No. | example | α | a | b | c | d | e | (at %) | c + d + e)} |
| 1 | Comparative | 0.000 | 0.110 | 0.020 | 0.030 | 0.010 | 0.000 | 0.000 | — |
| | example | | | | | | | | |
| 2 | Comparative | 0.000 | 0.110 | 0.020 | 0.030 | 0.010 | 0.000 | 0.002 | — |
| | example | | | | | | | | |
| 3 | Comparative | 0.000 | 0.110 | 0.020 | 0.030 | 0.010 | 0.000 | 0.005 | — |
| | example | | | | | | | | |
| 4 | Comparative | 0.000 | 0.110 | 0.020 | 0.030 | 0.010 | 0.000 | 0.015 | — |
| | example | | | | | | | | |
| 5 | Comparative | 0.000 | 0.110 | 0.020 | 0.030 | 0.010 | 0.000 | 0.025 | — |
| | example | | | | | | | | |
| 6 | Comparative | 0.000 | 0.110 | 0.020 | 0.030 | 0.010 | 0.000 | 0.040 | — |
| | example | | | | | | | | |
| 7 | Comparative | 0.000 | 0.110 | 0.020 | 0.030 | 0.010 | 0.000 | 0.080 | — |
| | example | | | | | | | | |
| 8 | Comparative | 0.000 | 0.110 | 0.020 | 0.030 | 0.010 | 0.000 | 0.100 | — |
| | example | | | | | | | | |
| 9 | Comparative | 0.000 | 0.110 | 0.020 | 0.030 | 0.010 | 0.000 | 1.000 | — |
| | example | | | | | | | | |
| 10 | Comparative | 0.000 | 0.110 | 0.020 | 0.030 | 0.010 | 0.000 | 2.000 | — |
| | example | | | | | | | | |
| 11 | Comparative | 0.000 | 0.110 | 0.020 | 0.030 | 0.010 | 0.000 | 2.800 | — |
| | example | | | | | | | | |
| 12 | Comparative | 0.000 | 0.110 | 0.020 | 0.030 | 0.010 | 0.000 | 3.000 | — |
| | example | | | | | | | | |
| | | | | | | | Corrosion | | |
| | | | α{1 − | | | Corrosion | current | Average | |
| | | | (a + b + | | | potential | density | particle | Average |
| | | Sample | c + d + e)} × | Crystal | Bs | (Ecorr) | (icorr) | size | Wadell |
| | | No. | e × 10000 | structure | (T) | (mV) | (μA/cm²) | (μm) | circularity |
| | | 1 | 0.0 | Amorphous | 1.67 | −689 | 52.3 | 19.1 | 0.88 |
| | | 2 | 0.0 | Amorphous | 1.67 | −668 | 51.2 | 19.3 | 0.88 |
| | | 3 | 0.0 | Amorphous | 1.67 | −667 | 51.3 | 19.8 | 0.88 |
| | | 4 | 0.0 | Amorphous | 1.67 | −665 | 50.8 | 21.0 | 0.89 |
| | | 5 | 0.0 | Amorphous | 1.67 | −665 | 50.4 | 19.7 | 0.88 |
| | | 6 | 0.0 | Amorphous | 1.67 | −675 | 50.5 | 20.1 | 0.90 |
| | | 7 | 0.0 | Amorphous | 1.67 | −665 | 50.7 | 19.3 | 0.87 |
| | | 8 | 0.0 | Amorphous | 1.66 | −675 | 51.0 | 20.3 | 0.88 |
| | | 9 | 0.0 | Amorphous | 1.66 | −679 | 51.4 | 19.5 | 0.89 |
| | | 10 | 0.0 | Amorphous | 1.66 | −678 | 52.1 | 19.1 | 0.88 |
| | | 11 | 0.0 | Amorphous | 1.65 | −678 | 52.3 | 20.4 | 0.86 |
| | | 12 | 0.0 | Crystal | 1.65 | −677 | 54.1 | 20.0 | 0.85 |

TABLE 1B

| | | (Fe_{(1-α)}Co_{α})_{(1-(a+b+c+d+e))}BₐP_{b}Si_{c}C_{d}Crₑ | | | | | | | |
|---|---|---|---|---|---|---|---|---|---|
| | Example/ | (β = 0) | | | | | | Mn | f /α{1 − |
| Sample | Comparative | | B | P | Si | C | Cr | f | (a + b + |
| No. | example | α | a | b | c | d | e | (at %) | c + d + e)} |
| 13 | Comparative | 0.005 | 0.110 | 0.020 | 0.030 | 0.010 | 0.000 | 0.000 | 0.000 |
| | example | | | | | | | | |
| 14 | Example | 0.005 | 0.110 | 0.020 | 0.030 | 0.010 | 0.000 | 0.002 | 0.48 |
| 15 | Example | 0.005 | 0.110 | 0.020 | 0.030 | 0.010 | 0.000 | 0.005 | 1.2 |
| 16 | Example | 0.005 | 0.110 | 0.020 | 0.030 | 0.010 | 0.000 | 0.015 | 3.6 |
| 17 | Example | 0.005 | 0.110 | 0.020 | 0.030 | 0.010 | 0.000 | 0.025 | 6.0 |
| 18 | Example | 0.005 | 0.110 | 0.020 | 0.030 | 0.010 | 0.000 | 0.040 | 10 |
| 19 | Example | 0.005 | 0.110 | 0.020 | 0.030 | 0.010 | 0.000 | 0.080 | 19 |
| 20 | Example | 0.005 | 0.110 | 0.020 | 0.030 | 0.010 | 0.000 | 0.100 | 24 |
| 21 | Example | 0.005 | 0.110 | 0.020 | 0.030 | 0.010 | 0.000 | 1.000 | 241 |
| 22 | Example | 0.005 | 0.110 | 0.020 | 0.030 | 0.010 | 0.000 | 2.000 | 482 |
| 23 | Example | 0.005 | 0.110 | 0.020 | 0.030 | 0.010 | 0.000 | 2.800 | 675 |
| 24 | Comparative | 0.005 | 0.110 | 0.020 | 0.030 | 0.010 | 0.000 | 3.000 | 723 |
| | example | | | | | | | | |
| | | | | | | | Corrosion | | |
| | | | α{1 − | | | Corrosion | current | Average | |
| | | | (a + b + | | | potential | density | particle | Average |
| | | Sample | c + d + e)} × | Crystal | Bs | (Ecorr) | (icorr) | size | Wadell |
| | | No. | e × 10000 | structure | (T) | (mV) | (μA/cm²) | (μm) | circularity |
| | | 13 | 0.0 | Amorphous | 1.68 | −678 | 51.0 | 19.5 | 0.79 |
| | | 14 | 0.0 | Amorphous | 1.68 | −629 | 40.3 | 20.4 | 0.85 |
| | | 15 | 0.0 | Amorphous | 1.68 | −621 | 40.1 | 19.4 | 0.86 |
| | | 16 | 0.0 | Amorphous | 1.68 | −618 | 39.1 | 19.5 | 0.86 |
| | | 17 | 0.0 | Amorphous | 1.68 | −617 | 39.0 | 19.3 | 0.90 |
| | | 18 | 0.0 | Amorphous | 1.68 | −615 | 40.8 | 20.2 | 0.91 |
| | | 19 | 0.0 | Amorphous | 1.68 | −614 | 39.8 | 19.8 | 0.90 |
| | | 20 | 0.0 | Amorphous | 1.67 | −613 | 38.7 | 19.4 | 0.90 |
| | | 21 | 0.0 | Amorphous | 1.67 | −612 | 38.4 | 19.8 | 0.90 |
| | | 22 | 0.0 | Amorphous | 1.67 | −605 | 38.3 | 19.6 | 0.89 |
| | | 23 | 0.0 | Amorphous | 1.66 | −603 | 38.3 | 20.7 | 0.89 |
| | | 24 | 0.0 | Crystal | 1.66 | −645 | 55.0 | 20.3 | 0.89 |

TABLE 1C

| | | (Fe_{(1-α)}Co_{α})_{(1-(a+b+c+d+e))}BₐP_{b}Si_{c}C_{d}Crₑ | | | | | | | |
|---|---|---|---|---|---|---|---|---|---|
| | Example/ | (β = 0) | | | | | | Mn | f /α{1 − |
| Sample | Comparative | | B | P | Si | C | Cr | f | (a + b + |
| No. | example | α | a | b | c | d | e | (at %) | c + d + e)} |
| 25 | Comparative | 0.010 | 0.110 | 0.020 | 0.030 | 0.010 | 0.000 | 0.000 | 0.000 |
| | example | | | | | | | | |
| 26 | Example | 0.010 | 0.110 | 0.020 | 0.030 | 0.010 | 0.000 | 0.002 | 0.24 |
| 27 | Example | 0.010 | 0.110 | 0.020 | 0.030 | 0.010 | 0.000 | 0.005 | 0.60 |
| 28 | Example | 0.010 | 0.110 | 0.020 | 0.030 | 0.010 | 0.000 | 0.015 | 1.8 |
| 29 | Example | 0.010 | 0.110 | 0.020 | 0.030 | 0.010 | 0.000 | 0.025 | 3.0 |
| 30 | Example | 0.010 | 0.110 | 0.020 | 0.030 | 0.010 | 0.000 | 0.040 | 4.8 |
| 31 | Example | 0.010 | 0.110 | 0.020 | 0.030 | 0.010 | 0.000 | 0.080 | 9.6 |
| 32 | Example | 0.010 | 0.110 | 0.020 | 0.030 | 0.010 | 0.000 | 0.100 | 12 |
| 33 | Example | 0.010 | 0.110 | 0.020 | 0.030 | 0.010 | 0.000 | 1.000 | 120 |
| 34 | Example | 0.010 | 0.110 | 0.020 | 0.030 | 0.010 | 0.000 | 2.000 | 241 |
| 35 | Example | 0.010 | 0.110 | 0.020 | 0.030 | 0.010 | 0.000 | 2.800 | 337 |
| 36 | Comparative | 0.010 | 0.110 | 0.020 | 0.030 | 0.010 | 0.000 | 3.000 | 361 |
| | example | | | | | | | | |
| | | | | | | | Corrosion | | |
| | | | α{1 − | | | Corrosion | current | Average | |
| | | | (a + b + | | | potential | density | particle | Average |
| | | Sample | c + d + e)} × | Crystal | Bs | (Ecorr) | (icorr) | size | Wadell |
| | | No. | e × 10000 | structure | (T) | (mV) | (μA/cm²) | (μm) | circularity |
| | | 25 | 0.0 | Amorphous | 1.69 | −675 | 50.0 | 20.0 | 0.79 |
| | | 26 | 0.0 | Amorphous | 1.69 | −629 | 40.1 | 20.7 | 0.84 |
| | | 27 | 0.0 | Amorphous | 1.69 | −622 | 40.0 | 20.7 | 0.87 |
| | | 28 | 0.0 | Amorphous | 1.69 | −615 | 39.4 | 19.4 | 0.87 |
| | | 29 | 0.0 | Amorphous | 1.69 | −608 | 39.0 | 20.3 | 0.89 |
| | | 30 | 0.0 | Amorphous | 1.69 | −609 | 38.8 | 19.5 | 0.90 |
| | | 31 | 0.0 | Amorphous | 1.69 | −607 | 38.3 | 20.5 | 0.91 |
| | | 32 | 0.0 | Amorphous | 1.68 | −605 | 36.5 | 20.4 | 0.91 |
| | | 33 | 0.0 | Amorphous | 1.68 | −604 | 36.3 | 20.3 | 0.91 |
| | | 34 | 0.0 | Amorphous | 1.67 | −602 | 36.0 | 19.2 | 0.91 |
| | | 35 | 0.0 | Amorphous | 1.67 | −598 | 36.2 | 20.2 | 0.90 |
| | | 36 | 0.0 | Crystal | 1.65 | −645 | 52.0 | 19.2 | 0.90 |

TABLE 1D

| | | (Fe_{(1-α)}Co_{α})_{(1-(a+b+c+d+e))}BₐP_{b}Si_{c}C_{d}Crₑ | | | | | | | |
|---|---|---|---|---|---|---|---|---|---|
| | Example/ | (β = 0) | | | | | | Mn | f /α{1 − |
| Sample | Comparative | | B | P | Si | C | Cr | f | (a + b + |
| No. | example | α | a | b | c | d | e | (at %) | c + d + e)} |
| 37 | Comparative | 0.030 | 0.110 | 0.020 | 0.030 | 0.010 | 0.000 | 0.000 | 0.000 |
| | example | | | | | | | | |
| 38 | Example | 0.030 | 0.110 | 0.020 | 0.030 | 0.010 | 0.000 | 0.002 | 0.05 |
| 39 | Example | 0.030 | 0.110 | 0.020 | 0.030 | 0.010 | 0.000 | 0.005 | 0.12 |
| 40 | Example | 0.030 | 0.110 | 0.020 | 0.030 | 0.010 | 0.000 | 0.015 | 0.36 |
| 41 | Example | 0.030 | 0.110 | 0.020 | 0.030 | 0.010 | 0.000 | 0.025 | 0.60 |
| 42 | Example | 0.030 | 0.110 | 0.020 | 0.030 | 0.010 | 0.000 | 0.040 | 0.96 |
| 43 | Example | 0.030 | 0.110 | 0.020 | 0.030 | 0.010 | 0.000 | 0.080 | 1.9 |
| 44 | Example | 0.030 | 0.110 | 0.020 | 0.030 | 0.010 | 0.000 | 0.100 | 2.4 |
| 45 | Example | 0.030 | 0.110 | 0.020 | 0.030 | 0.010 | 0.000 | 1.000 | 24 |
| 46 | Example | 0.030 | 0.110 | 0.020 | 0.030 | 0.010 | 0.000 | 2.000 | 48 |
| 47 | Example | 0.030 | 0.110 | 0.020 | 0.030 | 0.010 | 0.000 | 2.800 | 67 |
| 48 | Comparative | 0.030 | 0.110 | 0.020 | 0.030 | 0.010 | 0.000 | 3.000 | 72 |
| | example | | | | | | | | |
| | | | | | | | Corrosion | | |
| | | | α{1 − | | | Corrosion | current | Average | |
| | | | (a + b + | | | potential | density | particle | Average |
| | | Sample | c + d + e)} × | Crystal | Bs | (Ecorr) | (icorr) | size | Wadell |
| | | No. | e × 10000 | structure | (T) | (mV) | (μA/cm²) | (μm) | circularity |
| | | 37 | 0.0 | Amorphous | 1.70 | −670 | 50.5 | 21.4 | 0.78 |
| | | 38 | 0.0 | Amorphous | 1.70 | −630 | 40.2 | 20.4 | 0.83 |
| | | 39 | 0.0 | Amorphous | 1.70 | −624 | 40.1 | 21.6 | 0.86 |
| | | 40 | 0.0 | Amorphous | 1.70 | −616 | 37.4 | 19.9 | 0.87 |
| | | 41 | 0.0 | Amorphous | 1.70 | −610 | 36.7 | 20.2 | 0.89 |
| | | 42 | 0.0 | Amorphous | 1.70 | −607 | 36.3 | 18.7 | 0.91 |
| | | 43 | 0.0 | Amorphous | 1.70 | −604 | 35.8 | 19.3 | 0.92 |
| | | 44 | 0.0 | Amorphous | 1.69 | −597 | 34.8 | 19.0 | 0.92 |
| | | 45 | 0.0 | Amorphous | 1.69 | −590 | 34.5 | 21.0 | 0.92 |
| | | 46 | 0.0 | Amorphous | 1.69 | −585 | 34.0 | 19.1 | 0.91 |
| | | 47 | 0.0 | Amorphous | 1.69 | −581 | 33.5 | 18.8 | 0.90 |
| | | 48 | 0.0 | Crystal | 1.68 | −656 | 52.5 | 18.5 | 0.90 |

TABLE 1E

| | | (Fe_{(1-α)}Co_{α})_{(1-(a+b+c+d+e))}BₐP_{b}Si_{c}C_{d}Crₑ | | | | | | | |
|---|---|---|---|---|---|---|---|---|---|
| | Example/ | (β = 0) | | | | | | Mn | f /α{1 − |
| Sample | Comparative | | B | P | Si | C | Cr | f | (a + b + |
| No. | example | α | a | b | c | d | e | (at %) | c + d + e)} |
| 49 | Comparative | 0.050 | 0.110 | 0.020 | 0.030 | 0.010 | 0.000 | 0.000 | 0.000 |
| | example | | | | | | | | |
| 50 | Example | 0.050 | 0.110 | 0.020 | 0.030 | 0.010 | 0.000 | 0.002 | 0.05 |
| 51 | Example | 0.050 | 0.110 | 0.020 | 0.030 | 0.010 | 0.000 | 0.005 | 0.12 |
| 52 | Example | 0.050 | 0.110 | 0.020 | 0.030 | 0.010 | 0.000 | 0.015 | 0.36 |
| 53 | Example | 0.050 | 0.110 | 0.020 | 0.030 | 0.010 | 0.000 | 0.025 | 0.60 |
| 54 | Example | 0.050 | 0.110 | 0.020 | 0.030 | 0.010 | 0.000 | 0.040 | 0.96 |
| 55 | Example | 0.050 | 0.110 | 0.020 | 0.030 | 0.010 | 0.000 | 0.080 | 1.9 |
| 56 | Example | 0.050 | 0.110 | 0.020 | 0.030 | 0.010 | 0.000 | 0.100 | 2.4 |
| 57 | Example | 0.050 | 0.110 | 0.020 | 0.030 | 0.010 | 0.000 | 1.000 | 24 |
| 58 | Example | 0.050 | 0.110 | 0.020 | 0.030 | 0.010 | 0.000 | 2.000 | 48 |
| 59 | Example | 0.050 | 0.110 | 0.020 | 0.030 | 0.010 | 0.000 | 2.800 | 67 |
| 60 | Comparative | 0.050 | 0.110 | 0.020 | 0.030 | 0.010 | 0.000 | 3.000 | 72 |
| | example | | | | | | | | |
| | | | | | | | Corrosion | | |
| | | | α{1 − | | | Corrosion | current | Average | |
| | | | (a + b + | | | potential | density | particle | Average |
| | | Sample | c + d + e)} × | Crystal | Bs | (Ecorr) | (icorr) | size | Wadell |
| | | No. | e × 10000 | structure | (T) | (mV) | (μA/cm²) | (μm) | circularity |
| | | 49 | 0.0 | Amorphous | 1.71 | −665 | 51.0 | 19.2 | 0.75 |
| | | 50 | 0.0 | Amorphous | 1.71 | −627 | 40.2 | 20.0 | 0.81 |
| | | 51 | 0.0 | Amorphous | 1.71 | −625 | 40.2 | 20.8 | 0.83 |
| | | 52 | 0.0 | Amorphous | 1.71 | −618 | 35.4 | 20.8 | 0.9 |
| | | 53 | 0.0 | Amorphous | 1.71 | −609 | 34.4 | 20.4 | 0.89 |
| | | 54 | 0.0 | Amorphous | 1.71 | −602 | 33.7 | 20.1 | 0.91 |
| | | 55 | 0.0 | Amorphous | 1.71 | −600 | 33.0 | 19.7 | 0.90 |
| | | 56 | 0.0 | Amorphous | 1.70 | −588 | 32.2 | 19.5 | 0.90 |
| | | 57 | 0.0 | Amorphous | 1.70 | −576 | 32.0 | 20.4 | 0.90 |
| | | 58 | 0.0 | Amorphous | 1.70 | −567 | 31.5 | 20.9 | 0.91 |
| | | 59 | 0.0 | Amorphous | 1.70 | −564 | 31.0 | 19.5 | 0.91 |
| | | 60 | 0.0 | Crystal | 1.70 | −645 | 53.0 | 20.9 | 0.91 |

TABLE 1F

| | | (Fe_{(1-α)}Co_{α})_{(1-(a+b+c+d+e))}BₐP_{b}Si_{c}C_{d}Crₑ | | | | | | | |
|---|---|---|---|---|---|---|---|---|---|
| | Example/ | (β = 0) | | | | | | Mn | f /α{1 − |
| Sample | Comparative | | B | P | Si | C | Cr | f | (a + b + |
| No. | example | α | a | b | c | d | e | (at %) | c + d + e)} |
| 61 | Comparative | 0.100 | 0.110 | 0.020 | 0.030 | 0.010 | 0.000 | 0.000 | 0.000 |
| | example | | | | | | | | |
| 62 | Example | 0.100 | 0.110 | 0.020 | 0.030 | 0.010 | 0.000 | 0.002 | 0.024 |
| 63 | Example | 0.100 | 0.110 | 0.020 | 0.030 | 0.010 | 0.000 | 0.005 | 0.060 |
| 64 | Example | 0.100 | 0.110 | 0.020 | 0.030 | 0.010 | 0.000 | 0.015 | 0.18 |
| 65 | Example | 0.100 | 0.110 | 0.020 | 0.030 | 0.010 | 0.000 | 0.025 | 0.30 |
| 66 | Example | 0.100 | 0.110 | 0.020 | 0.030 | 0.010 | 0.000 | 0.040 | 0.48 |
| 67 | Example | 0.100 | 0.110 | 0.020 | 0.030 | 0.010 | 0.000 | 0.080 | 0.96 |
| 68 | Example | 0.100 | 0.110 | 0.020 | 0.030 | 0.010 | 0.000 | 0.100 | 1.2 |
| 69 | Example | 0.100 | 0.110 | 0.020 | 0.030 | 0.010 | 0.000 | 1.000 | 12 |
| 70 | Example | 0.100 | 0.110 | 0.020 | 0.030 | 0.010 | 0.000 | 2.000 | 24 |
| 71 | Example | 0.100 | 0.110 | 0.020 | 0.030 | 0.010 | 0.000 | 2.800 | 34 |
| 72 | Comparative | 0.100 | 0.110 | 0.020 | 0.030 | 0.010 | 0.000 | 3.000 | 36 |
| | example | | | | | | | | |
| | | | | | | | Corrosion | | |
| | | | α{1 − | | | Corrosion | current | Average | |
| | | | (a + b + | | | potential | density | particle | Average |
| | | Sample | c + d + e)} × | Crystal | Bs | (Ecorr) | (icorr) | size | Wadell |
| | | No. | e × 10000 | structure | (T) | (mV) | (μA/cm²) | (μm) | circularity |
| | | 61 | 0.0 | Amorphous | 1.75 | −667 | 52.0 | 19.3 | 0.73 |
| | | 62 | 0.0 | Amorphous | 1.74 | −625 | 40.1 | 19.3 | 0.81 |
| | | 63 | 0.0 | Amorphous | 1.74 | −621 | 39.8 | 19.5 | 0.85 |
| | | 64 | 0.0 | Amorphous | 1.74 | −616 | 34.3 | 19.2 | 0.92 |
| | | 65 | 0.0 | Amorphous | 1.74 | −608 | 33.3 | 19.8 | 0.93 |
| | | 66 | 0.0 | Amorphous | 1.74 | −589 | 32.5 | 19.3 | 0.94 |
| | | 67 | 0.0 | Amorphous | 1.74 | −587 | 32.1 | 20.2 | 0.94 |
| | | 68 | 0.0 | Amorphous | 1.73 | −584 | 32.0 | 20.3 | 0.93 |
| | | 69 | 0.0 | Amorphous | 1.72 | −577 | 31.4 | 21.0 | 0.91 |
| | | 70 | 0.0 | Amorphous | 1.72 | −575 | 31.2 | 20.0 | 0.90 |
| | | 71 | 0.0 | Amorphous | 1.71 | −565 | 31.0 | 19.0 | 0.91 |
| | | 72 | 0.0 | Crystal | 1.71 | −669 | 49.0 | 20.9 | 0.90 |

TABLE 1G

| | | (Fe_{(1-α)}Co_{α})_{(1-(a+b+c+d+e))}BₐP_{b}Si_{c}C_{d}Crₑ | | | | | | | |
|---|---|---|---|---|---|---|---|---|---|
| | Example/ | (β = 0) | | | | | | Mn | f /α{1 − |
| Sample | Comparative | | B | P | Si | C | Cr | f | (a + b + |
| No. | example | α | a | b | c | d | e | (at %) | c + d + e)} |
| 73 | Comparative | 0.150 | 0.110 | 0.020 | 0.030 | 0.010 | 0.000 | 0.000 | 0.000 |
| | example | | | | | | | | |
| 74 | Example | 0.150 | 0.110 | 0.020 | 0.030 | 0.010 | 0.000 | 0.002 | 0.016 |
| 75 | Example | 0.150 | 0.110 | 0.020 | 0.030 | 0.010 | 0.000 | 0.005 | 0.040 |
| 76 | Example | 0.150 | 0.110 | 0.020 | 0.030 | 0.010 | 0.000 | 0.015 | 0.12 |
| 77 | Example | 0.150 | 0.110 | 0.020 | 0.030 | 0.010 | 0.000 | 0.025 | 0.20 |
| 78 | Example | 0.150 | 0.110 | 0.020 | 0.030 | 0.010 | 0.000 | 0.040 | 0.32 |
| 79 | Example | 0.150 | 0.110 | 0.020 | 0.030 | 0.010 | 0.000 | 0.080 | 0.64 |
| 80 | Example | 0.150 | 0.110 | 0.020 | 0.030 | 0.010 | 0.000 | 0.100 | 0.80 |
| 81 | Example | 0.150 | 0.110 | 0.020 | 0.030 | 0.010 | 0.000 | 1.000 | 8.0 |
| 82 | Example | 0.150 | 0.110 | 0.020 | 0.030 | 0.010 | 0.000 | 2.000 | 16 |
| 83 | Example | 0.150 | 0.110 | 0.020 | 0.030 | 0.010 | 0.000 | 2.800 | 22 |
| 84 | Comparative | 0.150 | 0.110 | 0.020 | 0.030 | 0.010 | 0.000 | 3.000 | 24 |
| | example | | | | | | | | |
| | | | | | | | Corrosion | | |
| | | | α{1 − | | | Corrosion | current | Average | |
| | | | (a + b + | | | potential | density | particle | Average |
| | | Sample | c + d + e)} × | Crystal | Bs | (Ecorr) | (icorr) | size | Wadell |
| | | No. | e × 10000 | structure | (T) | (mV) | (μA/cm²) | (μm) | circularity |
| | | 73 | 0.0 | Amorphous | 1.76 | −662 | 49.5 | 20.4 | 0.73 |
| | | 74 | 0.0 | Amorphous | 1.76 | −613 | 40.2 | 20.1 | 0.80 |
| | | 75 | 0.0 | Amorphous | 1.76 | −604 | 37.2 | 19.0 | 0.85 |
| | | 76 | 0.0 | Amorphous | 1.76 | −598 | 32.1 | 19.6 | 0.93 |
| | | 77 | 0.0 | Amorphous | 1.76 | −587 | 31.6 | 20.1 | 0.93 |
| | | 78 | 0.0 | Amorphous | 1.76 | −579 | 31.1 | 19.8 | 0.94 |
| | | 79 | 0.0 | Amorphous | 1.76 | −583 | 32.6 | 20.7 | 0.95 |
| | | 80 | 0.0 | Amorphous | 1.75 | −589 | 33.7 | 19.7 | 0.93 |
| | | 81 | 0.0 | Amorphous | 1.74 | −588 | 33.7 | 20.4 | 0.93 |
| | | 82 | 0.0 | Amorphous | 1.73 | −573 | 34.2 | 19.6 | 0.91 |
| | | 83 | 0.0 | Amorphous | 1.73 | −567 | 34.2 | 20.6 | 0.91 |
| | | 84 | 0.0 | Crystal | 1.72 | −695 | 50.0 | 20.8 | 0.90 |

TABLE 1H

| | | (Fe_{(1-α)}Co_{α})_{(1-(a+b+c+d+e))}BₐP_{b}Si_{c}C_{d}Crₑ | | | | | | | |
|---|---|---|---|---|---|---|---|---|---|
| | Example/ | (β = 0) | | | | | | Mn | f /α{1 − |
| Sample | Comparative | | B | P | Si | C | Cr | f | (a + b + |
| No. | example | α | a | b | c | d | e | (at %) | c + d + e)} |
| 85 | Comparative | 0.300 | 0.110 | 0.020 | 0.030 | 0.010 | 0.000 | 0.000 | 0.000 |
| | example | | | | | | | | |
| 86 | Example | 0.300 | 0.110 | 0.020 | 0.030 | 0.010 | 0.000 | 0.002 | 0.0080 |
| 87 | Example | 0.300 | 0.110 | 0.020 | 0.030 | 0.010 | 0.000 | 0.005 | 0.020 |
| 88 | Example | 0.300 | 0.110 | 0.020 | 0.030 | 0.010 | 0.000 | 0.015 | 0.060 |
| 89 | Example | 0.300 | 0.110 | 0.020 | 0.030 | 0.010 | 0.000 | 0.025 | 0.10 |
| 90 | Example | 0.300 | 0.110 | 0.020 | 0.030 | 0.010 | 0.000 | 0.040 | 0.16 |
| 91 | Example | 0.300 | 0.110 | 0.020 | 0.030 | 0.010 | 0.000 | 0.080 | 0.32 |
| 92 | Example | 0.300 | 0.110 | 0.020 | 0.030 | 0.010 | 0.000 | 0.100 | 0.40 |
| 93 | Example | 0.300 | 0.110 | 0.020 | 0.030 | 0.010 | 0.000 | 1.000 | 4.0 |
| 94 | Example | 0.300 | 0.110 | 0.020 | 0.030 | 0.010 | 0.000 | 2.000 | 8.0 |
| 95 | Example | 0.300 | 0.110 | 0.020 | 0.030 | 0.010 | 0.000 | 2.800 | 11 |
| 96 | Comparative | 0.300 | 0.110 | 0.020 | 0.030 | 0.010 | 0.000 | 3.000 | 12 |
| | example | | | | | | | | |
| | | | | | | | Corrosion | | |
| | | | α{1 − | | | Corrosion | current | Average | |
| | | | (a + b + | | | potential | density | particle | Average |
| | | Sample | c + d + e)} × | Crystal | Bs | (Ecorr) | (icorr) | size | Wadell |
| | | No. | e × 10000 | structure | (T) | (mV) | (μA/cm²) | (μm) | circularity |
| | | 85 | 0.0 | Amorphous | 1.77 | −653 | 51.5 | 19.7 | 0.73 |
| | | 86 | 0.0 | Amorphous | 1.77 | −612 | 40.0 | 20.2 | 0.81 |
| | | 87 | 0.0 | Amorphous | 1.77 | −604 | 37.2 | 20.8 | 0.87 |
| | | 88 | 0.0 | Amorphous | 1.77 | −589 | 31.6 | 19.8 | 0.92 |
| | | 89 | 0.0 | Amorphous | 1.77 | −578 | 24.5 | 19.1 | 0.93 |
| | | 90 | 0.0 | Amorphous | 1.77 | −568 | 21.4 | 20.0 | 0.94 |
| | | 91 | 0.0 | Amorphous | 1.77 | −576 | 21.4 | 19.4 | 0.94 |
| | | 92 | 0.0 | Amorphous | 1.76 | −580 | 21.9 | 20.3 | 0.95 |
| | | 93 | 0.0 | Amorphous | 1.75 | −578 | 20.9 | 20.9 | 0.95 |
| | | 94 | 0.0 | Amorphous | 1.75 | −567 | 21.9 | 19.6 | 0.94 |
| | | 95 | 0.0 | Amorphous | 1.72 | −566 | 21.6 | 19.7 | 0.92 |
| | | 96 | 0.0 | Crystal | 1.71 | −697 | 48.5 | 20.8 | 0.92 |

TABLE 1I

| | | | | | | | | | | a{1 − | | | Corro- | Corro- | Aver- | |
|---|---|---|---|---|---|---|---|---|---|---|---|---|---|---|---|---|
| | | | | | | | | | | (a + b + | | | sion | sion | age | Aver- |
| | Example/ | (Fe₍₁₋ₐ₎COₐ)_{(1-(a+b+c+d+e))}BₐP_{b}Si_{c}C_{d}Crₑ | | | | | | | f/a{1 − | c + d + | | | poten- | current | par- | age |
| Sam- | Compar- | (β = 0) | | | | | | Mn | (a + b + | e)} × | | | tial | density | ticle | Wadell |
| ple | ative | | B | P | Si | C | Cr | f | c + d + | e × | Crystal | Bs | (Ecorr) | (icorr) | size | circu- |
| No. | example | a | a | b | c | d | e | (at %) | e)} | 10000 | structure | (T) | (mV) | (μA/cm²) | (μm) | larity |
| 97 | Compar- | 0.450 | 0.110 | 0.020 | 0.030 | 0.010 | 0.000 | 0.000 | 0.000 | 0.0 | Amorphous | 1.75 | −651 | 51.5 | 19.4 | 0.73 |
| | ative | | | | | | | | | | | | | | | |
| | example | | | | | | | | | | | | | | | |
| 98 | Example | 0.450 | 0.110 | 0.020 | 0.030 | 0.010 | 0.000 | 0.002 | 0.0054 | 0.0 | Amorphous | 1.75 | −608 | 39.9 | 20.4 | 0.80 |
| 99 | Example | 0.450 | 0.110 | 0.020 | 0.030 | 0.010 | 0.000 | 0.005 | 0.013 | 0.0 | Amorphous | 1.75 | −602 | 36.2 | 20.8 | 0.86 |
| 100 | Example | 0.450 | 0.110 | 0.020 | 0.030 | 0.010 | 0.000 | 0.015 | 0.040 | 0.0 | Amorphous | 1.75 | −586 | 30.3 | 19.6 | 0.90 |
| 101 | Example | 0.450 | 0.110 | 0.020 | 0.030 | 0.010 | 0.000 | 0.025 | 0.067 | 0.0 | Amorphous | 1.75 | −568 | 23.4 | 19.4 | 0.92 |
| 102 | Example | 0.450 | 0.110 | 0.020 | 0.030 | 0.010 | 0.000 | 0.040 | 0.11 | 0.0 | Amorphous | 1.75 | −556 | 22.1 | 19.4 | 0.94 |
| 103 | Example | 0.450 | 0.110 | 0.020 | 0.030 | 0.010 | 0.000 | 0.080 | 0.21 | 0.0 | Amorphous | 1.75 | −560 | 21.2 | 19.1 | 0.95 |
| 104 | Example | 0.450 | 0.110 | 0.020 | 0.030 | 0.010 | 0.000 | 0.100 | 0.27 | 0.0 | Amorphous | 1.74 | −559 | 21.0 | 19.1 | 0.95 |
| 105 | Example | 0.450 | 0.110 | 0.020 | 0.030 | 0.010 | 0.000 | 1.000 | 2.7 | 0.0 | Amorphous | 1.73 | −555 | 21.0 | 20.7 | 0.96 |
| 106 | Example | 0.450 | 0.110 | 0.020 | 0.030 | 0.010 | 0.000 | 2.000 | 5.4 | 0.0 | Amorphous | 1.73 | −553 | 20.9 | 19.3 | 0.97 |
| 107 | Example | 0.450 | 0.110 | 0.020 | 0.030 | 0.010 | 0.000 | 2.800 | 7.5 | 0.0 | Amorphous | 1.73 | −552 | 20.4 | 20.7 | 0.95 |
| 108 | Compar- | 0.450 | 0.110 | 0.020 | 0.030 | 0.010 | 0.000 | 3.000 | 8.0 | 0.0 | Crystal | 1.68 | −711 | 48.5 | 19.7 | 0.90 |
| | ative | | | | | | | | | | | | | | | |
| | example | | | | | | | | | | | | | | | |

TABLE 1J

| | | | | | | | | | | | | | | Corro- | | |
|---|---|---|---|---|---|---|---|---|---|---|---|---|---|---|---|---|
| | | | | | | | | | | a{1 − | | | Corro- | sion | Aver- | |
| | | | | | | | | | | (a + b + | | | sion | current | age | Aver- |
| | Example/ | (Fe₍₁₋ₐ₎COₐ)_{(1-(a+b+c+d+e))}BₐP_{b}Si_{c}C_{d}Crₑ | | | | | | | f/a{1 − | c + d + | | | poten- | density | par- | age |
| Sam- | Compar- | (β = 0) | | | | | | Mn | (a + b + | e)} × | | | tial | (icorr) | ticle | Wadell |
| ple | ative | | B | P | Si | C | Cr | f | c + d + | e × | Crystal | Bs | (Ecorr) | (μA/ | size | circu- |
| No. | example | a | a | b | c | d | e | (at %) | e)} | 10000 | structure | (T) | (mV) | cm²) | (μm) | larity |
| 109 | Compar- | 0.500 | 0.110 | 0.020 | 0.030 | 0.010 | 0.000 | 0.000 | 0.000 | 0.0 | Amorphous | 1.74 | −649 | 52.0 | 19.8 | 0.72 |
| | ative | | | | | | | | | | | | | | | |
| | example | | | | | | | | | | | | | | | |
| 110 | Example | 0.500 | 0.110 | 0.020 | 0.030 | 0.010 | 0.000 | 0.002 | 0.0048 | 0.0 | Amorphous | 1.74 | −605 | 38.3 | 20.5 | 0.80 |
| 111 | Example | 0.500 | 0.110 | 0.020 | 0.030 | 0.010 | 0.000 | 0.005 | 0.012 | 0.0 | Amorphous | 1.74 | −600 | 35.5 | 20.6 | 0.85 |
| 112 | Example | 0.500 | 0.110 | 0.020 | 0.030 | 0.010 | 0.000 | 0.015 | 0.036 | 0.0 | Amorphous | 1.74 | −586 | 30.0 | 19.6 | 0.9 |
| 113 | Example | 0.500 | 0.110 | 0.020 | 0.030 | 0.010 | 0.000 | 0.025 | 0.060 | 0.0 | Amorphous | 1.74 | −553 | 23.3 | 20.2 | 0.93 |
| 114 | Example | 0.500 | 0.110 | 0.020 | 0.030 | 0.010 | 0.000 | 0.040 | 0.096 | 0.0 | Amorphous | 1.74 | −549 | 22.0 | 20.4 | 0.94 |
| 115 | Example | 0.500 | 0.110 | 0.020 | 0.030 | 0.010 | 0.000 | 0.080 | 0.19 | 0.0 | Amorphous | 1.74 | −550 | 21.0 | 19.0 | 0.93 |
| 116 | Example | 0.500 | 0.110 | 0.020 | 0.030 | 0.010 | 0.000 | 0.100 | 0.24 | 0.0 | Amorphous | 1.73 | −547 | 21.0 | 20.2 | 0.93 |
| 117 | Example | 0.500 | 0.110 | 0.020 | 0.030 | 0.010 | 0.000 | 1.000 | 2.4 | 0.0 | Amorphous | 1.73 | −544 | 20.8 | 20.1 | 0.93 |
| 118 | Example | 0.500 | 0.110 | 0.020 | 0.030 | 0.010 | 0.000 | 2.000 | 4.8 | 0.0 | Amorphous | 1.73 | −542 | 20.7 | 19.7 | 0.93 |
| 119 | Example | 0.500 | 0.110 | 0.020 | 0.030 | 0.010 | 0.000 | 2.800 | 6.7 | 0.0 | Amorphous | 1.73 | −541 | 20.6 | 19.6 | 0.94 |
| 120 | Compar- | 0.500 | 0.110 | 0.020 | 0.030 | 0.010 | 0.000 | 3.000 | 7.2 | 0.0 | Crystal | 1.71 | −706 | 47.0 | 20.6 | 0.92 |
| | ative | | | | | | | | | | | | | | | |
| | example | | | | | | | | | | | | | | | |

TABLE 1K

| | | | | | | | | | | | | | | Corro- | | |
|---|---|---|---|---|---|---|---|---|---|---|---|---|---|---|---|---|
| | | | | | | | | | | a{1 − | | | Corro- | sion | Aver- | |
| | | | | | | | | | | (a + b + | | | sion | current | age | Aver- |
| | Example/ | (Fe₍₁₋ₐ₎COₐ)_{(1-(a+b+c+d+e))}BₐP_{b}Si_{c}C_{d}Crₑ | | | | | | | f/a{1 − | c + d + | | | poten- | density | par- | age |
| Sam- | Compar- | (β = 0) | | | | | | Mn | (a + b + | e)} × | | | tial | (icorr) | ticle | Wadell |
| ple | ative | | B | P | Si | C | Cr | f | c + d + | e × | Crystal | Bs | (Ecorr) | (μA/ | size | circu- |
| No. | example | a | a | b | c | d | e | (at %) | e)} | 10000 | structure | (T) | (mV) | cm²) | (μm) | larity |
| 121 | Compar- | 0.600 | 0.110 | 0.020 | 0.030 | 0.010 | 0.000 | 0.000 | 0.000 | 0.0 | Amorphous | 1.64 | −644 | 51.0 | 19.6 | 0.72 |
| | ative | | | | | | | | | | | | | | | |
| | example | | | | | | | | | | | | | | | |
| 122 | Example | 0.600 | 0.110 | 0.020 | 0.030 | 0.010 | 0.000 | 0.002 | 0.0040 | 0.0 | Amorphous | 1.64 | −603 | 38.5 | 21.0 | 0.80 |
| 123 | Example | 0.600 | 0.110 | 0.020 | 0.030 | 0.010 | 0.000 | 0.005 | 0.010 | 0.0 | Amorphous | 1.64 | −596 | 34.4 | 19.0 | 0.86 |
| 124 | Example | 0.600 | 0.110 | 0.020 | 0.030 | 0.010 | 0.000 | 0.015 | 0.030 | 0.0 | Amorphous | 1.64 | −583 | 29.6 | 20.4 | 0.87 |
| 125 | Example | 0.600 | 0.110 | 0.020 | 0.030 | 0.010 | 0.000 | 0.025 | 0.050 | 0.0 | Amorphous | 1.64 | −543 | 22.4 | 20.2 | 0.92 |
| 126 | Example | 0.600 | 0.110 | 0.020 | 0.030 | 0.010 | 0.000 | 0.040 | 0.080 | 0.0 | Amorphous | 1.64 | −534 | 21.5 | 19.3 | 0.93 |
| 127 | Example | 0.600 | 0.110 | 0.020 | 0.030 | 0.010 | 0.000 | 0.080 | 0.16 | 0.0 | Amorphous | 1.64 | −533 | 21.4 | 20.0 | 0.94 |
| 128 | Example | 0.600 | 0.110 | 0.020 | 0.030 | 0.010 | 0.000 | 0.100 | 0.20 | 0.0 | Amorphous | 1.63 | −523 | 21.1 | 19.2 | 0.94 |
| 129 | Example | 0.600 | 0.110 | 0.020 | 0.030 | 0.010 | 0.000 | 1.000 | 2.0 | 0.0 | Amorphous | 1.63 | −521 | 20.1 | 19.4 | 0.94 |
| 130 | Example | 0.600 | 0.110 | 0.020 | 0.030 | 0.010 | 0.000 | 2.000 | 4.0 | 0.0 | Amorphous | 1.63 | −520 | 20.1 | 20.8 | 0.93 |
| 131 | Example | 0.600 | 0.110 | 0.020 | 0.030 | 0.010 | 0.000 | 2.800 | 5.6 | 0.0 | Amorphous | 1.63 | −512 | 20.0 | 20.6 | 0.93 |
| 132 | Compar- | 0.600 | 0.110 | 0.020 | 0.030 | 0.010 | 0.000 | 3.000 | 6.0 | 0.0 | Crystal | 1.62 | −712 | 52.0 | 19.2 | 0.93 |
| | ative | | | | | | | | | | | | | | | |
| | example | | | | | | | | | | | | | | | |

TABLE 1L

| | | | | | | | | | | | | | | Corro- | | |
|---|---|---|---|---|---|---|---|---|---|---|---|---|---|---|---|---|
| | | | | | | | | | | a{1 − | | | Corro- | sion | Aver- | |
| | | | | | | | | | | (a + b + | | | sion | current | age | Aver- |
| | Example/ | (Fe₍₁₋ₐ₎COₐ)_{(1-(a+b+c+d+e))}BₐP_{b}Si_{c}C_{d}Crₑ | | | | | | | f/a{1 − | c + d + | | | poten- | density | par- | age |
| Sam- | Compar- | (β = 0) | | | | | | Mn | (a + b + | e)} × | | | tial | (icorr) | ticle | Wadell |
| ple | ative | | B | P | Si | C | Cr | f | c + d + | e × | Crystal | Bs | (Ecorr) | (μA/ | size | circu- |
| No. | example | a | a | b | c | d | e | (at %) | e)} | 10000 | structure | (T) | (mV) | cm²) | (μm) | larity |
| 133 | Compar- | 0.700 | 0.110 | 0.020 | 0.030 | 0.010 | 0.000 | 0.000 | 0.000 | 0.0 | Amorphous | 1.53 | −645 | 51.2 | 20.9 | 0.72 |
| | ative | | | | | | | | | | | | | | | |
| | example | | | | | | | | | | | | | | | |
| 134 | Example | 0.700 | 0.110 | 0.020 | 0.030 | 0.010 | 0.000 | 0.002 | 0.0034 | 0.0 | Amorphous | 1.53 | −604 | 38.6 | 19.4 | 0.80 |
| 135 | Example | 0.700 | 0.110 | 0.020 | 0.030 | 0.010 | 0.000 | 0.005 | 0.0086 | 0.0 | Amorphous | 1.53 | −577 | 34.4 | 19.4 | 0.83 |
| 136 | Example | 0.700 | 0.110 | 0.020 | 0.030 | 0.010 | 0.000 | 0.015 | 0.026 | 0.0 | Amorphous | 1.53 | −568 | 28.7 | 19.4 | 0.86 |
| 137 | Example | 0.700 | 0.110 | 0.020 | 0.030 | 0.010 | 0.000 | 0.025 | 0.043 | 0.0 | Amorphous | 1.53 | −533 | 22.3 | 20.4 | 0.87 |
| 138 | Example | 0.700 | 0.110 | 0.020 | 0.030 | 0.010 | 0.000 | 0.040 | 0.069 | 0.0 | Amorphous | 1.53 | −524 | 21.5 | 19.5 | 0.89 |
| 139 | Example | 0.700 | 0.110 | 0.020 | 0.030 | 0.010 | 0.000 | 0.080 | 0.14 | 0.0 | Amorphous | 1.53 | −523 | 21.3 | 20.3 | 0.91 |
| 140 | Example | 0.700 | 0.110 | 0.020 | 0.030 | 0.010 | 0.000 | 0.100 | 0.17 | 0.0 | Amorphous | 1.53 | −521 | 21.1 | 20.8 | 0.90 |
| 141 | Example | 0.700 | 0.110 | 0.020 | 0.030 | 0.010 | 0.000 | 1.000 | 1.7 | 0.0 | Amorphous | 1.53 | −520 | 21.0 | 20.6 | 0.89 |
| 142 | Example | 0.700 | 0.110 | 0.020 | 0.030 | 0.010 | 0.000 | 2.000 | 3.4 | 0.0 | Amorphous | 1.53 | −519 | 20.9 | 20.5 | 0.89 |
| 143 | Example | 0.700 | 0.110 | 0.020 | 0.030 | 0.010 | 0.000 | 2.800 | 4.8 | 0.0 | Amorphous | 1.52 | −511 | 20.9 | 19.1 | 0.88 |
| 144 | Compar- | 0.700 | 0.110 | 0.020 | 0.030 | 0.010 | 0.000 | 3.000 | 5.2 | 0.0 | Crystal | 1.52 | −711 | 53.0 | 20.3 | 0.87 |
| | ative | | | | | | | | | | | | | | | |
| | example | | | | | | | | | | | | | | | |

TABLE 1M

| | | | | | | | | | | | | | | Corro- | | |
|---|---|---|---|---|---|---|---|---|---|---|---|---|---|---|---|---|
| | | | | | | | | | | a{1 − | | | Corro- | sion | Aver- | |
| | | | | | | | | | | (a + b + | | | sion | current | age | Aver- |
| | | (Fe₍₁₋ₐ₎COₐ)_{(1-(a+b+c+d+e))}BₐP_{b}Si_{c}C_{d}Crₑ | | | | | | | f/a{1 − | c + d + | | | poten- | density | par- | age |
| Sam- | Example/ | (β = 0) | | | | | | Mn | (a + b + | e)} × | | | tial | (icorr) | ticle | Wadell |
| ple | Comparative | | B | P | Si | C | Cr | f | c + d + | e × | Crystal | Bs | (Ecorr) | (μA/ | size | circu- |
| No. | example | a | a | b | c | d | e | (at %) | e)} | 10000 | structure | (T) | (mV) | cm²) | (μm) | larity |
| 145 | Comparative | 0.800 | 0.110 | 0.020 | 0.030 | 0.010 | 0.000 | 0.000 | 0.000 | 0.0 | Amorphous | 1.45 | −643 | 50.3 | 19.5 | 0.71 |
| | example | | | | | | | | | | | | | | | |
| 146 | Comparative | 0.800 | 0.110 | 0.020 | 0.030 | 0.010 | 0.000 | 0.002 | 0.0030 | 0.0 | Amorphous | 1.45 | −605 | 38.6 | 20.0 | 0.81 |
| | example | | | | | | | | | | | | | | | |
| 147 | Comparative | 0.800 | 0.110 | 0.020 | 0.030 | 0.010 | 0.000 | 0.005 | 0.0075 | 0.0 | Amorphous | 1.45 | −575 | 30.0 | 19.9 | 0.82 |
| | example | | | | | | | | | | | | | | | |
| 148 | Comparative | 0.800 | 0.110 | 0.020 | 0.030 | 0.010 | 0.000 | 0.015 | 0.023 | 0.0 | Amorphous | 1.45 | −556 | 29.8 | 19.7 | 0.85 |
| | example | | | | | | | | | | | | | | | |
| 149 | Comparative | 0.800 | 0.110 | 0.020 | 0.030 | 0.010 | 0.000 | 0.025 | 0.038 | 0.0 | Amorphous | 1.45 | −532 | 23.0 | 20.2 | 0.86 |
| | example | | | | | | | | | | | | | | | |
| 150 | Comparative | 0.800 | 0.110 | 0.020 | 0.030 | 0.010 | 0.000 | 0.040 | 0.060 | 0.0 | Amorphous | 1.45 | −523 | 22.0 | 20.5 | 0.88 |
| | example | | | | | | | | | | | | | | | |
| 151 | Comparative | 0.800 | 0.110 | 0.020 | 0.030 | 0.010 | 0.000 | 0.080 | 0.12 | 0.0 | Amorphous | 1.45 | −523 | 21.1 | 19.4 | 0.91 |
| | example | | | | | | | | | | | | | | | |
| 152 | Comparative | 0.800 | 0.110 | 0.020 | 0.030 | 0.010 | 0.000 | 0.100 | 0.15 | 0.0 | Amorphous | 1.45 | −522 | 21.2 | 19.4 | 0.91 |
| | example | | | | | | | | | | | | | | | |
| 153 | Comparative | 0.800 | 0.110 | 0.020 | 0.030 | 0.010 | 0.000 | 1.000 | 1.5 | 0.0 | Amorphous | 1.45 | −521 | 21.4 | 20.3 | 0.90 |
| | example | | | | | | | | | | | | | | | |
| 154 | Comparative | 0.800 | 0.110 | 0.020 | 0.030 | 0.010 | 0.000 | 2.000 | 3.0 | 0.0 | Amorphous | 1.45 | −519 | 21.1 | 19.6 | 0.89 |
| | example | | | | | | | | | | | | | | | |
| 155 | Comparative | 0.800 | 0.110 | 0.020 | 0.030 | 0.010 | 0.000 | 2.800 | 4.2 | 0.0 | Amorphous | 1.44 | −511 | 20.2 | 19.8 | 0.89 |
| | example | | | | | | | | | | | | | | | |
| 156 | Comparative | 0.800 | 0.110 | 0.020 | 0.030 | 0.010 | 0.000 | 3.000 | 4.5 | 0.0 | Crystal | 1.44 | −712 | 52.2 | 19.4 | 0.87 |
| | example | | | | | | | | | | | | | | | |

Tables 1A to 1M show results of examples and comparative examples which were performed under the same conditions except for changing the Co amount (α) with respect to Fe and the Mn amount (f). When the Co amount (α) with respect to Fe and the Mn amount (f) were within the predetermined ranges, Bs and the corrosion resistance were good. On the contrary to this, when the Co amount (α) with respect to Fe was too small and the Mn amount was out of the predetermined range, the corrosion resistance decreased. Also, when the Co amount (α) with respect to Fe was too large, Bs decreased. Further, when the Mn amount was too large, crystals were formed in the soft magnetic alloy ribbon, and the amorphous ratio X was less than 85%.

TABLE 2A

| | | | | | | | | | | | | | | Corro- | | |
|---|---|---|---|---|---|---|---|---|---|---|---|---|---|---|---|---|
| | | | | | | | | | | a{1 − | | | Corro- | sion | Aver | |
| | | | | | | | | | | (a + b + | | | sion | current | age | Aver- |
| | Example/ | (Fe₍₁₋ₐ₎COₐ)_{(1-(a+b+c+d+e))}BₐP_{b}Si_{c}C_{d}Crₑ | | | | | | | f/a{1 − | c + d + | | | poten- | density | par- | age |
| Sam- | Compar- | (β = 0) | | | | | | Mn | (a + b + | e)} × | | | tial | (icorr) | ticle | Wadell |
| ple | ative | | B | P | Si | C | Cr | f | c + d + | e × | Crystal | Bs | (Ecorr) | (μA/ | size | circu- |
| No. | example | a | a | b | c | d | e | (at %) | e)} | 10000 | structure | (T) | (mV) | cm²) | (μm) | larity |
| 54 | Example | 0.050 | 0.110 | 0.020 | 0.030 | 0.010 | 0.000 | 0.040 | 0.96 | 0.0 | Amorphous | 1.71 | −602 | 33.7 | 20.1 | 0.91 |
| 78 | Example | 0.150 | 0.110 | 0.020 | 0.030 | 0.010 | 0.000 | 0.040 | 0.32 | 0.0 | Amorphous | 1.76 | −579 | 31.1 | 19.8 | 0.94 |
| 90 | Example | 0.300 | 0.110 | 0.020 | 0.030 | 0.010 | 0.000 | 0.040 | 0.16 | 0.0 | Amorphous | 1.77 | −568 | 21.4 | 20.0 | 0.94 |
| 102 | Example | 0.450 | 0.110 | 0.020 | 0.030 | 0.010 | 0.000 | 0.040 | 0.11 | 0.0 | Amorphous | 1.75 | −556 | 22.1 | 19.4 | 0.94 |
| 126 | Example | 0.600 | 0.110 | 0.020 | 0.030 | 0.010 | 0.000 | 0.040 | 0.080 | 0.0 | Amorphous | 1.64 | −534 | 21.5 | 19.3 | 0.93 |
| 157 | Example | 0.050 | 0.110 | 0.020 | 0.030 | 0.010 | 0.001 | 0.040 | 0.97 | 0.415 | Amorphous | 1.70 | −601 | 33.1 | 19.4 | 0.91 |
| 158 | Example | 0.150 | 0.110 | 0.020 | 0.030 | 0.010 | 0.001 | 0.040 | 0.32 | 1.24 | Amorphous | 1.72 | −572 | 26.5 | 21.3 | 0.94 |
| 159 | Example | 0.300 | 0.110 | 0.020 | 0.030 | 0.010 | 0.001 | 0.040 | 0.16 | 2.49 | Amorphous | 1.76 | −550 | 21.1 | 20.5 | 0.94 |
| 160 | Example | 0.450 | 0.110 | 0.020 | 0.030 | 0.010 | 0.001 | 0.040 | 0.11 | 3.73 | Amorphous | 1.74 | −525 | 21.0 | 20.5 | 0.94 |
| 161 | Example | 0.600 | 0.110 | 0.020 | 0.030 | 0.010 | 0.001 | 0.040 | 0.08 | 4.97 | Amorphous | 1.64 | −510 | 20.1 | 20.9 | 0.93 |
| 162 | Example | 0.050 | 0.110 | 0.020 | 0.030 | 0.010 | 0.005 | 0.040 | 0.97 | 2.06 | Amorphous | 1.69 | −598 | 28.3 | 21.8 | 0.91 |
| 163 | Example | 0.150 | 0.110 | 0.020 | 0.030 | 0.010 | 0.005 | 0.040 | 0.32 | 6.19 | Amorphous | 1.71 | −572 | 26.3 | 20.3 | 0.94 |
| 164 | Example | 0.300 | 0.110 | 0.020 | 0.030 | 0.010 | 0.005 | 0.040 | 0.16 | 12.4 | Amorphous | 1.74 | −550 | 21.0 | 21.2 | 0.94 |
| 165 | Example | 0.450 | 0.110 | 0.020 | 0.030 | 0.010 | 0.005 | 0.040 | 0.11 | 18.6 | Amorphous | 1.72 | −520 | 20.0 | 19.3 | 0.94 |
| 166 | Example | 0.600 | 0.110 | 0.020 | 0.030 | 0.010 | 0.005 | 0.040 | 0.08 | 24.8 | Amorphous | 1.63 | −509 | 19.8 | 21.9 | 0.93 |

TABLE 2B

| | | | | | | | | | | | | | | Corro- | | |
|---|---|---|---|---|---|---|---|---|---|---|---|---|---|---|---|---|
| | | | | | | | | | | a{1 − | | | Corro- | sion | Aver- | |
| | | | | | | | | | | (a + b + | | | sion | current | age | Aver- |
| | Example/ | (Fe₍₁₋ₐ₎COₐ)_{(1-(a+b+c+d+e))}BₐP_{b}Si_{c}C_{d}Crₑ | | | | | | | f/a{1 − | c + d + | | | poten- | density | par- | age |
| Sam- | Compar- | (β = 0) | | | | | | Mn | (a + b + | e)} × | | | tial | (icorr) | ticle | Wadell |
| ple | ative | | B | P | Si | C | Cr | f | c + d + | e × | Crystal | Bs | (Ecorr) | (μA/ | size | circu- |
| No. | example | a | a | b | c | d | e | (at %) | e)} | 10000 | structure | (T) | (mV) | cm²) | (μm) | larity |
| 167 | Compar- | 0.000 | 0.110 | 0.020 | 0.030 | 0.010 | 0.010 | 0.040 | — | 0.0 | Amorphous | 1.57 | −675 | 56.0 | 18.9 | 0.9 |
| | ative | | | | | | | | | | | | | | | |
| | example | | | | | | | | | | | | | | | |
| 168 | Example | 0.005 | 0.110 | 0.020 | 0.030 | 0.010 | 0.010 | 0.040 | 9.8 | 0.410 | Amorphous | 1.62 | −611 | 38.0 | 19.2 | 0.91 |
| 169 | Example | 0.010 | 0.110 | 0.020 | 0.030 | 0.010 | 0.010 | 0.040 | 4.9 | 0.820 | Amorphous | 1.65 | −601 | 35.0 | 19.5 | 0.9 |
| 170 | Example | 0.050 | 0.110 | 0.020 | 0.030 | 0.010 | 0.010 | 0.040 | 0.98 | 4.10 | Amorphous | 1.68 | −597 | 27.2 | 20.1 | 0.91 |
| 171 | Example | 0.100 | 0.110 | 0.020 | 0.030 | 0.010 | 0.010 | 0.040 | 0.49 | 8.20 | Amorphous | 1.69 | −577 | 26.0 | 18.7 | 0.94 |
| 172 | Example | 0.150 | 0.110 | 0.020 | 0.030 | 0.010 | 0.010 | 0.040 | 0.33 | 12.3 | Amorphous | 1.68 | −568 | 25.5 | 19.1 | 0.94 |
| 173 | Example | 0.300 | 0.110 | 0.020 | 0.030 | 0.010 | 0.010 | 0.040 | 0.16 | 24.6 | Amorphous | 1.69 | −540 | 20.1 | 21.2 | 0.94 |
| 174 | Example | 0.450 | 0.110 | 0.020 | 0.030 | 0.010 | 0.010 | 0.040 | 0.11 | 36.9 | Amorphous | 1.69 | −516 | 19.3 | 19.0 | 0.94 |
| 175 | Example | 0.500 | 0.110 | 0.020 | 0.030 | 0.010 | 0.010 | 0.040 | 0.10 | 41.0 | Amorphous | 1.68 | −511 | 18.4 | 20.6 | 0.94 |
| 176 | Example | 0.600 | 0.110 | 0.020 | 0.030 | 0.010 | 0.010 | 0.040 | 0.081 | 49.2 | Amorphous | 1.62 | −503 | 18.2 | 20.6 | 0.93 |
| 177 | Example | 0.700 | 0.110 | 0.020 | 0.030 | 0.010 | 0.010 | 0.040 | 0.070 | 57.4 | Amorphous | 1.54 | −493 | 18.1 | 18.7 | 0.89 |
| 178 | Compar- | 0.800 | 0.110 | 0.020 | 0.030 | 0.010 | 0.010 | 0.040 | 0.061 | 65.6 | Amorphous | 1.48 | −487 | 16.0 | 20.4 | 0.88 |
| | ative | | | | | | | | | | | | | | | |
| | example | | | | | | | | | | | | | | | |
| 179 | Example | 0.050 | 0.110 | 0.020 | 0.030 | 0.010 | 0.020 | 0.040 | 0.99 | 8.10 | Amorphous | 1.62 | −466 | 16.4 | 20.4 | 0.91 |
| 180 | Example | 0.150 | 0.110 | 0.020 | 0.030 | 0.010 | 0.020 | 0.040 | 0.33 | 24.3 | Amorphous | 1.62 | −420 | 14.4 | 20.2 | 0.93 |
| 181 | Example | 0.300 | 0.110 | 0.020 | 0.030 | 0.010 | 0.020 | 0.040 | 0.16 | 48.6 | Amorphous | 1.62 | −330 | 6.2 | 18.8 | 0.94 |
| 182 | Example | 0.450 | 0.110 | 0.020 | 0.030 | 0.010 | 0.020 | 0.040 | 0.11 | 72.9 | Amorphous | 1.59 | −298 | 5.0 | 19.4 | 0.93 |
| 183 | Example | 0.600 | 0.110 | 0.020 | 0.030 | 0.010 | 0.020 | 0.040 | 0.082 | 97.2 | Amorphous | 1.55 | −234 | 3.2 | 19.4 | 0.93 |
| 184 | Example | 0.050 | 0.110 | 0.020 | 0.030 | 0.010 | 0.040 | 0.040 | 1.0 | 15.8 | Amorphous | 1.52 | −307 | 7.2 | 18.7 | 0.91 |
| 185 | Example | 0.150 | 0.110 | 0.020 | 0.030 | 0.010 | 0.040 | 0.040 | 0.34 | 47.4 | Amorphous | 1.56 | −255 | 4.3 | 19.7 | 0.93 |
| 186 | Example | 0.300 | 0.110 | 0.020 | 0.030 | 0.010 | 0.040 | 0.040 | 0.17 | 94.8 | Amorphous | 1.55 | −204 | 2.1 | 21.1 | 0.94 |
| 187 | Example | 0.450 | 0.110 | 0.020 | 0.030 | 0.010 | 0.040 | 0.040 | 0.11 | 142 | Amorphous | 1.54 | −132 | 1.0 | 20.9 | 0.94 |
| 188 | Example | 0.600 | 0.110 | 0.020 | 0.030 | 0.010 | 0.040 | 0.040 | 0.084 | 190 | Amorphous | 1.51 | −52 | 0.3 | 19.8 | 0.93 |
| 189 | Compar- | 0.050 | 0.110 | 0.020 | 0.030 | 0.010 | 0.050 | 0.040 | 1.0 | 19.5 | Amorphous | 1.44 | −180 | 4.0 | 19.5 | 0.90 |
| | ative | | | | | | | | | | | | | | | |
| | example | | | | | | | | | | | | | | | |
| 190 | Compar- | 0.150 | 0.110 | 0.020 | 0.030 | 0.010 | 0.050 | 0.040 | 0.34 | 58.5 | Amorphous | 1.48 | −160 | 3.2 | 18.8 | 0.92 |
| | ative | | | | | | | | | | | | | | | |
| | example | | | | | | | | | | | | | | | |
| 191 | Compar- | 0.300 | 0.110 | 0.020 | 0.030 | 0.010 | 0.050 | 0.040 | 0.17 | 117 | Amorphous | 1.49 | −102 | 1.2 | 19.5 | 0.94 |
| | ative | | | | | | | | | | | | | | | |
| | example | | | | | | | | | | | | | | | |
| 192 | Compar- | 0.450 | 0.110 | 0.020 | 0.030 | 0.010 | 0.050 | 0.040 | 0.11 | 176 | Amorphous | 1.49 | −30 | 0.2 | 21.4 | 0.93 |
| | ative | | | | | | | | | | | | | | | |
| | example | | | | | | | | | | | | | | | |
| 193 | Compar- | 0.600 | 0.110 | 0.020 | 0.030 | 0.010 | 0.050 | 0.040 | 0.11 | 176 | Amorphous | 1.49 | −20 | 0.1 | 20.9 | 0.93 |
| | ative | | | | | | | | | | | | | | | |
| | example | | | | | | | | | | | | | | | |

TABLE 3A

| | | | | | | | | | | | | | | Corro- | | |
|---|---|---|---|---|---|---|---|---|---|---|---|---|---|---|---|---|
| | | | | | | | | | | a{1 − | | | Corro- | sion | Aver- | |
| | | | | | | | | | | (a + b + | | | sion | current | age | Aver- |
| | | (Fe₍₁₋ₐ₎COₐ)_{(1-(a+b+c+d+e))}BₐP_{b}Si_{c}C_{d}Crₑ | | | | | | | f/a{1 − | c + d + | | | poten- | density | par- | age |
| Sam- | Example/ | (β = 0) | | | | | | Mn | (a + b + | e)} × | | | tial | (icorr) | ticle | Wadell |
| ple | Comparative | | B | P | Si | C | Cr | f | c + d + | e × | Crystal | Bs | (Ecorr) | (μA/ | size | circu- |
| No. | example | a | a | b | c | d | e | (at %) | e)} | 10000 | structure | (T) | (mV) | cm²) | (μm) | larity |
| 194 | Example | 0.050 | 0.110 | 0.000 | 0.030 | 0.010 | 0.010 | 0.040 | 0.95 | 4.20 | Amorphous | 1.68 | −605 | 29.3 | 20.0 | 0.91 |
| 195 | Example | 0.150 | 0.110 | 0.000 | 0.030 | 0.010 | 0.010 | 0.040 | 0.32 | 12.6 | Amorphous | 1.69 | −589 | 26.0 | 19.8 | 0.93 |
| 196 | Example | 0.300 | 0.110 | 0.000 | 0.030 | 0.010 | 0.010 | 0.040 | 0.16 | 25.2 | Amorphous | 1.71 | −550 | 22.0 | 21.1 | 0.94 |
| 197 | Example | 0.450 | 0.110 | 0.000 | 0.030 | 0.010 | 0.010 | 0.040 | 0.11 | 37.8 | Amorphous | 1.70 | −547 | 21.0 | 18.7 | 0.94 |
| 198 | Example | 0.600 | 0.110 | 0.000 | 0.030 | 0.010 | 0.010 | 0.040 | 0.079 | 50.4 | Amorphous | 1.59 | −544 | 20.1 | 21.5 | 0.93 |
| 199 | Example | 0.050 | 0.110 | 0.001 | 0.030 | 0.010 | 0.010 | 0.040 | 0.95 | 4.20 | Amorphous | 1.67 | −604 | 28.3 | 21.4 | 0.91 |
| 200 | Example | 0.150 | 0.110 | 0.001 | 0.030 | 0.010 | 0.010 | 0.040 | 0.32 | 12.6 | Amorphous | 1.69 | −571 | 25.6 | 18.7 | 0.93 |
| 201 | Example | 0.300 | 0.110 | 0.001 | 0.030 | 0.010 | 0.010 | 0.040 | 0.16 | 25.2 | Amorphous | 1.70 | −540 | 21.1 | 20.7 | 0.94 |
| 202 | Example | 0.450 | 0.110 | 0.001 | 0.030 | 0.010 | 0.010 | 0.040 | 0.11 | 37.8 | Amorphous | 1.70 | −522 | 20.0 | 20.0 | 0.94 |
| 203 | Example | 0.600 | 0.110 | 0.001 | 0.030 | 0.010 | 0.010 | 0.040 | 0.079 | 50.3 | Amorphous | 1.59 | −510 | 19.8 | 21.3 | 0.93 |
| 204 | Example | 0.050 | 0.110 | 0.010 | 0.030 | 0.010 | 0.010 | 0.040 | 0.96 | 4.15 | Amorphous | 1.66 | −600 | 28.2 | 21.1 | 0.92 |
| 205 | Example | 0.150 | 0.110 | 0.010 | 0.030 | 0.010 | 0.010 | 0.040 | 0.32 | 12.5 | Amorphous | 1.67 | −570 | 25.5 | 20.7 | 0.94 |
| 206 | Example | 0.300 | 0.110 | 0.010 | 0.030 | 0.010 | 0.010 | 0.040 | 0.16 | 24.9 | Amorphous | 1.69 | −538 | 20.5 | 20.4 | 0.94 |
| 207 | Example | 0.450 | 0.110 | 0.010 | 0.030 | 0.010 | 0.010 | 0.040 | 0.11 | 37.4 | Amorphous | 1.67 | −518 | 19.8 | 20.9 | 0.94 |
| 208 | Example | 0.600 | 0.110 | 0.010 | 0.030 | 0.010 | 0.010 | 0.040 | 0.080 | 49.8 | Amorphous | 1.58 | −505 | 18.2 | 21.2 | 0.93 |
| 170 | Example | 0.050 | 0.110 | 0.020 | 0.030 | 0.010 | 0.010 | 0.040 | 0.98 | 4.10 | Amorphous | 1.68 | −597 | 27.2 | 20.1 | 0.91 |
| 172 | Example | 0.150 | 0.110 | 0.020 | 0.030 | 0.010 | 0.010 | 0.040 | 0.33 | 12.3 | Amorphous | 1.68 | −568 | 25.5 | 19.1 | 0.94 |
| 173 | Example | 0.300 | 0.110 | 0.020 | 0.030 | 0.010 | 0.010 | 0.040 | 0.16 | 24.6 | Amorphous | 1.69 | −540 | 20.1 | 21.2 | 0.94 |
| 174 | Example | 0.450 | 0.110 | 0.020 | 0.030 | 0.010 | 0.010 | 0.040 | 0.11 | 36.9 | Amorphous | 1.69 | −516 | 19.3 | 19.0 | 0.94 |
| 176 | Example | 0.600 | 0.110 | 0.020 | 0.030 | 0.010 | 0.010 | 0.040 | 0.081 | 49.2 | Amorphous | 1.62 | −503 | 18.2 | 20.6 | 0.93 |
| 209 | Example | 0.050 | 0.110 | 0.030 | 0.030 | 0.010 | 0.010 | 0.040 | 0.99 | 4.05 | Amorphous | 1.65 | −587 | 26.9 | 19.3 | 0.92 |
| 210 | Example | 0.150 | 0.110 | 0.030 | 0.030 | 0.010 | 0.010 | 0.040 | 0.33 | 12.2 | Amorphous | 1.66 | −555 | 25.1 | 20.7 | 0.94 |
| 211 | Example | 0.300 | 0.110 | 0.030 | 0.030 | 0.010 | 0.010 | 0.040 | 0.16 | 24.3 | Amorphous | 1.67 | −532 | 20.0 | 21.5 | 0.94 |
| 212 | Example | 0.450 | 0.110 | 0.030 | 0.030 | 0.010 | 0.010 | 0.040 | 0.11 | 36.5 | Amorphous | 1.65 | −514 | 18.1 | 21.0 | 0.94 |
| 213 | Example | 0.600 | 0.110 | 0.030 | 0.030 | 0.010 | 0.010 | 0.040 | 0.082 | 48.6 | Amorphous | 1.60 | −499 | 17.4 | 20.3 | 0.93 |

TABLE 3B

| | | | | | | | | | | | | | | Corro- | | |
|---|---|---|---|---|---|---|---|---|---|---|---|---|---|---|---|---|
| | | | | | | | | | | a{1 − | | | Corro- | sion | Aver- | |
| | | | | | | | | | | (a + b + | | | sion | current | age | Aver- |
| | Example/ | (Fe₍₁₋ₐ₎COₐ)_{(1-(a+b+c+d+e))}BₐP_{b}Si_{c}C_{d}Crₑ | | | | | | | f/a{1 − | c + d + | | | poten- | density | par- | age |
| Sam- | Compar- | (β = 0) | | | | | | Mn | (a + b + | e)} × | | | tial | (icorr) | ticle | Wadell |
| ple | ative | | B | P | Si | C | Cr | f | c + d + | e × | Crystal | Bs | (Ecorr) | (μA/ | size | circu- |
| No. | example | a | a | b | c | d | e | (at %) | e)} | 10000 | structure | (T) | (mV) | cm²) | (μm) | larity |
| 214 | Example | 0.050 | 0.110 | 0.040 | 0.030 | 0.010 | 0.010 | 0.040 | 1.0 | 4.00 | Amorphous | 1.62 | −578 | 26.4 | 18.7 | 0.92 |
| 215 | Example | 0.150 | 0.110 | 0.040 | 0.030 | 0.010 | 0.010 | 0.040 | 0.33 | 12.0 | Amorphous | 1.63 | −545 | 25.2 | 21.2 | 0.94 |
| 216 | Example | 0.300 | 0.110 | 0.040 | 0.030 | 0.010 | 0.010 | 0.040 | 0.17 | 24.0 | Amorphous | 1.64 | −530 | 19.8 | 20.1 | 0.94 |
| 217 | Example | 0.450 | 0.110 | 0.040 | 0.030 | 0.010 | 0.010 | 0.040 | 0.11 | 36.0 | Amorphous | 1.64 | −510 | 17.2 | 19.2 | 0.94 |
| 218 | Example | 0.600 | 0.110 | 0.040 | 0.030 | 0.010 | 0.010 | 0.040 | 0.083 | 48.0 | Amorphous | 1.61 | −487 | 17.0 | 20.0 | 0.93 |
| 219 | Example | 0.050 | 0.110 | 0.050 | 0.030 | 0.010 | 0.010 | 0.040 | 1.0 | 3.95 | Amorphous | 1.58 | −567 | 26.0 | 18.7 | 0.92 |
| 220 | Example | 0.150 | 0.110 | 0.050 | 0.030 | 0.010 | 0.010 | 0.040 | 0.34 | 11.9 | Amorphous | 1.56 | −542 | 25.0 | 21.4 | 0.94 |
| 221 | Example | 0.300 | 0.110 | 0.050 | 0.030 | 0.010 | 0.010 | 0.040 | 0.17 | 23.7 | Amorphous | 1.57 | −525 | 18.1 | 20.1 | 0.94 |
| 222 | Example | 0.450 | 0.110 | 0.050 | 0.030 | 0.010 | 0.010 | 0.040 | 0.11 | 35.6 | Amorphous | 1.57 | −498 | 16.6 | 20.0 | 0.94 |
| 223 | Example | 0.600 | 0.110 | 0.050 | 0.030 | 0.010 | 0.010 | 0.040 | 0.084 | 47.4 | Amorphous | 1.55 | −470 | 16.4 | 21.4 | 0.93 |
| 224 | Example | 0.050 | 0.110 | 0.060 | 0.030 | 0.010 | 0.010 | 0.040 | 1.0 | 3.90 | Amorphous | 1.52 | −566 | 25.8 | 18.5 | 0.92 |
| 225 | Example | 0.150 | 0.110 | 0.060 | 0.030 | 0.010 | 0.010 | 0.040 | 0.34 | 11.7 | Amorphous | 1.53 | −540 | 24.3 | 20.4 | 0.94 |
| 226 | Example | 0.300 | 0.110 | 0.060 | 0.030 | 0.010 | 0.010 | 0.040 | 0.17 | 23.4 | Amorphous | 1.54 | −520 | 17.5 | 19.9 | 0.94 |
| 227 | Example | 0.450 | 0.110 | 0.060 | 0.030 | 0.010 | 0.010 | 0.040 | 0.11 | 35.1 | Amorphous | 1.52 | −488 | 15.7 | 21.2 | 0.94 |
| 228 | Example | 0.600 | 0.110 | 0.060 | 0.030 | 0.010 | 0.010 | 0.040 | 0.085 | 46.8 | Amorphous | 1.51 | −466 | 15.3 | 19.0 | 0.93 |
| 229 | Example | 0.050 | 0.110 | 0.070 | 0.030 | 0.010 | 0.010 | 0.040 | 1.0 | 3.85 | Amorphous | 1.51 | −555 | 25.7 | 19.1 | 0.92 |
| 230 | Example | 0.150 | 0.110 | 0.070 | 0.030 | 0.010 | 0.010 | 0.040 | 0.35 | 11.6 | Amorphous | 1.52 | −534 | 24.1 | 20.7 | 0.94 |
| 231 | Example | 0.300 | 0.110 | 0.070 | 0.030 | 0.010 | 0.010 | 0.040 | 0.17 | 23.1 | Amorphous | 1.53 | −513 | 16.6 | 19.8 | 0.94 |
| 232 | Example | 0.450 | 0.110 | 0.070 | 0.030 | 0.010 | 0.010 | 0.040 | 0.12 | 34.7 | Amorphous | 1.53 | −477 | 15.2 | 18.5 | 0.94 |
| 233 | Example | 0.600 | 0.110 | 0.070 | 0.030 | 0.010 | 0.010 | 0.040 | 0.087 | 46.2 | Amorphous | 1.50 | −465 | 14.1 | 19.1 | 0.93 |
| 234 | Compar- | 0.050 | 0.110 | 0.080 | 0.030 | 0.010 | 0.010 | 0.040 | 1.1 | 3.80 | Amorphous | 1.46 | −564 | 24.8 | 18.8 | 0.92 |
| | ative | | | | | | | | | | | | | | | |
| | example | | | | | | | | | | | | | | | |
| 235 | Compar- | 0.150 | 0.110 | 0.080 | 0.030 | 0.010 | 0.010 | 0.040 | 0.35 | 11.4 | Amorphous | 1.49 | −532 | 23.6 | 18.7 | 0.94 |
| | ative | | | | | | | | | | | | | | | |
| | example | | | | | | | | | | | | | | | |
| 236 | Compar- | 0.300 | 0.110 | 0.080 | 0.030 | 0.010 | 0.010 | 0.040 | 0.18 | 22.8 | Amorphous | 1.48 | −511 | 16.3 | 21.1 | 0.94 |
| | ative | | | | | | | | | | | | | | | |
| | example | | | | | | | | | | | | | | | |
| 237 | Compar- | 0.450 | 0.110 | 0.080 | 0.030 | 0.010 | 0.010 | 0.040 | 0.12 | 34.2 | Amorphous | 1.47 | −466 | 14.7 | 19.1 | 0.94 |
| | ative | | | | | | | | | | | | | | | |
| | example | | | | | | | | | | | | | | | |
| 238 | Compar- | 0.600 | 0.110 | 0.080 | 0.030 | 0.010 | 0.010 | 0.040 | 0.088 | 45.6 | Amorphous | 1.44 | −450 | 13.6 | 19.2 | 0.93 |
| | ative | | | | | | | | | | | | | | | |
| | example | | | | | | | | | | | | | | | |

TABLE 4A

| | | | | | | | | | | | | | | Corro- | | |
|---|---|---|---|---|---|---|---|---|---|---|---|---|---|---|---|---|
| | | | | | | | | | | a{1 − | | | Corro- | sion | Aver- | |
| | | | | | | | | | | (a + b + | | | sion | current | age | Aver- |
| | Example/ | (Fe₍₁₋ₐ₎COₐ)_{(1-(a+b+c+d+e))}BₐP_{b}Si_{c}C_{d}Crₑ | | | | | | | f/a{1 − | c + d + | | | poten- | density | par- | age |
| Sam- | Compar- | (β = 0) | | | | | | Mn | (a + b + | e)} × | | | tial | (icorr) | ticle | Wadell |
| ple | ative | | B | P | Si | C | Cr | f | c + d + | e × | Crystal | Bs | (Ecorr) | (μA/ | size | circu- |
| No. | example | a | a | b | c | d | e | (at %) | e)} | 10000 | structure | (T) | (mV) | cm²) | (μm) | larity |
| 239 | Example | 0.050 | 0.110 | 0.020 | 0.030 | 0.000 | 0.010 | 0.040 | 0.96 | 4.15 | Amorphous | 1.70 | −600 | 29.2 | 19.2 | 0.91 |
| 240 | Example | 0.150 | 0.110 | 0.020 | 0.030 | 0.000 | 0.010 | 0.040 | 0.32 | 12.5 | Amorphous | 1.71 | −570 | 25.5 | 20.4 | 0.93 |
| 241 | Example | 0.300 | 0.110 | 0.020 | 0.030 | 0.000 | 0.010 | 0.040 | 0.16 | 24.9 | Amorphous | 1.71 | −544 | 20.4 | 18.7 | 0.94 |
| 242 | Example | 0.450 | 0.110 | 0.020 | 0.030 | 0.000 | 0.010 | 0.040 | 0.11 | 37.4 | Amorphous | 1.70 | −518 | 19.4 | 21.2 | 0.94 |
| 243 | Example | 0.600 | 0.110 | 0.020 | 0.030 | 0.000 | 0.010 | 0.040 | 0.080 | 49.8 | Amorphous | 1.64 | −512 | 18.2 | 21.3 | 0.93 |
| 244 | Example | 0.050 | 0.110 | 0.020 | 0.030 | 0.001 | 0.010 | 0.040 | 0.97 | 4.15 | Amorphous | 1.70 | −598 | 28.3 | 18.8 | 0.92 |
| 245 | Example | 0.150 | 0.110 | 0.020 | 0.030 | 0.001 | 0.010 | 0.040 | 0.32 | 12.4 | Amorphous | 1.71 | −569 | 25.3 | 18.7 | 0.93 |
| 246 | Example | 0.300 | 0.110 | 0.020 | 0.030 | 0.001 | 0.010 | 0.040 | 0.16 | 24.9 | Amorphous | 1.70 | −543 | 20.3 | 19.2 | 0.94 |
| 247 | Example | 0.450 | 0.110 | 0.020 | 0.030 | 0.001 | 0.010 | 0.040 | 0.11 | 37.3 | Amorphous | 1.70 | −517 | 19.3 | 21.0 | 0.94 |
| 248 | Example | 0.600 | 0.110 | 0.020 | 0.030 | 0.001 | 0.010 | 0.040 | 0.080 | 49.7 | Amorphous | 1.64 | −507 | 18.3 | 19.3 | 0.93 |
| 170 | Example | 0.050 | 0.110 | 0.020 | 0.030 | 0.010 | 0.010 | 0.040 | 0.98 | 4.10 | Amorphous | 1.68 | −597 | 27.2 | 20.1 | 0.91 |
| 172 | Example | 0.150 | 0.110 | 0.020 | 0.030 | 0.010 | 0.010 | 0.040 | 0.33 | 12.3 | Amorphous | 1.68 | −568 | 25.5 | 19.1 | 0.94 |
| 173 | Example | 0.300 | 0.110 | 0.020 | 0.030 | 0.010 | 0.010 | 0.040 | 0.16 | 24.6 | Amorphous | 1.69 | −540 | 20.1 | 21.2 | 0.94 |
| 174 | Example | 0.450 | 0.110 | 0.020 | 0.030 | 0.010 | 0.010 | 0.040 | 0.11 | 36.9 | Amorphous | 1.69 | −516 | 19.3 | 19.0 | 0.94 |
| 176 | Example | 0.600 | 0.110 | 0.020 | 0.030 | 0.010 | 0.010 | 0.040 | 0.081 | 49.2 | Amorphous | 1.62 | −503 | 18.2 | 20.6 | 0.93 |
| 249 | Example | 0.050 | 0.110 | 0.020 | 0.030 | 0.020 | 0.010 | 0.040 | 0.99 | 4.05 | Amorphous | 1.62 | −597 | 27.1 | 20.9 | 0.92 |
| 250 | Example | 0.150 | 0.110 | 0.020 | 0.030 | 0.020 | 0.010 | 0.040 | 0.33 | 12.2 | Amorphous | 1.64 | −566 | 25.4 | 19.9 | 0.94 |
| 251 | Example | 0.300 | 0.110 | 0.020 | 0.030 | 0.020 | 0.010 | 0.040 | 0.16 | 24.3 | Amorphous | 1.63 | −534 | 20.2 | 21.3 | 0.93 |
| 252 | Example | 0.450 | 0.110 | 0.020 | 0.030 | 0.020 | 0.010 | 0.040 | 0.11 | 36.5 | Amorphous | 1.63 | −514 | 19.2 | 19.6 | 0.93 |
| 253 | Example | 0.600 | 0.110 | 0.020 | 0.030 | 0.020 | 0.010 | 0.040 | 0.082 | 48.6 | Amorphous | 1.59 | −508 | 18.3 | 19.1 | 0.93 |

TABLE 4B

| | | | | | | | | | | | | | | Corro- | | |
|---|---|---|---|---|---|---|---|---|---|---|---|---|---|---|---|---|
| | | | | | | | | | | a{1 − | | | Corro- | sion | Aver- | |
| | | | | | | | | | | (a + b + | | | sion | current | age | Aver- |
| | | (Fe₍₁₋ₐ₎COₐ)_{(1-(a+b+c+d+e))}BₐP_{b}Si_{c}C_{d}Crₑ | | | | | | | f/a{1 − | c + d + | | | poten- | density | par- | age |
| Sam- | Example/ | (β = 0) | | | | | | Mn | (a + b + | e)} × | | | tial | (icorr) | ticle | Wadell |
| ple | Comparative | | B | P | Si | C | Cr | f | c + d + | e × | Crystal | Bs | (Ecorr) | (μA/ | size | circu- |
| No. | example | a | a | b | c | d | e | (at %) | e)} | 10000 | structure | (T) | (mV) | cm²) | (μm) | larity |
| 254 | Example | 0.050 | 0.110 | 0.020 | 0.030 | 0.030 | 0.010 | 0.040 | 1.0 | 4.00 | Amorphous | 1.60 | −596 | 27.0 | 19.8 | 0.92 |
| 255 | Example | 0.150 | 0.110 | 0.020 | 0.030 | 0.030 | 0.010 | 0.040 | 0.33 | 12.0 | Amorphous | 1.61 | −567 | 25.3 | 21.4 | 0.93 |
| 256 | Example | 0.300 | 0.110 | 0.020 | 0.030 | 0.030 | 0.010 | 0.040 | 0.17 | 24.0 | Amorphous | 1.59 | −533 | 20.1 | 21.3 | 0.93 |
| 257 | Example | 0.450 | 0.110 | 0.020 | 0.030 | 0.030 | 0.010 | 0.040 | 0.11 | 36.0 | Amorphous | 1.58 | −513 | 19.2 | 21.5 | 0.93 |
| 258 | Example | 0.600 | 0.110 | 0.020 | 0.030 | 0.030 | 0.010 | 0.040 | 0.083 | 48.0 | Amorphous | 1.56 | −500 | 18.4 | 19.7 | 0.93 |
| 259 | Example | 0.050 | 0.110 | 0.020 | 0.030 | 0.050 | 0.010 | 0.040 | 1.0 | 3.90 | Amorphous | 1.52 | −589 | 26.4 | 21.1 | 0.92 |
| 260 | Example | 0.150 | 0.110 | 0.020 | 0.030 | 0.050 | 0.010 | 0.040 | 0.34 | 11.7 | Amorphous | 1.53 | −565 | 25.5 | 21.5 | 0.93 |
| 261 | Example | 0.300 | 0.110 | 0.020 | 0.030 | 0.050 | 0.010 | 0.040 | 0.17 | 23.4 | Amorphous | 1.52 | −532 | 20.1 | 21.1 | 0.93 |
| 262 | Example | 0.450 | 0.110 | 0.020 | 0.030 | 0.050 | 0.010 | 0.040 | 0.11 | 35.1 | Amorphous | 1.51 | −511 | 19.1 | 18.7 | 0.93 |
| 263 | Example | 0.600 | 0.110 | 0.020 | 0.030 | 0.050 | 0.010 | 0.040 | 0.085 | 46.8 | Amorphous | 1.50 | −491 | 18.4 | 19.1 | 0.93 |
| 264 | Comparative | 0.050 | 0.110 | 0.020 | 0.030 | 0.060 | 0.010 | 0.040 | 1.0 | 3.85 | Amorphous | 1.48 | −585 | 26.3 | 20.8 | 0.92 |
| | example | | | | | | | | | | | | | | | |
| 265 | Comparative | 0.150 | 0.110 | 0.020 | 0.030 | 0.060 | 0.010 | 0.040 | 0.35 | 11.6 | Amorphous | 1.49 | −564 | 25.4 | 19.3 | 0.94 |
| | example | | | | | | | | | | | | | | | |
| 266 | Comparative | 0.300 | 0.110 | 0.020 | 0.030 | 0.060 | 0.010 | 0.040 | 0.17 | 23.1 | Amorphous | 1.48 | −524 | 19.8 | 18.9 | 0.93 |
| | example | | | | | | | | | | | | | | | |
| 267 | Comparative | 0.450 | 0.110 | 0.020 | 0.030 | 0.060 | 0.010 | 0.040 | 0.12 | 34.7 | Amorphous | 1.48 | −514 | 19.1 | 18.9 | 0.93 |
| | example | | | | | | | | | | | | | | | |
| 268 | Comparative | 0.600 | 0.110 | 0.020 | 0.030 | 0.060 | 0.010 | 0.040 | 0.087 | 46.2 | Amorphous | 1.46 | −487 | 18.1 | 20.2 | 0.93 |
| | example | | | | | | | | | | | | | | | |

TABLE 5A

| | | | | | | | | | | | | | | Corro- | | |
|---|---|---|---|---|---|---|---|---|---|---|---|---|---|---|---|---|
| | | | | | | | | | | a{1 − | | | Corro- | sion | Aver- | |
| | | | | | | | | | | (a + b + | | | sion | current | age | Aver- |
| | Example/ | (Fe₍₁₋ₐ₎COₐ)_{(1-(a+b+c+d+e))}BₐP_{b}Si_{c}C_{d}Crₑ | | | | | | | f/a{1 − | c + d + | | | poten- | density | par- | age |
| Sam- | Compar- | (β = 0) | | | | | | Mn | (a + b + | e)} × | | | tial | (icorr) | ticle | Wadell |
| ple | ative | | B | P | Si | C | Cr | f | c + d + | e × | Crystal | Bs | (Ecorr) | (μA/ | size | circu- |
| No. | example | a | a | b | c | d | e | (at %) | e)} | 10000 | structure | (T) | (mV) | cm²) | (μm) | larity |
| 269 | Example | 0.050 | 0.110 | 0.020 | 0.000 | 0.010 | 0.010 | 0.040 | 0.94 | 4.25 | Amorphous | 1.70 | −601 | 30.1 | 20.2 | 0.92 |
| 270 | Example | 0.150 | 0.110 | 0.020 | 0.000 | 0.010 | 0.010 | 0.040 | 0.31 | 12.8 | Amorphous | 1.71 | −578 | 28.0 | 21.3 | 0.93 |
| 271 | Example | 0.300 | 0.110 | 0.020 | 0.000 | 0.010 | 0.010 | 0.040 | 0.16 | 25.5 | Amorphous | 1.72 | −545 | 21.1 | 20.2 | 0.93 |
| 272 | Example | 0.450 | 0.110 | 0.020 | 0.000 | 0.010 | 0.010 | 0.040 | 0.10 | 38.3 | Amorphous | 1.71 | −520 | 20.1 | 19.5 | 0.93 |
| 273 | Example | 0.600 | 0.110 | 0.020 | 0.000 | 0.010 | 0.010 | 0.040 | 0.078 | 51.0 | Amorphous | 1.66 | −502 | 19.2 | 20.7 | 0.93 |
| 274 | Example | 0.050 | 0.110 | 0.020 | 0.010 | 0.010 | 0.010 | 0.040 | 0.95 | 4.20 | Amorphous | 1.71 | −598 | 29.2 | 20.6 | 0.92 |
| 275 | Example | 0.150 | 0.110 | 0.020 | 0.010 | 0.010 | 0.010 | 0.040 | 0.32 | 12.6 | Amorphous | 1.72 | −570 | 27.5 | 20.1 | 0.93 |
| 276 | Example | 0.300 | 0.110 | 0.020 | 0.010 | 0.010 | 0.010 | 0.040 | 0.16 | 25.2 | Amorphous | 1.71 | −543 | 21.3 | 18.7 | 0.93 |
| 277 | Example | 0.450 | 0.110 | 0.020 | 0.010 | 0.010 | 0.010 | 0.040 | 0.11 | 37.8 | Amorphous | 1.71 | −518 | 20.0 | 18.7 | 0.93 |
| 278 | Example | 0.600 | 0.110 | 0.020 | 0.010 | 0.010 | 0.010 | 0.040 | 0.079 | 50.4 | Amorphous | 1.65 | −504 | 18.7 | 20.8 | 0.93 |
| 279 | Example | 0.050 | 0.110 | 0.020 | 0.020 | 0.010 | 0.010 | 0.040 | 0.96 | 4.15 | Amorphous | 1.69 | −599 | 29.3 | 19.1 | 0.92 |
| 280 | Example | 0.150 | 0.110 | 0.020 | 0.020 | 0.010 | 0.010 | 0.040 | 0.32 | 12.5 | Amorphous | 1.70 | −569 | 27.0 | 20.2 | 0.93 |
| 281 | Example | 0.300 | 0.110 | 0.020 | 0.020 | 0.010 | 0.010 | 0.040 | 0.16 | 24.9 | Amorphous | 1.70 | −542 | 21.4 | 21.5 | 0.93 |
| 282 | Example | 0.450 | 0.110 | 0.020 | 0.020 | 0.010 | 0.010 | 0.040 | 0.11 | 37.4 | Amorphous | 1.70 | −517 | 19.5 | 21.3 | 0.93 |
| 283 | Example | 0.600 | 0.110 | 0.020 | 0.020 | 0.010 | 0.010 | 0.040 | 0.080 | 49.8 | Amorphous | 1.64 | −503 | 18.5 | 20.4 | 0.93 |
| 170 | Example | 0.050 | 0.110 | 0.020 | 0.030 | 0.010 | 0.010 | 0.040 | 0.98 | 4.10 | Amorphous | 1.68 | −597 | 27.2 | 20.1 | 0.91 |
| 172 | Example | 0.150 | 0.110 | 0.020 | 0.030 | 0.010 | 0.010 | 0.040 | 0.33 | 12.3 | Amorphous | 1.68 | −568 | 25.5 | 19.1 | 0.94 |
| 173 | Example | 0.300 | 0.110 | 0.020 | 0.030 | 0.010 | 0.010 | 0.040 | 0.16 | 24.6 | Amorphous | 1.69 | −540 | 20.1 | 21.2 | 0.94 |
| 174 | Example | 0.450 | 0.110 | 0.020 | 0.030 | 0.010 | 0.010 | 0.040 | 0.11 | 36.9 | Amorphous | 1.69 | −516 | 19.3 | 19.0 | 0.94 |
| 176 | Example | 0.600 | 0.110 | 0.020 | 0.030 | 0.010 | 0.010 | 0.040 | 0.081 | 49.2 | Amorphous | 1.62 | −503 | 18.2 | 20.6 | 0.93 |

TABLE 5B

| | | | | | | | | | | | | | | Corro- | | |
|---|---|---|---|---|---|---|---|---|---|---|---|---|---|---|---|---|
| | | | | | | | | | | a{1 − | | | Corro- | sion | Aver- | |
| | | | | | | | | | | (a + b + | | | sion | current | age | Aver- |
| | | (Fe₍₁₋ₐ₎COₐ)_{(1-(a+b+c+d+e))}BₐP_{b}Si_{c}C_{d}Crₑ | | | | | | | f/a{1 − | c + d + | | | poten- | density | par- | age |
| Sam- | Example/ | (β = 0) | | | | | | Mn | (a + b + | e)} × | | | tial | (icorr) | ticle | Wadell |
| ple | Comparative | | B | P | Si | C | Cr | f | c + d + | e × | Crystal | Bs | (Ecorr) | μA/ | size | circu- |
| No. | example | a | a | b | c | d | e | (at %) | e)} | 10000 | structure | (T) | (mV) | (cm²) | (μm) | larity |
| 284 | Example | 0.050 | 0.110 | 0.020 | 0.050 | 0.010 | 0.010 | 0.040 | 1.0 | 4.00 | Amorphous | 1.64 | −598 | 26.7 | 21.1 | 0.92 |
| 285 | Example | 0.150 | 0.110 | 0.020 | 0.050 | 0.010 | 0.010 | 0.040 | 0.33 | 12.0 | Amorphous | 1.65 | −567 | 25.4 | 19.5 | 0.93 |
| 286 | Example | 0.300 | 0.110 | 0.020 | 0.050 | 0.010 | 0.010 | 0.040 | 0.17 | 24.0 | Amorphous | 1.64 | −538 | 19.5 | 20.2 | 0.93 |
| 287 | Example | 0.450 | 0.110 | 0.020 | 0.050 | 0.010 | 0.010 | 0.040 | 0.11 | 36.0 | Amorphous | 1.64 | −515 | 19.2 | 21.4 | 0.94 |
| 288 | Example | 0.600 | 0.110 | 0.020 | 0.050 | 0.010 | 0.010 | 0.040 | 0.083 | 48.0 | Amorphous | 1.58 | −502 | 18.1 | 18.9 | 0.93 |
| 289 | Example | 0.050 | 0.110 | 0.020 | 0.070 | 0.010 | 0.010 | 0.040 | 1.0 | 3.90 | Amorphous | 1.61 | −589 | 26.4 | 20.0 | 0.92 |
| 290 | Example | 0.150 | 0.110 | 0.020 | 0.070 | 0.010 | 0.010 | 0.040 | 0.34 | 11.7 | Amorphous | 1.61 | −566 | 25.3 | 19.7 | 0.93 |
| 291 | Example | 0.300 | 0.110 | 0.020 | 0.070 | 0.010 | 0.010 | 0.040 | 0.17 | 23.4 | Amorphous | 1.61 | −532 | 19.4 | 19.0 | 0.94 |
| 292 | Example | 0.450 | 0.110 | 0.020 | 0.070 | 0.010 | 0.010 | 0.040 | 0.11 | 35.1 | Amorphous | 1.60 | −513 | 19.1 | 19.8 | 0.93 |
| 293 | Example | 0.600 | 0.110 | 0.020 | 0.070 | 0.010 | 0.010 | 0.040 | 0.085 | 46.8 | Amorphous | 1.55 | −501 | 18.3 | 19.2 | 0.93 |
| 294 | Example | 0.050 | 0.110 | 0.020 | 0.100 | 0.010 | 0.010 | 0.040 | 1.1 | 3.75 | Amorphous | 1.52 | −586 | 26.4 | 19.1 | 0.91 |
| 295 | Example | 0.150 | 0.110 | 0.020 | 0.100 | 0.010 | 0.010 | 0.040 | 0.36 | 11.3 | Amorphous | 1.52 | −564 | 25.3 | 21.3 | 0.93 |
| 296 | Example | 0.300 | 0.110 | 0.020 | 0.100 | 0.010 | 0.010 | 0.040 | 0.18 | 22.5 | Amorphous | 1.52 | −531 | 19.2 | 18.9 | 0.93 |
| 297 | Example | 0.450 | 0.110 | 0.020 | 0.100 | 0.010 | 0.010 | 0.040 | 0.12 | 33.8 | Amorphous | 1.51 | −510 | 19.0 | 18.5 | 0.94 |
| 298 | Example | 0.600 | 0.110 | 0.020 | 0.100 | 0.010 | 0.010 | 0.040 | 0.089 | 45.0 | Amorphous | 1.50 | −503 | 18.4 | 18.8 | 0.93 |
| 299 | Comparative | 0.050 | 0.110 | 0.020 | 0.110 | 0.010 | 0.010 | 0.040 | 1.1 | 3.70 | Amorphous | 1.46 | −576 | 26.3 | 21.1 | 0.92 |
| | example | | | | | | | | | | | | | | | |
| 300 | Comparative | 0.150 | 0.110 | 0.020 | 0.110 | 0.010 | 0.010 | 0.040 | 0.36 | 11.1 | Amorphous | 1.48 | −555 | 25.0 | 18.8 | 0.94 |
| | example | | | | | | | | | | | | | | | |
| 301 | Comparative | 0.300 | 0.110 | 0.020 | 0.110 | 0.010 | 0.010 | 0.040 | 0.18 | 22.2 | Amorphous | 1.48 | −554 | 24.7 | 18.8 | 0.94 |
| | example | | | | | | | | | | | | | | | |
| 302 | Comparative | 0.450 | 0.110 | 0.020 | 0.110 | 0.010 | 0.010 | 0.040 | 0.12 | 33.3 | Amorphous | 1.47 | −548 | 24.4 | 19.8 | 0.94 |
| | example | | | | | | | | | | | | | | | |
| 303 | Comparative | 0.600 | 0.110 | 0.020 | 0.110 | 0.010 | 0.010 | 0.040 | 0.090 | 44.4 | Amorphous | 1.44 | −530 | 23.3 | 20.0 | 0.93 |
| | example | | | | | | | | | | | | | | | |

TABLE 6A

| | | | | | | | | | | | | | | Corro- | | |
|---|---|---|---|---|---|---|---|---|---|---|---|---|---|---|---|---|
| | | | | | | | | | | | | | | sion | | |
| | | | | | | | | | | α{1 − | | | Corro- | current | | |
| | Example/ | (Fe_{(1-α)}CO_{α})_{(1-(a+b+c+d+e))}BₐP_{b}Si_{c}C_{d}Crₑ | | | | | | | f/α{1 − | (a + b + | | | sion | density | Average | Average |
| Sam- | Compar- | (β = 0) | | | | | | Mn | (a + b + | c + d + | | | potential | (icorr) | particle | Wadell |
| ple | ative | | B | P | Si | C | Cr | f | c + d + | e)} × | Crystal | Bs | (Ecorr) | (μA/ | size | circu- |
| No. | example | α | a | b | c | d | e | (at %) | e)} | e × 10000 | structure | (T) | (mV) | cm²) | (μm) | larity |
| 304 | Example | 0.050 | 0.050 | 0.020 | 0.030 | 0.010 | 0.010 | 0.040 | 0.91 | 4.40 | Amorphous | 1.76 | −612 | 32.2 | 20.8 | 0.92 |
| 305 | Example | 0.150 | 0.050 | 0.020 | 0.030 | 0.010 | 0.010 | 0.040 | 0.30 | 13.2 | Amorphous | 1.75 | −577 | 30.0 | 20.4 | 0.93 |
| 306 | Example | 0.300 | 0.050 | 0.020 | 0.030 | 0.010 | 0.010 | 0.040 | 0.15 | 26.4 | Amorphous | 1.80 | −550 | 29.3 | 21.4 | 0.93 |
| 307 | Example | 0.450 | 0.050 | 0.020 | 0.030 | 0.010 | 0.010 | 0.040 | 0.10 | 39.6 | Amorphous | 1.77 | −522 | 22.1 | 20.9 | 0.94 |
| 308 | Example | 0.600 | 0.050 | 0.020 | 0.030 | 0.010 | 0.010 | 0.040 | 0.076 | 52.8 | Amorphous | 1.72 | −502 | 19.8 | 20.0 | 0.93 |
| 309 | Example | 0.050 | 0.070 | 0.020 | 0.030 | 0.010 | 0.010 | 0.040 | 0.93 | 4.30 | Amorphous | 1.73 | −602 | 31.4 | 20.3 | 0.92 |
| 310 | Example | 0.150 | 0.070 | 0.020 | 0.030 | 0.010 | 0.010 | 0.040 | 0.31 | 12.9 | Amorphous | 1.73 | −575 | 28.2 | 18.5 | 0.93 |
| 311 | Example | 0.300 | 0.070 | 0.020 | 0.030 | 0.010 | 0.010 | 0.040 | 0.16 | 25.8 | Amorphous | 1.77 | −545 | 27.1 | 20.0 | 0.94 |
| 312 | Example | 0.450 | 0.070 | 0.020 | 0.030 | 0.010 | 0.010 | 0.040 | 0.10 | 38.7 | Amorphous | 1.74 | −524 | 21.4 | 21.4 | 0.93 |
| 313 | Example | 0.600 | 0.070 | 0.020 | 0.030 | 0.010 | 0.010 | 0.040 | 0.078 | 51.6 | Amorphous | 1.69 | −503 | 18.3 | 19.1 | 0.93 |
| 314 | Example | 0.050 | 0.090 | 0.020 | 0.030 | 0.010 | 0.010 | 0.040 | 0.95 | 4.20 | Amorphous | 1.72 | −601 | 29.8 | 19.2 | 0.93 |
| 315 | Example | 0.150 | 0.090 | 0.020 | 0.030 | 0.010 | 0.010 | 0.040 | 0.32 | 12.6 | Amorphous | 1.72 | −573 | 26.5 | 20.7 | 0.95 |
| 316 | Example | 0.300 | 0.090 | 0.020 | 0.030 | 0.010 | 0.010 | 0.040 | 0.16 | 25.2 | Amorphous | 1.74 | −542 | 23.4 | 19.4 | 0.97 |
| 317 | Example | 0.450 | 0.090 | 0.020 | 0.030 | 0.010 | 0.010 | 0.040 | 0.11 | 37.8 | Amorphous | 1.73 | −517 | 20.1 | 19.3 | 0.96 |
| 318 | Example | 0.600 | 0.090 | 0.020 | 0.030 | 0.010 | 0.010 | 0.040 | 0.079 | 50.4 | Amorphous | 1.67 | −501 | 18.4 | 20.0 | 0.93 |
| 170 | Example | 0.050 | 0.110 | 0.020 | 0.030 | 0.010 | 0.010 | 0.040 | 0.98 | 4.10 | Amorphous | 1.68 | −597 | 27.2 | 20.1 | 0.91 |
| 172 | Example | 0.150 | 0.110 | 0.020 | 0.030 | 0.010 | 0.010 | 0.040 | 0.33 | 12.3 | Amorphous | 1.68 | −568 | 25.5 | 19.1 | 0.94 |
| 173 | Example | 0.300 | 0.110 | 0.020 | 0.030 | 0.010 | 0.010 | 0.040 | 0.16 | 24.6 | Amorphous | 1.69 | −540 | 20.1 | 21.2 | 0.94 |
| 174 | Example | 0.450 | 0.110 | 0.020 | 0.030 | 0.010 | 0.010 | 0.040 | 0.11 | 36.9 | Amorphous | 1.69 | −516 | 19.3 | 19.0 | 0.94 |
| 176 | Example | 0.600 | 0.110 | 0.020 | 0.030 | 0.010 | 0.010 | 0.040 | 0.081 | 49.2 | Amorphous | 1.62 | −503 | 18.2 | 20.6 | 0.93 |
| 319 | Example | 0.050 | 0.150 | 0.020 | 0.030 | 0.010 | 0.010 | 0.040 | 1.0 | 3.90 | Amorphous | 1.54 | −603 | 26.4 | 18.7 | 0.91 |
| 320 | Example | 0.150 | 0.150 | 0.020 | 0.030 | 0.010 | 0.010 | 0.040 | 0.34 | 11.7 | Amorphous | 1.55 | −564 | 24.4 | 19.8 | 0.93 |
| 321 | Example | 0.300 | 0.150 | 0.020 | 0.030 | 0.010 | 0.010 | 0.040 | 0.17 | 23.4 | Amorphous | 1.57 | −535 | 17.3 | 19.6 | 0.93 |
| 322 | Example | 0.450 | 0.150 | 0.020 | 0.030 | 0.010 | 0.010 | 0.040 | 0.11 | 35.1 | Amorphous | 1.55 | −515 | 19.0 | 20.3 | 0.94 |
| 323 | Example | 0.600 | 0.150 | 0.020 | 0.030 | 0.010 | 0.010 | 0.040 | 0.085 | 46.8 | Amorphous | 1.52 | −504 | 17.9 | 18.7 | 0.93 |
| 324 | Example | 0.050 | 0.170 | 0.020 | 0.030 | 0.010 | 0.010 | 0.040 | 1.1 | 3.80 | Amorphous | 1.51 | −604 | 26.3 | 20.6 | 0.92 |
| 325 | Example | 0.150 | 0.170 | 0.020 | 0.030 | 0.010 | 0.010 | 0.040 | 0.35 | 11.4 | Amorphous | 1.52 | −563 | 23.3 | 19.8 | 0.94 |
| 326 | Example | 0.300 | 0.170 | 0.020 | 0.030 | 0.010 | 0.010 | 0.040 | 0.18 | 22.8 | Amorphous | 1.51 | −532 | 17.2 | 21.1 | 0.94 |
| 327 | Example | 0.450 | 0.170 | 0.020 | 0.030 | 0.010 | 0.010 | 0.040 | 0.12 | 34.2 | Amorphous | 1.51 | −512 | 18.4 | 20.5 | 0.94 |
| 328 | Example | 0.500 | 0.170 | 0.020 | 0.030 | 0.010 | 0.010 | 0.040 | 0.11 | 38.0 | Amorphous | 1.50 | −502 | 16.3 | 18.8 | 0.93 |

TABLE 6B

| | | | | | | | | | | | | | | Corro- | | |
|---|---|---|---|---|---|---|---|---|---|---|---|---|---|---|---|---|
| | | | | | | | | | | | | | | sion | | |
| | | | | | | | | | | α{1 − | | | Corro- | current | | |
| | Example/ | (Fe_{(1-α)}CO_{α})_{(1-(a+b+c+d+e))}BₐP_{b}Si_{c}C_{d}Crₑ | | | | | | | f/α{1 − | (a + b + | | | sion | density | Average | Average |
| Sam- | Compar- | (β = 0) | | | | | | Mn | (a + b + | c + d + | | | potential | (icorr) | particle | Wadell |
| ple | ative | | B | P | Si | C | Cr | f | c + d + | e)} × | Crystal | Bs | (Ecorr) | (μA/ | size | circu- |
| No. | example | α | a | b | c | d | e | (at %) | e)} | e × 10000 | structure | (T) | (mV) | cm²) | (μm) | larity |
| 329 | Compar- | 0.050 | 0.010 | 0.040 | 0.030 | 0.010 | 0.010 | 0.040 | 0.89 | 4.50 | Crystal | 1.80 | −721 | 93.0 | 19.9 | 0.91 |
| | ative | | | | | | | | | | | | | | | |
| | example | | | | | | | | | | | | | | | |
| 330 | Compar- | 0.150 | 0.010 | 0.040 | 0.030 | 0.010 | 0.010 | 0.040 | 0.30 | 13.5 | Crystal | 1.81 | −698 | 88.0 | 20.5 | 0.93 |
| | ative | | | | | | | | | | | | | | | |
| | example | | | | | | | | | | | | | | | |
| 331 | Compar- | 0.300 | 0.010 | 0.040 | 0.030 | 0.010 | 0.010 | 0.040 | 0.15 | 27.0 | Crystal | 1.83 | −689 | 87.0 | 21.3 | 0.94 |
| | ative | | | | | | | | | | | | | | | |
| | example | | | | | | | | | | | | | | | |
| 332 | Compar- | 0.450 | 0.010 | 0.040 | 0.030 | 0.010 | 0.010 | 0.040 | 0.10 | 40.5 | Crystal | 1.82 | −687 | 86.0 | 19.2 | 0.94 |
| | ative | | | | | | | | | | | | | | | |
| | example | | | | | | | | | | | | | | | |
| 333 | Compar- | 0.600 | 0.010 | 0.040 | 0.030 | 0.010 | 0.010 | 0.040 | 0.074 | 54.0 | Crystal | 1.76 | −667 | 80.3 | 19.7 | 0.93 |
| | ative | | | | | | | | | | | | | | | |
| | example | | | | | | | | | | | | | | | |
| 334 | Example | 0.050 | 0.020 | 0.040 | 0.030 | 0.010 | 0.010 | 0.040 | 0.90 | 4.45 | Amorphous | 1.79 | −610 | 38.2 | 20.0 | 0.91 |
| 335 | Example | 0.150 | 0.020 | 0.040 | 0.030 | 0.010 | 0.010 | 0.040 | 0.30 | 13.4 | Amorphous | 1.80 | −590 | 35.0 | 19.2 | 0.93 |
| 336 | Example | 0.300 | 0.020 | 0.040 | 0.030 | 0.010 | 0.010 | 0.040 | 0.15 | 26.7 | Amorphous | 1.79 | −587 | 33.0 | 20.2 | 0.94 |
| 337 | Example | 0.450 | 0.020 | 0.040 | 0.030 | 0.010 | 0.010 | 0.040 | 0.10 | 40.1 | Amorphous | 1.78 | −577 | 32.0 | 20.5 | 0.94 |
| 338 | Example | 0.600 | 0.020 | 0.040 | 0.030 | 0.010 | 0.010 | 0.040 | 0.075 | 53.4 | Amorphous | 1.75 | −540 | 28.1 | 19.7 | 0.93 |
| 339 | Example | 0.050 | 0.050 | 0.040 | 0.030 | 0.010 | 0.010 | 0.040 | 0.93 | 4.30 | Amorphous | 1.72 | −589 | 30.2 | 19.1 | 0.92 |
| 340 | Example | 0.150 | 0.050 | 0.040 | 0.030 | 0.010 | 0.010 | 0.040 | 0.31 | 12.9 | Amorphous | 1.74 | −560 | 28.5 | 18.9 | 0.93 |
| 341 | Example | 0.300 | 0.050 | 0.040 | 0.030 | 0.010 | 0.010 | 0.040 | 0.16 | 25.8 | Amorphous | 1.74 | −542 | 26.2 | 21.3 | 0.94 |
| 342 | Example | 0.450 | 0.050 | 0.040 | 0.030 | 0.010 | 0.010 | 0.040 | 0.10 | 38.7 | Amorphous | 1.73 | −513 | 24.4 | 19.5 | 0.94 |
| 343 | Example | 0.600 | 0.050 | 0.040 | 0.030 | 0.010 | 0.010 | 0.040 | 0.078 | 51.6 | Amorphous | 1.70 | −487 | 22.1 | 19.5 | 0.93 |
| 344 | Example | 0.050 | 0.080 | 0.040 | 0.030 | 0.010 | 0.010 | 0.040 | 0.96 | 4.15 | Amorphous | 1.65 | −582 | 27.3 | 21.0 | 0.92 |
| 345 | Example | 0.150 | 0.080 | 0.040 | 0.030 | 0.010 | 0.010 | 0.040 | 0.32 | 12.5 | Amorphous | 1.67 | −553 | 22.4 | 20.8 | 0.94 |
| 346 | Example | 0.300 | 0.080 | 0.040 | 0.030 | 0.010 | 0.010 | 0.040 | 0.16 | 24.9 | Amorphous | 1.66 | −524 | 20.5 | 19.0 | 0.94 |
| 347 | Example | 0.450 | 0.080 | 0.040 | 0.030 | 0.010 | 0.010 | 0.040 | 0.11 | 37.4 | Amorphous | 1.64 | −514 | 18.6 | 19.9 | 0.93 |
| 348 | Example | 0.600 | 0.080 | 0.040 | 0.030 | 0.010 | 0.010 | 0.040 | 0.080 | 49.8 | Amorphous | 1.61 | −485 | 16.4 | 21.1 | 0.93 |
| 214 | Example | 0.050 | 0.110 | 0.040 | 0.030 | 0.010 | 0.010 | 0.040 | 1.0 | 4.00 | Amorphous | 1.62 | −578 | 26.4 | 18.7 | 0.92 |
| 215 | Example | 0.150 | 0.110 | 0.040 | 0.030 | 0.010 | 0.010 | 0.040 | 0.33 | 12.0 | Amorphous | 1.63 | −545 | 25.2 | 21.2 | 0.94 |
| 216 | Example | 0.300 | 0.110 | 0.040 | 0.030 | 0.010 | 0.010 | 0.040 | 0.17 | 24.0 | Amorphous | 1.64 | −530 | 19.8 | 20.1 | 0.94 |
| 217 | Example | 0.450 | 0.110 | 0.040 | 0.030 | 0.010 | 0.010 | 0.040 | 0.11 | 36.0 | Amorphous | 1.64 | −510 | 17.2 | 19.2 | 0.94 |
| 218 | Example | 0.600 | 0.110 | 0.040 | 0.030 | 0.010 | 0.010 | 0.040 | 0.083 | 48.0 | Amorphous | 1.61 | −487 | 17.0 | 20.0 | 0.93 |

TABLE 6C

| | | | | | | | | | | | | | | Corro- | | |
|---|---|---|---|---|---|---|---|---|---|---|---|---|---|---|---|---|
| | | | | | | | | | | | | | | sion | | |
| | | | | | | | | | | α{1− | | | Corro- | current | | |
| | Example/ | (Fe_{(1-α)}CO_{α})_{(1-(a+b+c+d+e))}BₐP_{b}Si_{c}C_{d}Crₑ | | | | | | | f/α{1 − | (a + b + | | | sion | density | Average | Average |
| Sam- | Compar- | (β = 0) | | | | | | Mn | (a + b + | c + d + | | | potential | (icorr) | particle | Wadell |
| ple | ative | | B | P | Si | C | Cr | f | c + d + | e)} × | Crystal | Bs | (Ecorr) | (μA/ | size | circu- |
| No. | example | α | a | b | c | d | e | (at %) | e)} | e × 10000 | structure | (T) | (mV) | cm²) | (μm) | larity |
| 349 | Example | 0.050 | 0.200 | 0.00 | 0.00 | 0.00 | 0.010 | 0.040 | 1.0 | 3.95 | Amorphous | 1.52 | −568 | 20.5 | 19.3 | 0.92 |
| 350 | Example | 0.150 | 0.200 | 0.00 | 0.00 | 0.00 | 0.010 | 0.040 | 0.34 | 11.9 | Amorphous | 1.53 | −532 | 16.0 | 20.0 | 0.94 |
| 351 | Example | 0.300 | 0.200 | 0.00 | 0.00 | 0.00 | 0.010 | 0.040 | 0.17 | 23.7 | Amorphous | 1.52 | −498 | 15.6 | 19.3 | 0.94 |
| 352 | Example | 0.450 | 0.200 | 0.00 | 0.00 | 0.00 | 0.010 | 0.040 | 0.11 | 35.6 | Amorphous | 1.51 | −488 | 15.0 | 20.2 | 0.93 |
| 353 | Example | 0.500 | 0.200 | 0.00 | 0.00 | 0.00 | 0.010 | 0.040 | 0.10 | 39.5 | Amorphous | 1.50 | −432 | 8.1 | 20.8 | 0.93 |
| 354 | Compar- | 0.050 | 0.210 | 0.00 | 0.00 | 0.00 | 0.010 | 0.040 | 1.0 | 3.90 | Amorphous | 1.47 | −550 | 20.1 | 18.5 | 0.92 |
| | ative | | | | | | | | | | | | | | | |
| | example | | | | | | | | | | | | | | | |
| 355 | Compar- | 0.150 | 0.210 | 0.00 | 0.00 | 0.00 | 0.010 | 0.040 | 0.34 | 11.7 | Amorphous | 1.48 | −521 | 14.0 | 21.3 | 0.94 |
| | ative | | | | | | | | | | | | | | | |
| | example | | | | | | | | | | | | | | | |
| 356 | Compar- | 0.300 | 0.210 | 0.00 | 0.00 | 0.00 | 0.010 | 0.040 | 0.17 | 23.4 | Amorphous | 1.47 | −477 | 12.5 | 19.3 | 0.94 |
| | ative | | | | | | | | | | | | | | | |
| | example | | | | | | | | | | | | | | | |
| 357 | Compar- | 0.450 | 0.210 | 0.00 | 0.00 | 0.00 | 0.010 | 0.040 | 0.11 | 35.1 | Amorphous | 1.46 | −456 | 12.0 | 21.3 | 0.94 |
| | ative | | | | | | | | | | | | | | | |
| | example | | | | | | | | | | | | | | | |
| 358 | Compar- | 0.500 | 0.210 | 0.00 | 0.00 | 0.00 | 0.010 | 0.040 | 0.10 | 39.0 | Amorphous | 1.42 | −401 | 6.3 | 21.2 | 0.93 |
| | ative | | | | | | | | | | | | | | | |
| | example | | | | | | | | | | | | | | | |

Table 2A and Table 2B show results of experiment examples in which the Cr amount (e) was varied. Table 3A and Table 3B show results of experiment examples in which the P amount (b) was varied. Table 4A and Table 4B show results of experiment examples in which the C amount (d) was varied. Table 5A and Table 5B show results of experiment examples in which the Si amount (c) was varied. Table 6A, Table 6B, and Table 6C show results of experiment examples in which the B amount (a) was varied. When the amount of each component was within in the predetermined range, Bs and the corrosion resistance were good.

Table 2A and Table 2B show that when 0.001≤e≤0.020 and 1.00≤α(1−γ){1−(a+b+c+d+e)}×e×10000≤50.0 were satisfied, a high Bs was obtained while maintaining a good corrosion resistance. On the contrary to this, when the Co amount (α) with respect to Fe was too small, the corrosion resistance decreased; and when the Co amount (α) with respect to Fe was too large, Bs decreased. Also, when the Cr amount (e) was too large, Bs decreased.

Table 3A and Table 3B show that particularly when 0≤b≤0.050 was satisfied, a high Bs was obtained while maintaining a good corrosion resistance. Also, when the P amount (b) was 0.001 or more, a higher corrosion resistance was obtained compared to when the P amount (b) was 0.000. When the P amount (b) was 0.050 or less, a higher Bs was obtained compared to when the P amount (b) was larger than 0.050. On the contrary to this, when the P amount (b) was too large, Bs decreased.

Table 4A and Table 4B show that when the C amount (d) was too large, Bs decreased.

Table 5A and Table 5B show that when the Si amount (c) was too large, Bs decreased.

Table 6A, Table 6B, and Table 6C show that when the B amount (a) was too small, crystals were formed in the soft magnetic alloy ribbon, hence the amorphous ratio X was less than 85%, and the corrosion resistance decreased. When the B amount (a) was too large, Bs decreased.

TABLE 7A

| | | | | | | | | | | | | | | Corro- | | |
|---|---|---|---|---|---|---|---|---|---|---|---|---|---|---|---|---|
| | | | | | | | | | | | | | | sion | | |
| | | | | | | | | | | α{1 − | | | Corro- | current | | |
| | Example/ | (Fe_{(1-α)}CO_{α})_{(1-(a+b+c+d+e))}BₐP_{b}Si_{c}C_{d}Crₑ | | | | | | | f/α{1 − | (a + b + | | | sion | density | Average | Average |
| Sam- | Compar- | (β = 0) | | | | | | Mn | (a + b + | c + d + | | | potential | (icorr) | particle | Wadell |
| ple | ative | | B | P | Si | C | Cr | f | c + | e)} × | Crystal | Bs | (Ecorr) | (μA/ | size | circu- |
| No. | example | α | a | b | c | d | e | (at %) | d + e)} | e × 10000 | structure | (T) | (mV) | cm²) | (μm) | larity |
| 359 | Compar- | 0.000 | 0.140 | 0.000 | 0.050 | 0.020 | 0.000 | 0.000 | — | 0.0 | Amorphous | 1.63 | −676 | 47.5 | 20.8 | 0.89 |
| | ative | | | | | | | | | | | | | | | |
| | example | | | | | | | | | | | | | | | |
| 360 | Compar- | 0.000 | 0.140 | 0.000 | 0.050 | 0.020 | 0.000 | 0.002 | — | 0.0 | Amorphous | 1.63 | −672 | 47.1 | 20.5 | 0.88 |
| | ative | | | | | | | | | | | | | | | |
| | example | | | | | | | | | | | | | | | |
| 361 | Compar- | 0.000 | 0.140 | 0.000 | 0.050 | 0.020 | 0.000 | 0.005 | — | 0.0 | Amorphous | 1.63 | −667 | 47.0 | 18.9 | 0.88 |
| | ative | | | | | | | | | | | | | | | |
| | example | | | | | | | | | | | | | | | |
| 362 | Compar- | 0.000 | 0.140 | 0.000 | 0.050 | 0.020 | 0.000 | 0.015 | — | 0.0 | Amorphous | 1.63 | −665 | 46.6 | 21.0 | 0.90 |
| | ative | | | | | | | | | | | | | | | |
| | example | | | | | | | | | | | | | | | |
| 363 | Compar- | 0.000 | 0.140 | 0.000 | 0.050 | 0.020 | 0.000 | 0.025 | — | 0.0 | Amorphous | 1.63 | −665 | 46.2 | 20.3 | 0.89 |
| | ative | | | | | | | | | | | | | | | |
| | example | | | | | | | | | | | | | | | |
| 364 | Compar- | 0.000 | 0.140 | 0.000 | 0.050 | 0.020 | 0.000 | 0.040 | — | 0.0 | Amorphous | 1.63 | −660 | 46.0 | 20.2 | 0.91 |
| | ative | | | | | | | | | | | | | | | |
| | example | | | | | | | | | | | | | | | |
| 365 | Compar- | 0.000 | 0.140 | 0.000 | 0.050 | 0.020 | 0.000 | 0.080 | — | 0.0 | Amorphous | 1.63 | −665 | 45.8 | 18.8 | 0.88 |
| | ative | | | | | | | | | | | | | | | |
| | example | | | | | | | | | | | | | | | |
| 366 | Compar- | 0.000 | 0.140 | 0.000 | 0.050 | 0.020 | 0.000 | 0.100 | — | 0.0 | Amorphous | 1.62 | −668 | 45.7 | 20.2 | 0.88 |
| | ative | | | | | | | | | | | | | | | |
| | example | | | | | | | | | | | | | | | |
| 367 | Compar- | 0.000 | 0.140 | 0.000 | 0.050 | 0.020 | 0.000 | 1.000 | — | 0.0 | Amorphous | 1.61 | −671 | 45.5 | 19.3 | 0.90 |
| | ative | | | | | | | | | | | | | | | |
| | example | | | | | | | | | | | | | | | |
| 368 | Compar- | 0.000 | 0.140 | 0.000 | 0.050 | 0.020 | 0.000 | 2.000 | — | 0.0 | Amorphous | 1.60 | −672 | 45.4 | 20.2 | 0.89 |
| | ative | | | | | | | | | | | | | | | |
| | example | | | | | | | | | | | | | | | |
| 369 | Compar- | 0.000 | 0.140 | 0.000 | 0.050 | 0.020 | 0.000 | 2.800 | — | 0.0 | Amorphous | 1.60 | −673 | 45.2 | 18.6 | 0.86 |
| | ative | | | | | | | | | | | | | | | |
| | example | | | | | | | | | | | | | | | |
| 370 | Compar- | 0.000 | 0.140 | 0.000 | 0.050 | 0.020 | 0.000 | 3.000 | — | 0.0 | Crystal | 1.58 | −723 | 54.0 | 20.1 | 0.85 |
| | ative | | | | | | | | | | | | | | | |
| | example | | | | | | | | | | | | | | | |

TABLE 7B

| | | | | | | | | | | | | | | Corro- | | |
|---|---|---|---|---|---|---|---|---|---|---|---|---|---|---|---|---|
| | | | | | | | | | | | | | | sion | | |
| | | | | | | | | | | α{1 − | | | Corro- | current | | |
| | Example/ | (Fe_{(1-α)}CO_{α})_{(1-(a+b+c+d+e))}BₐP_{b}Si_{c}C_{d}Crₑ | | | | | | | f/α{1 − | (a + b + | | | sion | density | Average | Average |
| Sam- | Compar- | (β = 0) | | | | | | Mn | (a + b + | c + d + | | | potential | (icorr) | particle | Wadell |
| ple | ative | | B | P | Si | C | Cr | f | c + | e)} × | Crystal | Bs | (Ecorr) | (μA/ | size | circu- |
| No. | example | α | a | b | c | d | e | (at %) | d + e)} | e × 10000 | structure | (T) | (mV) | cm²) | (μm) | larity |
| 371 | Compar- | 0.005 | 0.140 | 0.000 | 0.050 | 0.020 | 0.000 | 0.000 | — | 0.0 | Amorphous | 1.64 | −662 | 46.0 | 21.1 | 0.79 |
| | ative | | | | | | | | | | | | | | | |
| | example | | | | | | | | | | | | | | | |
| 372 | Example | 0,005 | 0.140 | 0.000 | 0.050 | 0.020 | 0.000 | 0.002 | 0.51 | 0.0 | Amorphous | 1.64 | −604 | 40.0 | 20.5 | 0.86 |
| 373 | Example | 0.005 | 0.140 | 0.000 | 0.050 | 0.020 | 0.000 | 0.005 | 1.3 | 0.0 | Amorphous | 1.64 | −603 | 39.8 | 20.2 | 0.87 |
| 374 | Example | 0.005 | 0.140 | 0.000 | 0.050 | 0.020 | 0.000 | 0.015 | 3.8 | 0.0 | Amorphous | 1.64 | −601 | 39.7 | 20.8 | 0.87 |
| 375 | Example | 0.005 | 0.140 | 0.000 | 0.050 | 0.020 | 0.000 | 0.025 | 6.3 | 0.0 | Amorphous | 1.64 | −598 | 39.5 | 18.6 | 0.90 |
| 376 | Example | 0.005 | 0.140 | 0.000 | 0.050 | 0.020 | 0.000 | 0.040 | 10 | 0.0 | Amorphous | 1.64 | −596 | 39.0 | 19.1 | 0.92 |
| 377 | Example | 0.005 | 0.140 | 0.000 | 0.050 | 0.020 | 0.000 | 0.080 | 20 | 0.0 | Amorphous | 1.64 | −593 | 38.4 | 21.2 | 0.90 |
| 378 | Example | 0.005 | 0.140 | 0.000 | 0.050 | 0.020 | 0.000 | 0.100 | 25 | 0.0 | Amorphous | 1.64 | −592 | 38.0 | 19.3 | 0.90 |
| 379 | Example | 0.005 | 0.140 | 0.000 | 0.050 | 0.020 | 0.000 | 1.000 | 253 | 0.0 | Amorphous | 1.64 | −589 | 37.5 | 20.9 | 0.90 |
| 380 | Example | 0.005 | 0.140 | 0.000 | 0.050 | 0.020 | 0.000 | 2.000 | 506 | 0.0 | Amorphous | 1.64 | −586 | 37.3 | 20.7 | 0.90 |
| 381 | Example | 0.005 | 0.140 | 0.000 | 0.050 | 0.020 | 0.000 | 2.800 | 709 | 0.0 | Amorphous | 1.63 | −582 | 37.2 | 20.7 | 0.90 |
| 382 | Compar- | 0.005 | 0.140 | 0.000 | 0.050 | 0.020 | 0.000 | 3.000 | 759 | 0.0 | Crystal | 1.63 | −652 | 48.0 | 20.8 | 0.89 |
| | ative | | | | | | | | | | | | | | | |
| | example | | | | | | | | | | | | | | | |

TABLE 7C

| | | | | | | | | | | | | | | Corro- | | |
|---|---|---|---|---|---|---|---|---|---|---|---|---|---|---|---|---|
| | | | | | | | | | | | | | | sion | | |
| | | | | | | | | | | α{1 − | | | Corro- | current | | |
| | Example/ | (Fe_{(1-α)}CO_{α})_{(1-(a+b+c+d+e))}BₐP_{b}Si_{c}C_{d}Crₑ | | | | | | | f/α{1 − | (a + b + | | | sion | density | Average | Average |
| Sam- | Compar- | (β = 0) | | | | | | Mn | (a + b + | c + d + | | | potential | (icorr) | particle | Wadell |
| ple | ative | | B | P | Si | C | Cr | f | c + | e)} × | Crystal | Bs | (Ecorr) | (μA/ | size | circu- |
| No. | example | α | a | b | c | d | e | (at %) | d + e)} | e × 10000 | structure | (T) | (mV) | cm²) | (μm) | larity |
| 383 | Compar- | 0.010 | 0.140 | 0.000 | 0.050 | 0.020 | 0.000 | 0.000 | — | 0.0 | Amonphous | 1.68 | −661 | 45.2 | 21.1 | 0.79 |
| | ative | | | | | | | | | | | | | | | |
| | example | | | | | | | | | | | | | | | |
| 384 | Example | 0.010 | 0.140 | 0.000 | 0.050 | 0.020 | 0.000 | 0.002 | 0.25 | 0.0 | Amonphous | 1.68 | −603 | 40.2 | 18.5 | 0.85 |
| 385 | Example | 0.010 | 0.140 | 0.000 | 0.050 | 0.020 | 0.000 | 0.005 | 0.63 | 0.0 | Amonphous | 1.68 | −602 | 40.1 | 20.4 | 0.88 |
| 386 | Example | 0.010 | 0.140 | 0.000 | 0.050 | 0.020 | 0.000 | 0.015 | 1.9 | 0.0 | Amonphous | 1.68 | −600 | 39.1 | 20.7 | 0.87 |
| 387 | Example | 0.010 | 0.140 | 0.000 | 0.050 | 0.020 | 0.000 | 0.025 | 3.2 | 0.0 | Amonphous | 1.68 | −589 | 39.0 | 20.7 | 0.89 |
| 388 | Example | 0.010 | 0.140 | 0.000 | 0.050 | 0.020 | 0.000 | 0.040 | 5.1 | 0.0 | Amonphous | 1.68 | −598 | 38.8 | 19.8 | 0.90 |
| 389 | Example | 0.010 | 0.140 | 0.000 | 0.050 | 0.020 | 0.000 | 0.080 | 10 | 0.0 | Amonphous | 1.68 | −596 | 37.6 | 20.3 | 0.91 |
| 390 | Example | 0.010 | 0.140 | 0.000 | 0.050 | 0.020 | 0.000 | 0.100 | 13 | 0.0 | Amonphous | 1.67 | −593 | 37.0 | 19.9 | 0.91 |
| 391 | Example | 0.010 | 0.140 | 0.000 | 0.050 | 0.020 | 0.000 | 1.000 | 127 | 0.0 | Amonphous | 1.67 | −590 | 35.6 | 19.0 | 0.92 |
| 392 | Example | 0.010 | 0.140 | 0.000 | 0.050 | 0.020 | 0.000 | 2.000 | 253 | 0.0 | Amonphous | 1.67 | −589 | 35.0 | 19.6 | 0.92 |
| 393 | Example | 0.010 | 0.140 | 0.000 | 0.050 | 0.020 | 0.000 | 2.800 | 354 | 0.0 | Amonphous | 1.66 | −586 | 34.4 | 20.8 | 0.90 |
| 394 | Compar- | 0.010 | 0.140 | 0.000 | 0.050 | 0.020 | 0.000 | 3.000 | 380 | 0.0 | Crystal | 1.66 | −645 | 47.5 | 20.8 | 0.91 |
| | ative | | | | | | | | | | | | | | | |
| | example | | | | | | | | | | | | | | | |

TABLE 7D

| | | | | | | | | | | | | | | Corro- | | |
|---|---|---|---|---|---|---|---|---|---|---|---|---|---|---|---|---|
| | | | | | | | | | | | | | | sion | | |
| | | | | | | | | | | α{1 − | | | Corro- | current | | |
| | Example/ | (Fe_{(1-α)}CO_{α})_{(1-(a+b+c+d+e))}BₐP_{b}Si_{c}C_{d}Crₑ | | | | | | | f/α{1 − | (a + b + | | | sion | density | Average | Average |
| Sam- | Compar- | (β = 0) | | | | | | Mn | (a + b + | c + d + | | | potential | (icorr) | particle | Wadell |
| ple | ative | | B | P | Si | C | Cr | f | c + | e)} × | Crystal | Bs | (Ecorr) | (μA/ | size | circu- |
| No. | example | α | a | b | c | d | e | (at %) | d + e)} | e × 10000 | structure | (T) | (mV) | cm²) | (μm) | larity |
| 395 | Compar- | 0.030 | 0.140 | 0.000 | 0.050 | 0.020 | 0.000 | 0.000 | — | 0.0 | Amorphous | 1.69 | −660 | 45.6 | 21.3 | 0.78 |
| | ative | | | | | | | | | | | | | | | |
| | example | | | | | | | | | | | | | | | |
| 396 | Example | 0.030 | 0.140 | 0.000 | 0.050 | 0.020 | 0.000 | 0.002 | 0.25 | 0.0 | Amorphous | 1.69 | −603 | 40.1 | 19.0 | 0.83 |
| 397 | Example | 0.030 | 0.140 | 0.000 | 0.050 | 0.020 | 0.000 | 0.005 | 0.63 | 0.0 | Amorphous | 1.69 | −602 | 39.2 | 20.5 | 0.87 |
| 398 | Example | 0.030 | 0.140 | 0.000 | 0.050 | 0.020 | 0.000 | 0.015 | 1.9 | 0.0 | Amorphous | 1.69 | −600 | 38.1 | 20.3 | 0.88 |
| 399 | Example | 0.030 | 0.140 | 0.000 | 0.050 | 0.020 | 0.000 | 0.025 | 3.2 | 0.0 | Amorphous | 1.69 | −594 | 37.8 | 20.6 | 0.90 |
| 400 | Example | 0.030 | 0.140 | 0.000 | 0.050 | 0.020 | 0.000 | 0.040 | 5.1 | 0.0 | Amorphous | 1.69 | −597 | 37.5 | 19.4 | 0.91 |
| 401 | Example | 0.030 | 0.140 | 0.000 | 0.050 | 0.020 | 0.000 | 0.080 | 10 | 0.0 | Amorphous | 1.69 | −590 | 36.3 | 20.4 | 0.92 |
| 402 | Example | 0.030 | 0.140 | 0.000 | 0.050 | 0.020 | 0.000 | 0.100 | 13 | 0.0 | Amorphous | 1.68 | −588 | 35.5 | 18.5 | 0.93 |
| 403 | Example | 0.030 | 0.140 | 0.000 | 0.050 | 0.020 | 0.000 | 1.000 | 127 | 0.0 | Amorphous | 1.68 | −585 | 34.6 | 20.8 | 0.93 |
| 404 | Example | 0.030 | 0.140 | 0.000 | 0.050 | 0.020 | 0.000 | 2.000 | 253 | 0.0 | Amorphous | 1.67 | −584 | 34.6 | 19.5 | 0.92 |
| 405 | Example | 0.030 | 0.140 | 0.000 | 0.050 | 0.020 | 0.000 | 2.800 | 354 | 0.0 | Amorphous | 1.67 | −582 | 34.0 | 18.6 | 0.91 |
| 406 | Compar- | 0.030 | 0.140 | 0.000 | 0.050 | 0.020 | 0.000 | 3.000 | 380 | 0.0 | Crystal | 1.66 | −647 | 49.8 | 19.9 | 0.90 |
| | ative | | | | | | | | | | | | | | | |
| | example | | | | | | | | | | | | | | | |

TABLE 7E

| | | | | | | | | | | | | | | Corro- | | |
|---|---|---|---|---|---|---|---|---|---|---|---|---|---|---|---|---|
| | | | | | | | | | | | | | | sion | | |
| | | | | | | | | | | α{1 − | | | Corro- | current | | |
| | Example/ | (Fe_{(1-α)}CO_{α})_{(1-(a+b+c+d+e))}BₐP_{b}Si_{c}C_{d}Crₑ | | | | | | | f/α{1 − | (a + b + | | | sion | density | Average | Average |
| Sam- | Compar- | (β = 0) | | | | | | Mn | (a + b + | c + d + | | | potential | (icorr) | particle | Wadell |
| ple | ative | | B | P | Si | C | Cr | f | c + | e)} × | Crystal | Bs | (Ecorr) | (μA/ | size | circu- |
| No. | example | a | a | b | c | d | e | (at %) | d + e)} | e × 10000 | structure | (T) | (mV) | cm²) | (μm) | larity |
| 407 | Compar- | 0.050 | 0.140 | 0.000 | 0.050 | 0.020 | 0.000 | 0.000 | — | 0.0 | Amorphous | 1.69 | −658 | 46.0 | 19.5 | 0.75 |
| | ative | | | | | | | | | | | | | | | |
| | example | | | | | | | | | | | | | | | |
| 408 | Example | 0.050 | 0.140 | 0.000 | 0.050 | 0.020 | 0.000 | 0.002 | 0.051 | 0.0 | Amorphous | 1.69 | −602 | 38.1 | 19.6 | 0.82 |
| 409 | Example | 0.050 | 0.140 | 0.000 | 0.050 | 0.020 | 0.000 | 0.005 | 0.13 | 0.0 | Amorphous | 1.69 | −601 | 37.8 | 19.2 | 0.83 |
| 410 | Example | 0.050 | 0.140 | 0.000 | 0.050 | 0.020 | 0.000 | 0.015 | 0.38 | 0.0 | Amorphous | 1.69 | −600 | 36.4 | 20.0 | 0.90 |
| 411 | Example | 0.050 | 0.140 | 0.000 | 0.050 | 0.020 | 0.000 | 0.025 | 0.63 | 0.0 | Amorphous | 1.69 | −598 | 36.0 | 20.6 | 0.90 |
| 412 | Example | 0.050 | 0.140 | 0.000 | 0.050 | 0.020 | 0.000 | 0.040 | 1.0 | 0.0 | Amorphous | 1.69 | −596 | 35.8 | 20.0 | 0.91 |
| 413 | Example | 0.050 | 0.140 | 0.000 | 0.050 | 0.020 | 0.000 | 0.080 | 2.0 | 0.0 | Amorphous | 1.69 | −584 | 35.0 | 20.9 | 0.91 |
| 414 | Example | 0.050 | 0.140 | 0.000 | 0.050 | 0.020 | 0.000 | 0.100 | 2.5 | 0.0 | Amorphous | 1.68 | −582 | 34.0 | 19.4 | 0.90 |
| 415 | Example | 0.050 | 0.140 | 0.000 | 0.050 | 0.020 | 0.000 | 1.000 | 25 | 0.0 | Amorphous | 1.68 | −580 | 33.5 | 20.3 | 0.91 |
| 416 | Example | 0.050 | 0.140 | 0.000 | 0.050 | 0.020 | 0.000 | 2.000 | 51 | 0.0 | Amorphous | 1.67 | −579 | 33.4 | 19.5 | 0.92 |
| 417 | Example | 0.050 | 0.140 | 0.000 | 0.050 | 0.020 | 0.000 | 2.800 | 71 | 0.0 | Amorphous | 1.67 | −578 | 33.4 | 21.3 | 0.91 |
| 418 | Compar- | 0.050 | 0.140 | 0.000 | 0.050 | 0.020 | 0.000 | 3.000 | 76 | 0.0 | Crystal | 1.65 | −648 | 52.0 | 18.5 | 0.91 |
| | ative | | | | | | | | | | | | | | | |
| | example | | | | | | | | | | | | | | | |

TABLE 7F

| | | | | | | | | | | | | | | Corro- | | |
|---|---|---|---|---|---|---|---|---|---|---|---|---|---|---|---|---|
| | | | | | | | | | | | | | | sion | | |
| | | | | | | | | | | α{1 − | | | Corro- | current | | |
| | Example/ | (Fe_{(1-α)}CO_{α})_{(1-(a+b+c+d+e))}BₐP_{b}Si_{c}C_{d}Crₑ | | | | | | | f/α{1 − | (a + b + | | | sion | density | Average | Average |
| Sam- | Compar- | (β = 0) | | | | | | Mn | (a + b + | c + d + | | | potential | (icorr) | particle | Wadell |
| ple | ative | | B | P | Si | C | Cr | f | c + | e)} × | Crystal | Bs | (Ecorr) | (μA/ | size | circu- |
| No. | example | α | a | b | c | d | e | (at %) | d + e)} | e × 10000 | structure | (T) | (mV) | cm²) | (μm) | larity |
| 419 | Compar- | 0.100 | 0.140 | 0.000 | 0.050 | 0.020 | 0.000 | 0.000 | — | 0.0 | Amorphous | 1.72 | −660 | 46.0 | 19.5 | 0.73 |
| | ative | | | | | | | | | | | | | | | |
| | example | | | | | | | | | | | | | | | |
| 420 | Example | 0.100 | 0.140 | 0.000 | 0.050 | 0.020 | 0.000 | 0.002 | 0.025 | 0.0 | Amorphous | 1.72 | −600 | 37.1 | 19.7 | 0.82 |
| 421 | Example | 0.100 | 0.140 | 0.000 | 0.050 | 0.020 | 0.000 | 0.005 | 0.063 | 0.0 | Amorphous | 1.72 | −598 | 36.9 | 21.3 | 0.86 |
| 422 | Example | 0.100 | 0.140 | 0.000 | 0.050 | 0.020 | 0.000 | 0.015 | 0.19 | 0.0 | Amorphous | 1.72 | −596 | 35.5 | 19.3 | 0.93 |
| 423 | Example | 0.100 | 0.140 | 0.000 | 0.050 | 0.020 | 0.000 | 0.025 | 0.32 | 0.0 | Amorphous | 1.72 | −593 | 34.4 | 18.7 | 0.93 |
| 424 | Example | 0.100 | 0.140 | 0.000 | 0.050 | 0.020 | 0.000 | 0.040 | 0.51 | 0.0 | Amorphous | 1.72 | −589 | 33.3 | 19.9 | 0.94 |
| 425 | Example | 0.100 | 0.140 | 0.000 | 0.050 | 0.020 | 0.000 | 0.080 | 1.0 | 0.0 | Amorphous | 1.72 | −586 | 32.0 | 20.0 | 0.95 |
| 426 | Example | 0.100 | 0.140 | 0.000 | 0.050 | 0.020 | 0.000 | 0.100 | 1.3 | 0.0 | Amorphous | 1.71 | −585 | 31.8 | 21.2 | 0.93 |
| 427 | Example | 0.100 | 0.140 | 0.000 | 0.050 | 0.020 | 0.000 | 1.000 | 13 | 0.0 | Amorphous | 1.70 | −578 | 31.3 | 19.8 | 0.91 |
| 428 | Example | 0.100 | 0.140 | 0.000 | 0.050 | 0.020 | 0.000 | 2.000 | 25 | 0.0 | Amorphous | 1.70 | −576 | 31.1 | 19.8 | 0.91 |
| 429 | Example | 0.100 | 0.140 | 0.000 | 0.050 | 0.020 | 0.000 | 2.800 | 35 | 0.0 | Amorphous | 1.70 | −576 | 30.0 | 20.7 | 0.92 |
| 430 | Compar- | 0.100 | 0.140 | 0.000 | 0.050 | 0.020 | 0.000 | 3.000 | 38 | 0.0 | Crystal | 1.70 | −655 | 51.0 | 20.3 | 0.90 |
| | ative | | | | | | | | | | | | | | | |
| | example | | | | | | | | | | | | | | | |

TABLE 7G

| | | | | | | | | | | | | | | Corro- | | |
|---|---|---|---|---|---|---|---|---|---|---|---|---|---|---|---|---|
| | | | | | | | | | | | | | | sion | | |
| | | | | | | | | | | α{1 − | | | Corro- | current | | |
| | Example/ | (Fe_{(1-α)}CO_{α})_{(1-(a+b+c+d+e))}BₐP_{b}Si_{c}C_{d}Crₑ | | | | | | | f/α{1 − | (a + b + | | | sion | density | Average | Average |
| Sam- | Compar- | (β = 0) | | | | | | Mn | (a + b + | c + d + | | | potential | (icorr) | particle | Wadell |
| ple | ative | | B | P | Si | C | Cr | f | c + | e)} × | Crystal | Bs | (Ecorr) | (μA/ | size | circu- |
| No. | example | α | a | b | c | d | e | (at %) | d + e)} | e × 10000 | structure | (T) | (mV) | cm²) | (μm) | larity |
| 431 | Compar- | 0.150 | 0.140 | 0.000 | 0.050 | 0.020 | 0.000 | 0.000 | — | 0.0 | Amorphous | 1.73 | −662 | 48.3 | 19.7 | 0.74 |
| | ative | | | | | | | | | | | | | | | |
| | example | | | | | | | | | | | | | | | |
| 432 | Example | 0.150 | 0.140 | 0.000 | 0.050 | 0.020 | 0.000 | 0.002 | 0.017 | 0.0 | Amorphous | 1.73 | −599 | 36.1 | 21.3 | 0.81 |
| 433 | Example | 0.150 | 0.140 | 0.000 | 0.050 | 0.020 | 0.000 | 0.005 | 0.042 | 0.0 | Amorphous | 1.73 | −598 | 35.5 | 20.0 | 0.85 |
| 434 | Example | 0.150 | 0.140 | 0.000 | 0.050 | 0.020 | 0.000 | 0.015 | 0.13 | 0.0 | Amorphous | 1.73 | −595 | 34.6 | 18.5 | 0.94 |
| 435 | Example | 0.150 | 0.140 | 0.000 | 0.050 | 0.020 | 0.000 | 0.025 | 0.21 | 0.0 | Amorphous | 1.73 | −588 | 33.6 | 20.9 | 0.94 |
| 436 | Example | 0.150 | 0.140 | 0.000 | 0.050 | 0.020 | 0.000 | 0.040 | 0.34 | 0.0 | Amorphous | 1.73 | −580 | 32.2 | 19.6 | 0.94 |
| 437 | Example | 0.150 | 0.140 | 0.000 | 0.050 | 0.020 | 0.000 | 0.080 | 0.68 | 0.0 | Amorphous | 1.73 | −581 | 30.1 | 21.3 | 0.96 |
| 438 | Example | 0.150 | 0.140 | 0.000 | 0.050 | 0.020 | 0.000 | 0.100 | 0.84 | 0.0 | Amorphous | 1.72 | −586 | 29.3 | 18.8 | 0.94 |
| 439 | Example | 0.150 | 0.140 | 0.000 | 0.050 | 0.020 | 0.000 | 1.000 | 8.4 | 0.0 | Amorphous | 1.71 | −586 | 28.4 | 19.1 | 0.93 |
| 440 | Example | 0.150 | 0.140 | 0.000 | 0.050 | 0.020 | 0.000 | 2.000 | 17 | 0.0 | Amorphous | 1.70 | −581 | 28.0 | 20.5 | 0.92 |
| 441 | Example | 0.150 | 0.140 | 0.000 | 0.050 | 0.020 | 0.000 | 2.800 | 24 | 0.0 | Amorphous | 1.70 | −570 | 27.1 | 19.6 | 0.92 |
| 442 | Compar- | 0.150 | 0.140 | 0.000 | 0.050 | 0.020 | 0.000 | 3.000 | 25 | 0.0 | Crystal | 1.69 | −701 | 48.0 | 19.5 | 0.90 |
| | ative | | | | | | | | | | | | | | | |
| | example | | | | | | | | | | | | | | | |

TABLE 7H

| | | | | | | | | | | | | | | Corro- | | |
|---|---|---|---|---|---|---|---|---|---|---|---|---|---|---|---|---|
| | | | | | | | | | | | | | | sion | | |
| | | | | | | | | | | α{1 − | | | Corro- | current | | |
| | Example/ | (Fe_{(1-α)}CO_{α})_{(1-(a+b+c+d+e))}BₐP_{b}Si_{c}C_{d}Crₑ | | | | | | | f/α{1 − | (a + b + | | | sion | density | Average | Average |
| Sam- | Compar- | (β = 0) | | | | | | Mn | (a + b + | c + d + | | | potential | (icorr) | particle | Wadell |
| ple | ative | | B | P | Si | C | Cr | f | c + | e)} × | Crystal | Bs | (Ecorr) | (μA/ | size | circu- |
| No. | example | α | a | b | c | d | e | (at %) | d + e)} | e × 10000 | structure | (T) | (mV) | cm²) | (μm) | larity |
| 443 | Compar- | 0.300 | 0.140 | 0.000 | 0.050 | 0.020 | 0.000 | 0.000 | — | 0.0 | Amorphous | 1.74 | −663 | 46.4 | 21.3 | 0.73 |
| | ative | | | | | | | | | | | | | | | |
| | example | | | | | | | | | | | | | | | |
| 444 | Example | 0.300 | 0.140 | 0.000 | 0.050 | 0.020 | 0.000 | 0.002 | 0.0084 | 0.0 | Amorphous | 1.74 | −589 | 36.0 | 18.7 | 0.82 |
| 445 | Example | 0.300 | 0.140 | 0.000 | 0.050 | 0.020 | 0.000 | 0.005 | 0.021 | 0.0 | Amorphous | 1.74 | −578 | 35.4 | 20.3 | 0.88 |
| 446 | Example | 0.300 | 0.140 | 0.000 | 0.050 | 0.020 | 0.000 | 0.015 | 0.063 | 0.0 | Amorphous | 1.74 | −576 | 34.4 | 20.9 | 0.92 |
| 447 | Example | 0.300 | 0.140 | 0.000 | 0.050 | 0.020 | 0.000 | 0.025 | 0.11 | 0.0 | Amorphous | 1.74 | −573 | 33.4 | 20.3 | 0.94 |
| 448 | Example | 0.300 | 0.140 | 0.000 | 0.050 | 0.020 | 0.000 | 0.040 | 0.17 | 0.0 | Amorphous | 1.74 | −570 | 32.1 | 20.5 | 0.94 |
| 449 | Example | 0.300 | 0.140 | 0.000 | 0.050 | 0.020 | 0.000 | 0.080 | 0.34 | 0.0 | Amorphous | 1.74 | −567 | 31.1 | 20.8 | 0.95 |
| 450 | Example | 0.300 | 0.140 | 0.000 | 0.050 | 0.020 | 0.000 | 0.100 | 0.42 | 0.0 | Amorphous | 1.73 | −555 | 30.3 | 18.6 | 0.96 |
| 451 | Example | 0.300 | 0.140 | 0.000 | 0.050 | 0.020 | 0.000 | 1.000 | 4.2 | 0.0 | Amorphous | 1.72 | −545 | 28.1 | 20.1 | 0.96 |
| 452 | Example | 0.300 | 0.140 | 0.000 | 0.050 | 0.020 | 0.000 | 2.000 | 8.4 | 0.0 | Amorphous | 1.72 | −543 | 27.9 | 18.7 | 0.94 |
| 453 | Example | 0.300 | 0.140 | 0.000 | 0.050 | 0.020 | 0.000 | 2.800 | 12 | 0.0 | Amorphous | 1.72 | −542 | 27.5 | 19.4 | 0.93 |
| 454 | Compar- | 0.300 | 0.140 | 0.000 | 0.050 | 0.020 | 0.000 | 3.000 | 13 | 0.0 | Crystal | 1.71 | −695 | 51.0 | 19.8 | 0.92 |
| | ative | | | | | | | | | | | | | | | |
| | example | | | | | | | | | | | | | | | |

TABLE 7I

| | | | | | | | | | | | | | | Corro- | | |
|---|---|---|---|---|---|---|---|---|---|---|---|---|---|---|---|---|
| | | | | | | | | | | | | | | sion | | |
| | | | | | | | | | | α{1 − | | | Corro- | density | | |
| | Example/ | (Fe_{(1-α)}CO_{α})_{(1-(a+b+c+d+e))}BₐP_{b}Si_{c}C_{d}Crₑ | | | | | | | f/α{1 − | (a + b + | | | sion | current | Average | Average |
| Sam- | Compar- | (β = 0) | | | | | | Mn | (a + b + | c + d + | | | potential | (icorr) | particle | Wadell |
| ple | ative | | B | P | Si | C | Cr | f | c + | e)} × | Crystal | Bs | (Ecorr) | (μA/ | size | circu- |
| No. | example | α | a | b | c | d | e | (at %) | d + e)} | e × 10000 | structure | (T) | (mV) | cm²) | (μm) | larity |
| 455 | Compar- | 0.450 | 0.140 | 0.000 | 0.050 | 0.020 | 0.000 | 0.000 | — | 0.0 | Amorphous | 1.75 | −663 | 46.3 | 21.5 | 0.74 |
| | ative | | | | | | | | | | | | | | | |
| | example | | | | | | | | | | | | | | | |
| 456 | Example | 0.450 | 0.140 | 0.000 | 0.050 | 0.020 | 0.000 | 0.002 | 0.0056 | 0.0 | Amorphous | 1.75 | −588 | 35.5 | 21.2 | 0.81 |
| 457 | Example | 0.450 | 0.140 | 0.000 | 0.050 | 0.020 | 0.000 | 0.005 | 0.014 | 0.0 | Amorphous | 1.75 | −582 | 34.6 | 20.4 | 0.86 |
| 458 | Example | 0.450 | 0.140 | 0.000 | 0.050 | 0.020 | 0.000 | 0.015 | 0.042 | 0.0 | Amorphous | 1.75 | −566 | 33.3 | 20.1 | 0.90 |
| 459 | Example | 0.450 | 0.140 | 0.000 | 0.050 | 0.020 | 0.000 | 0.025 | 0.070 | 0.0 | Amorphous | 1.75 | −548 | 32.4 | 19.6 | 0.92 |
| 460 | Example | 0.450 | 0.140 | 0.000 | 0.050 | 0.020 | 0.000 | 0.040 | 0.11 | 0.0 | Amorphous | 1.75 | −536 | 32.0 | 21.4 | 0.95 |
| 461 | Example | 0.450 | 0.140 | 0.000 | 0.050 | 0.020 | 0.000 | 0.080 | 0.23 | 0.0 | Amorphous | 1.75 | −540 | 31.2 | 20.6 | 0.96 |
| 462 | Example | 0.450 | 0.140 | 0.000 | 0.050 | 0.020 | 0.000 | 0.100 | 0.28 | 0.0 | Amorphous | 1.74 | −538 | 30.1 | 19.6 | 0.96 |
| 463 | Example | 0.450 | 0.140 | 0.000 | 0.050 | 0.020 | 0.000 | 1.000 | 2.8 | 0.0 | Amorphous | 1.72 | −535 | 28.3 | 18.7 | 0.96 |
| 464 | Example | 0.450 | 0.140 | 0.000 | 0.050 | 0.020 | 0.000 | 2.000 | 5.6 | 0.0 | Amorphous | 1.72 | −534 | 27.5 | 20.1 | 0.98 |
| 465 | Example | 0.450 | 0.140 | 0.000 | 0.050 | 0.020 | 0.000 | 2.800 | 7.9 | 0.0 | Amorphous | 1.72 | −533 | 27.0 | 18.7 | 0.95 |
| 466 | Compar- | 0.450 | 0.140 | 0.000 | 0.050 | 0.020 | 0.000 | 3.000 | 8.4 | 0.0 | Crystal | 1.72 | −691 | 46.5 | 20.7 | 0.91 |
| | ative | | | | | | | | | | | | | | | |
| | example | | | | | | | | | | | | | | | |

TABLE 7J

| | | | | | | | | | | | | | | Corro- | | |
|---|---|---|---|---|---|---|---|---|---|---|---|---|---|---|---|---|
| | | | | | | | | | | | | | | sion | | |
| | | | | | | | | | | α{1 − | | | Corro- | current | | |
| | Example/ | (Fe_{(1-α)}CO_{α})_{(1-(a+b+c+d+e))}BₐP_{b}Si_{c}C_{d}Crₑ | | | | | | | f/α{1 − | (a + b + | | | sion | density | Average | Average |
| Sam- | Compar- | (β = 0) | | | | | | Mn | (a + b + | c + d + | | | potential | (icorr) | particle | Wadell |
| ple | ative | | B | P | Si | C | Cr | f | c + | e)} × | Crystal | Bs | (Ecorr) | (μA/ | size | circu- |
| No. | example | α | a | b | c | d | e | (at %) | d + e)} | e × 10000 | structure | (T) | (mV) | cm²) | (μm) | larity |
| 467 | Compar- | 0.500 | 0.140 | 0.000 | 0.050 | 0.020 | 0.000 | 0.000 | — | 0.0 | Amorphous | 1.72 | −660 | 45.1 | 20.3 | 0.72 |
| | ative | | | | | | | | | | | | | | | |
| | example | | | | | | | | | | | | | | | |
| 468 | Example | 0.500 | 0.140 | 0.000 | 0.050 | 0.020 | 0.000 | 0.002 | 0.0051 | 0.0 | Amorphous | 1.72 | −589 | 35.4 | 18.8 | 0.80 |
| 469 | Example | 0.500 | 0.140 | 0.000 | 0.050 | 0.020 | 0.000 | 0.005 | 0.013 | 0.0 | Amorphous | 1.72 | −576 | 34.2 | 20.7 | 0.85 |
| 470 | Example | 0.500 | 0.140 | 0.000 | 0.050 | 0.020 | 0.000 | 0.015 | 0.038 | 0.0 | Amorphous | 1.72 | −570 | 33.3 | 19.8 | 0.91 |
| 471 | Example | 0.500 | 0.140 | 0.000 | 0.050 | 0.020 | 0.000 | 0.025 | 0.063 | 0.0 | Amorphous | 1.72 | −550 | 32.1 | 20.2 | 0.93 |
| 472 | Example | 0.500 | 0.140 | 0.000 | 0.050 | 0.020 | 0.000 | 0.040 | 0.10 | 0.0 | Amorphous | 1.72 | −534 | 31.6 | 19.6 | 0.94 |
| 473 | Example | 0.500 | 0.140 | 0.000 | 0.050 | 0.020 | 0.000 | 0.080 | 0.20 | 0.0 | Amorphous | 1.72 | −533 | 30.1 | 19.2 | 0.94 |
| 474 | Example | 0.500 | 0.140 | 0.000 | 0.050 | 0.020 | 0.000 | 0.100 | 0.25 | 0.0 | Amorphous | 1.71 | −532 | 29.7 | 20.5 | 0.93 |
| 475 | Example | 0.500 | 0.140 | 0.000 | 0.050 | 0.020 | 0.000 | 1.000 | 2.5 | 0.0 | Amorphous | 1.71 | −530 | 28.4 | 19.2 | 0.93 |
| 476 | Example | 0.500 | 0.140 | 0.000 | 0.050 | 0.020 | 0.000 | 2.000 | 5.1 | 0.0 | Amorphous | 1.71 | −529 | 27.4 | 21.2 | 0.93 |
| 477 | Example | 0.500 | 0.140 | 0.000 | 0.050 | 0.020 | 0.000 | 2.800 | 7.1 | 0.0 | Amorphous | 1.71 | −526 | 26.5 | 21.4 | 0.94 |
| 478 | Compar- | 0.500 | 0.140 | 0.000 | 0.050 | 0.020 | 0.000 | 3.000 | 7.6 | 0.0 | Crystal | 1.70 | −678 | 48.0 | 19.0 | 0.93 |
| | ative | | | | | | | | | | | | | | | |
| | example | | | | | | | | | | | | | | | |

TABLE 7J

| | | (Fe₍₁₋ₐ₎Coₐ)_{(1-(a+b+c+d-e))} | | | | | | |
|---|---|---|---|---|---|---|---|---|
| | Example/ | BₐP_{b}Si_{c}C_{d}Crₑ (β = 0) | | | | | | Mn |
| Sample | Comparative | | B | P | Si | C | Cr | f |
| No. | example | a | a | b | c | d | e | (at %) |
| 479 | Comparative | 0.600 | 0.140 | 0.000 | 0.050 | 0.020 | 0.000 | 0.000 |
| | example | | | | | | | |
| 480 | Example | 0.600 | 0.140 | 0.000 | 0.050 | 0.020 | 0.000 | 0.002 |
| 481 | Example | 0.600 | 0.140 | 0.000 | 0.050 | 0.020 | 0.000 | 0.005 |
| 482 | Example | 0.600 | 0.140 | 0.000 | 0.050 | 0.020 | 0.000 | 0.015 |
| 483 | Example | 0.600 | 0.140 | 0.000 | 0.050 | 0.020 | 0.000 | 0.025 |
| 484 | Example | 0.600 | 0.140 | 0.000 | 0.050 | 0.020 | 0.000 | 0.040 |
| 485 | Example | 0.600 | 0.140 | 0.000 | 0.050 | 0.020 | 0.000 | 0.080 |
| 486 | Example | 0.600 | 0.140 | 0.000 | 0.050 | 0.020 | 0.000 | 0.100 |
| 487 | Example | 0.600 | 0.140 | 0.000 | 0.050 | 0.020 | 0.000 | 1.000 |
| 488 | Example | 0.600 | 0.140 | 0.000 | 0.050 | 0.020 | 0.000 | 2.000 |
| 489 | Example | 0.600 | 0.140 | 0.000 | 0.050 | 0.020 | 0.000 | 2.800 |
| 490 | Comparative | 0.600 | 0.140 | 0.000 | 0.050 | 0.020 | 0.000 | 3.000 |
| | example | | | | | | | |
| | | | | | | Corrosion | | |
| | | a{1−(a + | | | Corrosion | current | Average | |
| | f/a{1− | b + c + | | | potential | density | particle | Average |
| Sample | (a + b + | d + e)} × | Crystal | Bs | (Ecorr) | (icorr) | size | Wadell |
| No. | c + d + e)} | e × 10000 | structure | (T) | (mV) | (μA/cm²) | (μm) | circularity |
| 479 | — | 0.0 | Amorphous | 1.61 | −658 | 46.1 | 19.4 | 0.73 |
| 480 | 0.0042 | 0.0 | Amorphous | 1.61 | −585 | 35.3 | 19.7 | 0.80 |
| 481 | 0.011 | 0.0 | Amorphous | 1.61 | −570 | 34.1 | 18.8 | 0.87 |
| 482 | 0.032 | 0.0 | Amorphous | 1.61 | −555 | 32.2 | 20.1 | 0.88 |
| 483 | 0.053 | 0.0 | Amorphous | 1.61 | −540 | 31.5 | 20.8 | 0.93 |
| 484 | 0.084 | 0.0 | Amorphous | 1.61 | −535 | 31.3 | 18.7 | 0.93 |
| 485 | 0.17 | 0.0 | Amorphous | 1.61 | −521 | 30.4 | 20.7 | 0.95 |
| 486 | 0.21 | 0.0 | Amorphous | 1.61 | −520 | 29.5 | 20.7 | 0.95 |
| 487 | 2.1 | 0.0 | Amorphous | 1.61 | −519 | 28.5 | 18.8 | 0.94 |
| 488 | 4.2 | 0.0 | Amorphous | 1.60 | −518 | 27.3 | 20.8 | 0.94 |
| 489 | 5.9 | 0.0 | Amorphous | 1.60 | −517 | 26.4 | 21.1 | 0.94 |
| 490 | 6.3 | 0.0 | Crystal | 1.60 | −660 | 53.0 | 19.5 | 0.93 |

TABLE 7K

| | | (Fe₍₁₋ₐ₎Coₐ)_{(1-(a+b+c+d-e))} | | | | | | |
|---|---|---|---|---|---|---|---|---|
| | Example/ | BₐP_{b}Si_{c}C_{d}Crₑ (β = 0) | | | | | | Mn |
| Sample | Comparative | | B | P | Si | C | Cr | f |
| No. | example | a | a | b | c | d | e | (at %) |
| 491 | Comparative | 0.700 | 0.140 | 0.000 | 0.050 | 0.020 | 0.000 | 0.000 |
| | example | | | | | | | |
| 492 | Example | 0.700 | 0.140 | 0.000 | 0.050 | 0.020 | 0.000 | 0.002 |
| 493 | Example | 0.700 | 0.140 | 0.000 | 0.050 | 0.020 | 0.000 | 0.005 |
| 494 | Example | 0.700 | 0.140 | 0.000 | 0.050 | 0.020 | 0.000 | 0.015 |
| 495 | Example | 0.700 | 0.140 | 0.000 | 0.050 | 0.020 | 0.000 | 0.025 |
| 496 | Example | 0.700 | 0.140 | 0.000 | 0.050 | 0.020 | 0.000 | 0.040 |
| 497 | Example | 0.700 | 0.140 | 0.000 | 0.050 | 0.020 | 0.000 | 0.080 |
| 498 | Example | 0.700 | 0.140 | 0.000 | 0.050 | 0.020 | 0.000 | 0.100 |
| 499 | Example | 0.700 | 0.140 | 0.000 | 0.050 | 0.020 | 0.000 | 1.000 |
| 500 | Example | 0.700 | 0.140 | 0.000 | 0.050 | 0.020 | 0.000 | 2.000 |
| 501 | Example | 0.700 | 0.140 | 0.000 | 0.050 | 0.020 | 0.000 | 2.800 |
| 502 | Comparative | 0.700 | 0.140 | 0.000 | 0.050 | 0.020 | 0.000 | 3.000 |
| | example | | | | | | | |
| | | | | | | Corrosion | | |
| | | a{1−(a + | | | Corrosion | current | Average | |
| | f/a{1− | b + c + | | | potential | density | particle | Average |
| Sample | (a + b + | d + e)} × | Crystal | Bs | (Ecorr) | (icorr) | size | Wadell |
| No. | c + d + e)} | e × 10000 | structure | (T) | (mV) | (μA/cm²) | (μm) | circularity |
| 491 | — | 0.0 | Amorphous | 1.53 | −648 | 45.3 | 20.5 | 0.72 |
| 492 | 0.0036 | 0.0 | Amorphous | 1.53 | −584 | 35.2 | 18.9 | 0.80 |
| 493 | 0.0090 | 0.0 | Amorphous | 1.53 | −567 | 33.9 | 19.8 | 0.83 |
| 494 | 0.027 | 0.0 | Amorphous | 1.53 | −555 | 33.5 | 20.1 | 0.86 |
| 495 | 0.045 | 0.0 | Amorphous | 1.53 | −545 | 31.3 | 20.4 | 0.88 |
| 496 | 0.072 | 0.0 | Amorphous | 1.53 | −530 | 31.1 | 20.6 | 0.89 |
| 497 | 0.14 | 0.0 | Amorphous | 1.53 | −521 | 30.5 | 21.5 | 0.92 |
| 498 | 0.18 | 0.0 | Amorphous | 1.53 | −520 | 29.5 | 20.2 | 0.90 |
| 499 | 1.8 | 0.0 | Amorphous | 1.53 | −518 | 28.4 | 21.1 | 0.90 |
| 500 | 3.6 | 0.0 | Amorphous | 1.53 | −517 | 27.4 | 19.1 | 0.89 |
| 501 | 5.1 | 0.0 | Amorphous | 1.52 | −510 | 26.4 | 18.7 | 0.89 |
| 502 | 5.4 | 0.0 | Crystal | 1.51 | −666 | 52.0 | 21.0 | 0.88 |

TABLE 7M

| | | (Fe₍₁₋ₐ₎Coₐ)_{(1-(a+b+c+d-e))} | | | | | | |
|---|---|---|---|---|---|---|---|---|
| | Example/ | BₐP_{b}Si_{c}C_{d}Crₑ (β = 0) | | | | | | Mn |
| Sample | Comparative | | B | P | Si | C | Cr | f |
| No. | example | a | a | b | c | d | e | (at %) |
| 503 | Comparative | 0.800 | 0.140 | 0.000 | 0.050 | 0.020 | 0.000 | 0.000 |
| | example | | | | | | | |
| 504 | Comparative | 0.800 | 0.140 | 0.000 | 0.050 | 0.020 | 0.000 | 0.002 |
| | example | | | | | | | |
| 505 | Comparative | 0.800 | 0.140 | 0.000 | 0.050 | 0.020 | 0.000 | 0.005 |
| | example | | | | | | | |
| 506 | Comparative | 0.800 | 0.140 | 0.000 | 0.050 | 0.020 | 0.000 | 0.015 |
| | example | | | | | | | |
| 507 | Comparative | 0.800 | 0.140 | 0.000 | 0.050 | 0.020 | 0.000 | 0.025 |
| | example | | | | | | | |
| 508 | Comparative | 0.800 | 0.140 | 0.000 | 0.050 | 0.020 | 0.000 | 0.040 |
| | example | | | | | | | |
| 509 | Comparative | 0.800 | 0.140 | 0.000 | 0.050 | 0.020 | 0.000 | 0.080 |
| | example | | | | | | | |
| 510 | Comparative | 0.800 | 0.140 | 0.000 | 0.050 | 0.020 | 0.000 | 0.100 |
| | example | | | | | | | |
| 511 | Comparative | 0.800 | 0.140 | 0.000 | 0.050 | 0.020 | 0.000 | 1.000 |
| | example | | | | | | | |
| 512 | Comparative | 0.800 | 0.140 | 0.000 | 0.050 | 0.020 | 0.000 | 2.000 |
| | example | | | | | | | |
| 513 | Comparative | 0.800 | 0.140 | 0.000 | 0.050 | 0.020 | 0.000 | 2.800 |
| | example | | | | | | | |
| 514 | Comparative | 0.800 | 0.140 | 0.000 | 0.050 | 0.020 | 0.000 | 3.000 |
| | example | | | | | | | |
| | | | | | | Corrosion | | |
| | | a{1−(a + | | | Corrosion | current | Average | |
| | f/a{1− | b + c + | | | potential | density | particle | Average |
| Sample | (a + b + | d + e)} × | Crystal | Bs | (Ecorr) | (icorr) | size | Wadell |
| No. | c + d + e)} | e × 10000 | structure | (T) | (mV) | (μA/cm²) | (μm) | circularity |
| 503 | — | 0.0 | Amorphous | 1.44 | −621 | 39.0 | 19.1 | 0.71 |
| 504 | 0.0032 | 0.0 | Amorphous | 1.44 | −582 | 35.1 | 19.8 | 0.82 |
| 505 | 0.0079 | 0.0 | Amorphous | 1.44 | −566 | 32.1 | 18.5 | 0.82 |
| 506 | 0.024 | 0.0 | Amorphous | 1.44 | −545 | 31.5 | 21.2 | 0.85 |
| 507 | 0.040 | 0.0 | Amorphous | 1.44 | −542 | 30.8 | 19.2 | 0.86 |
| 508 | 0.063 | 0.0 | Amorphous | 1.44 | −523 | 30.6 | 20.9 | 0.88 |
| 509 | 0.13 | 0.0 | Amorphous | 1.44 | −513 | 29.8 | 20.4 | 0.91 |
| 510 | 0.16 | 0.0 | Amorphous | 1.44 | −510 | 29.5 | 20.1 | 0.91 |
| 511 | 1.6 | 0.0 | Amorphous | 1.44 | −509 | 28.5 | 20.2 | 0.91 |
| 512 | 3.2 | 0.0 | Amorphous | 1.44 | −508 | 27.6 | 21.0 | 0.90 |
| 513 | 4.4 | 0.0 | Amorphous | 1.44 | −508 | 26.2 | 19.0 | 0.90 |
| 514 | 4.7 | 0.0 | Amorphous | 1.44 | −676 | 49.0 | 20.0 | 0.88 |

Table 7A to Table 7M show results of examples and comparative examples in which the Co amount (α) with respect to Fe and the Mn amount (f) were varied in a composition not including P and Cr, which is different from examples and comparative examples shown in Table 1 A to Table 1M. When the Co amount (α) with respect to Fe and the Mn amount (f) were within the predetermined ranges, Bs and the corrosion resistance were good. On the other hand, when the Co amount (α) with respect to Fe was too small and the Mn amount was out of the predetermined range, the corrosion resistance decreased. When the Co amount (α) with respect to Fe was too large, Bs decreased. Further, when the Mn amount was too large, crystals were formed in the soft magnetic alloy ribbon and the amorphous ratio X was less than 85%.

TABLE 8

| | | | | | | | | Corrosion | | |
|---|---|---|---|---|---|---|---|---|---|---|
| | | (Fe_{(1-(a+β))} CoₐNi_{β})_{0.820} | | | | | Corrosion | current | Average | |
| | Example/ | B_{0.110}P_{0.020}Si_{0.030} | | Mn | | | potential | density | particle | Average |
| Sample | Comparative | C_{0.010}Cr_{0.010} | | f | Crystal | Bs | (Ecorr) | (icorr) | size | Wadell |
| No. | example | a | β | (at %) | structure | (T) | (mV) | (μA/cm²) | (μm) | circularity |
| 173 | Example | 0.300 | 0.000 | 0.040 | Amorphous | 1.69 | −540 | 20.1 | 21.2 | 0.94 |
| 515 | Example | 0.300 | 0.005 | 0.040 | Amorphous | 1.73 | −533 | 18.0 | 21.0 | 0.95 |
| 516 | Example | 0.300 | 0.010 | 0.040 | Amorphous | 1.72 | −520 | 17.0 | 20.3 | 0.96 |
| 517 | Example | 0.300 | 0.050 | 0.040 | Amorphous | 1.66 | −512 | 16.4 | 20.5 | 0.96 |
| 518 | Example | 0.300 | 0.100 | 0.040 | Amorphous | 1.63 | −508 | 15.0 | 20.1 | 0.97 |
| 519 | Example | 0.300 | 0.150 | 0.040 | Amorphous | 1.60 | −498 | 14.3 | 21.4 | 0.95 |
| 520 | Example | 0.300 | 0.200 | 0.040 | Amorphous | 1.55 | −478 | 14.2 | 21.4 | 0.94 |
| 521 | Comparative | 0.300 | 0.250 | 0.040 | Amorphous | 1.48 | −445 | 13.0 | 20.6 | 0.95 |
| | example | | | | | | | | | |

Table 8 shows results of examples and comparative examples in which Fe of Sample No. 173 was partially substituted by Ni. By including a small amount of Ni, Bs tended to improve compared to the case of not including Ni. Also, as β increased, the corrosion resistance tended to improve; however, when β was too large, Bs decreased.

TABLE 9A

| | | ((Fe₍₁₋ₐ₎ Coₐ)_{(1-γ)}X1_{γ})_{0.820} | | | | | | | Corrosion | | |
|---|---|---|---|---|---|---|---|---|---|---|---|
| | | B_{0.110}P_{0.020}Si_{0.030} | | | | | | Corrosion | current | Average | |
| | Example/ | C_{0.010}Cr_{0.010} | | | Mn | | | potential | density | particle | Average |
| Sample | Comparative | (β = 0) | | | f | Crystal | Bs | (Ecorr) | (icorr) | size | Wadell |
| No. | example | a | X1 | γ | (at %) | structure | (T) | (mV) | (μA/cm²) | (μm) | circularity |
| 173 | Example | 0.300 | — | 0.000 | 0.040 | Amorphous | 1.69 | −540 | 20.1 | 21.2 | 0.94 |
| 522 | Example | 0.300 | Al | 0.001 | 0.040 | Amorphous | 1.69 | −557 | 23.9 | 21.4 | 0.94 |
| 523 | Example | 0.300 | Al | 0.003 | 0.040 | Amorphous | 1.69 | −557 | 23.9 | 20.7 | 0.94 |
| 524 | Example | 0.300 | Al | 0.010 | 0.040 | Amorphous | 1.67 | −585 | 24.4 | 20.5 | 0.93 |
| 525 | Example | 0.300 | Al | 0.025 | 0.040 | Amorphous | 1.66 | −607 | 24.7 | 20.5 | 0.93 |
| 526 | Example | 0.300 | Zn | 0.001 | 0.040 | Amorphous | 1.69 | −551 | 23.6 | 19.2 | 0.93 |
| 527 | Example | 0.300 | Zn | 0.003 | 0.040 | Amorphous | 1.69 | −546 | 23.3 | 21.2 | 0.94 |
| 528 | Example | 0.300 | Zn | 0.010 | 0.040 | Amorphous | 1.67 | −590 | 24.7 | 19.3 | 0.94 |
| 529 | Example | 0.300 | Zn | 0.025 | 0.040 | Amorphous | 1.66 | −601 | 24.9 | 19.2 | 0.94 |
| 530 | Example | 0.300 | Sn | 0.001 | 0.040 | Amorphous | 1.68 | −546 | 24.1 | 19.2 | 0.93 |
| 531 | Example | 0.300 | Sn | 0.003 | 0.040 | Amorphous | 1.68 | −551 | 24.4 | 21.0 | 0.93 |
| 532 | Example | 0.300 | Sn | 0.010 | 0.040 | Amorphous | 1.66 | −574 | 24.9 | 18.7 | 0.93 |
| 533 | Example | 0.300 | Sn | 0.025 | 0.040 | Amorphous | 1.65 | −601 | 25.1 | 19.4 | 0.93 |
| 534 | Example | 0.300 | Cu | 0.001 | 0.040 | Amorphous | 1.70 | −599 | 30.1 | 21.5 | 0.89 |
| 535 | Example | 0.300 | Cu | 0.003 | 0.040 | Amorphous | 1.68 | −612 | 32.1 | 19.5 | 0.87 |
| 536 | Example | 0.300 | Cu | 0.010 | 0.040 | Amorphous | 1.66 | −616 | 38.1 | 20.9 | 0.87 |
| 537 | Example | 0.300 | Cu | 0.025 | 0.040 | Amorphous | 1.64 | −626 | 44.4 | 21.3 | 0.86 |
| 538 | Example | 0.300 | Bi | 0.001 | 0.040 | Amorphous | 1.68 | −551 | 24.7 | 20.3 | 0.94 |
| 539 | Example | 0.300 | Bi | 0.003 | 0.040 | Amorphous | 1.68 | −546 | 24.9 | 19.6 | 0.93 |
| 540 | Example | 0.300 | Bi | 0.010 | 0.040 | Amorphous | 1.66 | −574 | 25.7 | 18.7 | 0.92 |
| 541 | Example | 0.300 | Bi | 0.025 | 0.040 | Amorphous | 1.65 | −590 | 26.5 | 20.2 | 0.93 |
| 542 | Example | 0.300 | La | 0.001 | 0.040 | Amorphous | 1.67 | −551 | 24.1 | 18.9 | 0.93 |
| 543 | Example | 0.300 | La | 0.003 | 0.040 | Amorphous | 1.67 | −546 | 24.4 | 18.6 | 0.93 |
| 544 | Example | 0.300 | La | 0.010 | 0.040 | Amorphous | 1.61 | −568 | 25.2 | 20.9 | 0.94 |
| 545 | Example | 0.300 | La | 0.025 | 0.040 | Amorphous | 1.55 | −579 | 25.1 | 21.3 | 0.94 |
| 546 | Example | 0.300 | Y | 0.001 | 0.040 | Amorphous | 1.67 | −551 | 23.3 | 20.8 | 0.93 |
| 547 | Example | 0.300 | Y | 0.003 | 0.040 | Amorphous | 1.67 | −540 | 23.6 | 21.0 | 0.93 |
| 548 | Example | 0.300 | Y | 0.010 | 0.040 | Amorphous | 1.64 | −568 | 24.4 | 20.7 | 0.92 |
| 549 | Example | 0.300 | Y | 0.025 | 0.040 | Amorphous | 1.60 | −596 | 25.2 | 19.5 | 0.93 |

TABLE 9B

| | | ((Fe₍₁₋ₐ₎ Coₐ)_{(1-γ)}X1_{γ})_{0.820} | | | | | | | Corrosion | | |
|---|---|---|---|---|---|---|---|---|---|---|---|
| | | B_{0.110}P_{0.020}Si_{0.030} | | | | | | Corrosion | current | Average | |
| | Example/ | C_{0.010}Cr_{0.010} | | | Mn | | | potential | density | particle | Average |
| Sample | Comparative | (β = 0) | | | f | Crystal | Bs | (Ecorr) | (icorr) | size | Wadell |
| No. | example | a | X1 | γ | (at %) | structure | (T) | (mV) | (μA/cm²) | (μm) | circularity |
| 173 | Example | 0.300 | — | 0.000 | 0.040 | Amorphous | 1.69 | −540 | 20.1 | 21.2 | 0.94 |
| 550 | Example | 0.300 | Ga | 0.001 | 0.040 | Amorphous | 1.67 | −535 | 25.1 | 19.6 | 0.93 |
| 551 | Example | 0.300 | Ga | 0.003 | 0.040 | Amorphous | 1.67 | −523 | 25.3 | 18.9 | 0.94 |
| 552 | Example | 0.300 | Ga | 0.010 | 0.040 | Amorphous | 1.62 | −574 | 27.4 | 18.6 | 0.94 |
| 553 | Example | 0.300 | Ga | 0.025 | 0.040 | Amorphous | 1.60 | −590 | 28.5 | 20.6 | 0.93 |
| 554 | Example | 0.300 | Ti | 0.001 | 0.040 | Amorphous | 1.67 | −551 | 25.3 | 21.5 | 0.94 |
| 555 | Example | 0.300 | Ti | 0.003 | 0.040 | Amorphous | 1.67 | −535 | 25.9 | 20.5 | 0.94 |
| 556 | Example | 0.300 | Ti | 0.010 | 0.040 | Amorphous | 1.61 | −585 | 28.0 | 18.6 | 0.95 |
| 557 | Example | 0.300 | Ti | 0.025 | 0.040 | Amorphous | 1.55 | −613 | 29.0 | 20.8 | 0.93 |
| 558 | Example | 0.300 | Zr | 0.001 | 0.040 | Amorphous | 1.67 | −551 | 25.9 | 19.7 | 0.94 |
| 559 | Example | 0.300 | Zr | 0.003 | 0.040 | Amorphous | 1.67 | −535 | 26.1 | 19.5 | 0.93 |
| 560 | Example | 0.300 | Zr | 0.010 | 0.040 | Amorphous | 1.62 | −574 | 26.6 | 19.9 | 0.93 |
| 561 | Example | 0.300 | Zr | 0.025 | 0.040 | Amorphous | 1.56 | −596 | 27.2 | 21.4 | 0.93 |
| 562 | Example | 0.300 | Hf | 0.001 | 0.040 | Amorphous | 1.67 | −551 | 25.9 | 21.1 | 0.95 |
| 563 | Example | 0.300 | Hf | 0.003 | 0.040 | Amorphous | 1.67 | −535 | 25.6 | 19.1 | 0.94 |
| 564 | Example | 0.300 | Hf | 0.010 | 0.040 | Amorphous | 1.61 | −568 | 25.9 | 20.8 | 0.93 |
| 565 | Example | 0.300 | Hf | 0.025 | 0.040 | Amorphous | 1.55 | −579 | 25.6 | 21.0 | 0.94 |
| 566 | Example | 0.300 | Nb | 0.001 | 0.040 | Amorphous | 1.68 | −535 | 26.1 | 19.8 | 0.93 |
| 567 | Example | 0.300 | Nb | 0.003 | 0.040 | Amorphous | 1.67 | −529 | 25.6 | 19.4 | 0.94 |
| 568 | Example | 0.300 | Nb | 0.010 | 0.040 | Amorphous | 1.57 | −529 | 24.8 | 21.0 | 0.93 |
| 569 | Example | 0.300 | Nb | 0.025 | 0.040 | Amorphous | 1.55 | −501 | 24.3 | 20.9 | 0.93 |

TABLE 9C

| | | | | | | | | | Corrosion | | |
|---|---|---|---|---|---|---|---|---|---|---|---|
| | | ((Fe₍₁₋ₐ₎Coₐ)_{(1-γ)}X1_{γ})_{0.820} | | | | | | Corrosion | current | Average | |
| | Example/ | B_{0.110}P_{0.020}Si_{0.030}C_{0.010}Cr_{0.010} | | | Mn | | | potential | density | particle | Average |
| Sample | Comparative | (β = 0) | | | f | Crystal | Bs | (Ecorr) | (icorr) | size | Wadell |
| No. | example | a | X1 | γ | (at %) | structure | (T) | (mV) | (μA/cm²) | (μm) | circularity |
| 173 | Example | 0.300 | — | 0.000 | 0.040 | Amorphous | 1.69 | −540 | 20.1 | 21.2 | 0.94 |
| 570 | Example | 0.300 | Ta | 0.001 | 0.040 | Amorphous | 1.67 | −523 | 25.9 | 19.0 | 0.93 |
| 571 | Example | 0.300 | Ta | 0.003 | 0.040 | Amorphous | 1.67 | −529 | 25.6 | 20.8 | 0.93 |
| 572 | Example | 0.300 | Ta | 0.010 | 0.040 | Amorphous | 1.61 | −535 | 25.6 | 19.2 | 0.94 |
| 573 | Example | 0.300 | Ta | 0.025 | 0.040 | Amorphous | 1.55 | −546 | 25.3 | 19.6 | 0.93 |
| 574 | Example | 0.300 | Mo | 0.001 | 0.040 | Amorphous | 1.68 | −540 | 25.6 | 19.5 | 0.94 |
| 575 | Example | 0.300 | Mo | 0.003 | 0.040 | Amorphous | 1.67 | −529 | 25.6 | 21.4 | 0.94 |
| 576 | Example | 0.300 | Mo | 0.010 | 0.040 | Amorphous | 1.60 | −535 | 25.9 | 19.9 | 0.93 |
| 577 | Example | 0.300 | Mo | 0.025 | 0.040 | Amorphous | 1.55 | −535 | 25.3 | 20.7 | 0.93 |
| 578 | Example | 0.300 | V | 0.001 | 0.040 | Amorphous | 1.68 | −540 | 25.3 | 20.7 | 0.93 |
| 579 | Example | 0.300 | V | 0.003 | 0.040 | Amorphous | 1.67 | −535 | 24.8 | 21.2 | 0.92 |
| 580 | Example | 0.300 | V | 0.010 | 0.040 | Amorphous | 1.60 | −546 | 25.3 | 18.8 | 0.93 |
| 581 | Example | 0.300 | V | 0.025 | 0.040 | Amorphous | 1.55 | −551 | 26.1 | 21.4 | 0.94 |
| 582 | Example | 0.300 | W | 0.001 | 0.040 | Amorphous | 1.67 | −540 | 25.1 | 19.3 | 0.93 |
| 583 | Example | 0.300 | W | 0.003 | 0.040 | Amorphous | 1.67 | −540 | 25.3 | 19.9 | 0.93 |
| 584 | Example | 0.300 | W | 0.010 | 0.040 | Amorphous | 1.57 | −540 | 25.6 | 20.6 | 0.93 |
| 585 | Example | 0.300 | W | 0.025 | 0.040 | Amorphous | 1.55 | −546 | 25.3 | 19.0 | 0.92 |
| 586 | Example | 0.300 | Ca | 0.0001 | 0.040 | Amorphous | 1.67 | −551 | 26.1 | 20.8 | 0.94 |
| 587 | Example | 0.300 | Ca | 0.003 | 0.040 | Amorphous | 1.66 | −546 | 25.3 | 20.3 | 0.92 |
| 588 | Example | 0.300 | Ca | 0.005 | 0.040 | Amorphous | 1.65 | −556 | 25.1 | 20.0 | 0.92 |
| 589 | Example | 0.300 | Ca | 0.010 | 0.040 | Amorphous | 1.64 | −555 | 25.7 | 18.6 | 0.92 |
| 590 | Example | 0.300 | Ca | 0.025 | 0.040 | Amorphous | 1.63 | −560 | 26.0 | 19.6 | 0.94 |
| 591 | Example | 0.300 | Mg | 0.0001 | 0.040 | Amorphous | 1.68 | −562 | 26.6 | 20.2 | 0.93 |
| 592 | Example | 0.300 | Mg | 0.003 | 0.040 | Amorphous | 1.68 | −568 | 26.9 | 19.1 | 0.92 |
| 593 | Example | 0.300 | Mg | 0.005 | 0.040 | Amorphous | 1.67 | −570 | 27.6 | 19.0 | 0.93 |
| 594 | Example | 0.300 | Mg | 0.010 | 0.040 | Amorphous | 1.65 | −573 | 26.9 | 20.7 | 0.94 |
| 595 | Example | 0.300 | Mg | 0.025 | 0.040 | Amorphous | 1.62 | −578 | 28.0 | 20.7 | 0.94 |
| 596 | Example | 0.300 | S | 0.0001 | 0.040 | Amorphous | 1.67 | −562 | 26.6 | 20.1 | 0.95 |
| 597 | Example | 0.300 | S | 0.003 | 0.040 | Amorphous | 1.68 | −568 | 27.2 | 19.4 | 0.96 |
| 598 | Example | 0.300 | S | 0.005 | 0.040 | Amorphous | 1.67 | −577 | 26.3 | 19.4 | 0.97 |
| 599 | Example | 0.300 | S | 0.010 | 0.040 | Amorphous | 1.66 | −580 | 27.6 | 19.7 | 0.97 |
| 600 | Example | 0.300 | S | 0.025 | 0.040 | Amorphous | 1.64 | −594 | 32.0 | 20.4 | 0.98 |
| 601 | Example | 0.300 | N | 0.0001 | 0.040 | Amorphous | 1.68 | −551 | 26.4 | 19.3 | 0.93 |
| 602 | Example | 0.300 | N | 0.003 | 0.040 | Amorphous | 1.67 | −562 | 26.9 | 18.7 | 0.94 |
| 603 | Example | 0.300 | N | 0.005 | 0.040 | Amorphous | 1.66 | −566 | 27.6 | 20.9 | 0.92 |
| 604 | Example | 0.300 | N | 0.025 | 0.040 | Amorphous | 1.64 | −568 | 28.0 | 19.6 | 0.92 |

TABLE 9D

| | | | | | | | | | |
|---|---|---|---|---|---|---|---|---|---|
| | | ((Fe₍₁₋ₐ₎Coₐ)_{(1-γ)}X1_{γ})_{0.820} | | | | | Corrosion | | |
| | | B_{0.110}P_{0.020}Si_{0.030} | | | | Corrosion | current | Average | |
| | Example/ | C_{0.010}Cr_{0.010} | Mn | | | potential | density | particle | Average |
| Sample | Comparative | (β = 0) | f | Crystal | Bs | (Ecorr) | (icorr) | size | Wadell |

| No. | example | a | X1 | γ | (at %) | structure | (T) | (mV) | (μA/cm²) | (μm) | circularity |
|---|---|---|---|---|---|---|---|---|---|---|---|
| 173 | Example | 0.300 | — | 0.000 | 0.040 | Amorphous | 1.69 | −540 | 20.1 | 21.2 | 0.94 |
| 605 | Example | 0.300 | Ag | 0.001 | 0.040 | Amorphous | 1.68 | −522 | 26.2 | 18.9 | 0.93 |
| 606 | Example | 0.300 | Ag | 0.003 | 0.040 | Amorphous | 1.67 | −527 | 25.8 | 19.4 | 0.94 |
| 607 | Example | 0.300 | Ag | 0.010 | 0.040 | Amorphous | 1.65 | −538 | 25.8 | 18.6 | 0.94 |
| 608 | Example | 0.300 | Ag | 0.025 | 0.040 | Amorphous | 1.58 | −551 | 26.0 | 20.4 | 0.94 |
| 609 | Example | 0.300 | As | 0.001 | 0.040 | Amorphous | 1.68 | −537 | 27.0 | 20.9 | 0.94 |
| 610 | Example | 0.300 | As | 0.003 | 0.040 | Amorphous | 1.67 | −534 | 27.1 | 19.2 | 0.93 |
| 611 | Example | 0.300 | As | 0.010 | 0.040 | Amorphous | 1.64 | −539 | 25.6 | 21.0 | 0.94 |
| 612 | Example | 0.300 | As | 0.025 | 0.040 | Amorphous | 1.57 | −534 | 24.7 | 20.4 | 0.93 |
| 613 | Example | 0.300 | Sb | 0.001 | 0.040 | Amorphous | 1.66 | −535 | 25.8 | 18.9 | 0.92 |
| 614 | Example | 0.300 | Sb | 0.003 | 0.040 | Amorphous | 1.64 | −538 | 25.6 | 18.5 | 0.92 |
| 615 | Example | 0.300 | Sb | 0.010 | 0.040 | Amorphous | 1.62 | −550 | 24.6 | 19.3 | 0.92 |
| 616 | Example | 0.300 | Sb | 0.025 | 0.040 | Amorphous | 1.56 | −556 | 24.5 | 21.1 | 0.94 |
| 617 | Example | 0.300 | Au | 0.001 | 0.040 | Amorphous | 1.68 | −538 | 25.9 | 18.8 | 0.93 |
| 618 | Example | 0.300 | Au | 0.003 | 0.040 | Amorphous | 1.67 | −543 | 24.5 | 18.7 | 0.92 |
| 619 | Example | 0.300 | Au | 0.010 | 0.040 | Amorphous | 1.66 | −544 | 24.8 | 19.2 | 0.93 |
| 620 | Example | 0.300 | Au | 0.025 | 0.040 | Amorphous | 1.58 | −545 | 24.3 | 20.1 | 0.92 |
| 621 | Example | 0.300 | Pt | 0.001 | 0.040 | Amorphous | 1.67 | −553 | 27.0 | 20.1 | 0.93 |
| 622 | Example | 0.300 | Pt | 0.003 | 0.040 | Amorphous | 1.66 | −543 | 24.8 | 19.0 | 0.93 |
| 623 | Example | 0.300 | Pt | 0.010 | 0.040 | Amorphous | 1.64 | −556 | 24.5 | 19.4 | 0.94 |
| 624 | Example | 0.300 | Pt | 0.025 | 0.040 | Amorphous | 1.56 | −559 | 24.2 | 19.3 | 0.94 |

Table 9A to Table 9D show results of examples in which Fe was partially substituted by X1 from what is shown in Sample No. 173. When X1 was within the predetermined range, that is, when the X1 amount (γ) was within the predetermined range, a high corrosion resistance and a high Bs were obtained.

TABLE 10

| | Example/ | ((Fe₍₁₋ₐ₎Coₐ)_{(1-γ)}X1_{γ})_{(1-(a+b+c+d-e))}BₐP_{b}Si_{c}C_{d}Crₑ | | | | | | |
|---|---|---|---|---|---|---|---|---|
| Sample | Comparative | | | | B | P | Si | C |
| No. | example | a | X1 | γ | a | b | c | d |
| 173 | Example | 0.300 | — | 0.000 | 0.110 | 0.020 | 0.030 | 0.010 |
| 625 | Example | 0.300 | — | 0.000 | 0.110 | 0.020 | 0.030 | 0.010 |
| 626 | Comparative | 0.300 | Nb | 0.037 | 0.110 | 0.020 | 0.000 | 0.010 |
| | example | | | | | | | |
| 627 | Comparative | 0.300 | Nb | 0.037 | 0.110 | 0.020 | 0.000 | 0.010 |
| | example | | | | | | | |
| 628 | Comparative | 0.300 | Nb | 0.085 | 0.080 | 0.020 | 0.000 | 0.000 |
| | example | | | | | | | |
| 629 | Comparative | 0.300 | Nb | 0.085 | 0.080 | 0.020 | 0.000 | 0.000 |
| | example | | | | | | | |
| | ((Fe₍₁₋ₐ₎Coₐ)_{(1-γ)} | | | | | | | Corrosion |
| | X1_{γ})_{(1-(a+b+c+d-e))} | | | | | | Corrosion | current |
| | BₐP_{b}Si_{c}C_{d}Crₑ | Mn | Heat | | Amorphous | | potential | density |
| Sample | Cr | f | treat- | Crystal | ratio | Bs | (Ecorr) | (icorr) |
| No. | e | (at %) | ment | structure | (%) | (T) | (mV) | (μA/cm²) |
| 173 | 0.010 | 0.040 | None | Amorphous | 100 | 1.69 | −540 | 20.1 |
| 625 | 0.010 | 0.040 | Done | Nanocrystal | 10 | 1.73 | −593 | 37.9 |
| 626 | 0.010 | 0.040 | None | Amorphous | 100 | 1.48 | −526 | 24.7 |
| 627 | 0.010 | 0.040 | Done | Nanocrystal | 10 | 1.49 | −662 | 49.0 |
| 628 | 0.010 | 0.040 | None | Amorphous | 100 | 1.23 | −401 | 16.9 |
| 629 | 0.010 | 0.040 | Done | Nanocrystal | 10 | 1.54 | −680 | 68.9 |

Table 10 shows results of examples and comparative examples using samples of γ=0, 0.037, and γ=0.085; and for each sample two different tests were performed, that is, one with heat treatment and one without heat treatment. By decreasing the amorphous ratio X, Bs improved, however the corrosion resistance decreased. Also, when the X1 amount (γ) was too large, Bs and/or the corrosion resistance decreased.

### Experiment Example 2

The raw material metals were weighed so to match with the alloy compositions of examples and comparative examples shown in Table 1 to Table 10, then these were melted by high frequency heating to produce the mother alloy. When the raw material metals were melted, materials other than Mn were melted in advance to obtain a molten alloy, then Mn was added and melted.

The produced mother alloy was heated and melted to form a metal in a melted state of 1500° C., then the soft magnetic alloy powder having the alloy composition of each sample was produced by gas atomization method. Specifically, when the melted mother alloy was exhausted from an exhaust port towards a cooling part in the cylinder, a high-pressured gas was sprayed to the exhausted molten metal drop. Note that, the high-pressured gas was N₂ gas. The molten metal drop was cool solidified by colliding against the cooling part (cooling water), thereby the soft magnetic alloy powder was formed. Note that, conditions of gas atomization method were regulated accordingly so to obtain the soft magnetic alloy powder satisfying the average particle size and the average Wadell's circularity shown in Table 1 to 10. Specifically, an injection amount of the molten was varied within a range of 0.5 to 4 kg/min, a gas spraying pressure was varied within a range of 2 to 10 MPa, and a cooling water pressure was varied within a range of 7 to 19 MPa.

ICP analysis confirmed that the composition of the mother alloy roughly matched with the composition of the powder.

Each obtained powder was performed with X-ray crystallography, and an amorphous ratio X was measured. When the amorphous ratio X was 85% or more, the powder was considered as formed of amorphous. When the amorphous ratio X was less than 85% and the average crystal size was 30 nm or less, then the powder was considered as formed of nanocrystals. When the amorphous ratio X was less than 85% and the average crystal size was more than 30 nm, the powder was considered as formed of crystals. Note that, the crystal structures of Experiment example 1 (ribbon) all matched with the crystal structures of Experiment example 2 (powder).

The average particle size and the average Wadell's circularity of the obtained soft magnetic alloy powder were measured by the above-mentioned method. Also, ICP analysis confirmed that the composition of the mother alloy was about the same as the composition of the powder.

Table 1A to Table 1M show results of examples and comparative examples which were carried out under the same conditions except for varying the Co amount (α) with respect to Fe and the Mn amount (f). Including the examples shown in Table 2 to Table 12, when the Co amount (α) with respect to Fe, the Mn amount (f), and the like were within the predetermined ranges, Bs and the corrosion resistance were good. Further, the average Wadell's circularity was 0.80 or more. On the other hand, when the Co amount (α) with respect to Fe was too small and the Mn amount was out of the predetermined range, the corrosion resistance decreased. Also, when the Co amount (α) with respect to Fe was too large, Bs decreased. Further, when the Co amount was within the predetermined range and the Mn amount was too small, the average Wadell's circularity decreased. When the Mn amount was too large, crystals were formed in the soft magnetic alloy powder and the amorphous ratio X was less than 85%.

### Experiment Example 3

In Experiment example 3, a toroidal core was produced by using the soft magnetic alloy powder having the composition shown in Table 11 and Table 12. Table 11 shows samples in which the Co amount (α) with respect to Fe and/or the average particle size were varied when P and Cr were included; and Table 11 also shows samples in which the Co amount (α) with respect to Fe and/or the average particle size were varied when P and Cr were not included. Table 12 shows samples in which the amorphous ratio X was varied by changing the amount of the molten metal drop. Note that, the soft magnetic alloy powder produced in Experiment example 2 was used for examples shown in Table 11 and examples having the amorphous ratio X of 100% shown in Table 12. As for the sample numbers, the same sample numbers used in Experiment example 2 were used.

The soft magnetic alloy powders of examples shown in Table 11 and Table 12 all exhibited a good Bs. Also, the soft magnetic alloy powders of examples shown in Table 11 and Table 12 were visually confirmed to have a gray metallic color. From this point, it was confirmed that the soft magnetic alloy powders of examples shown in Table 11 and Table 12 had good Bs. On the other hand, it was confirmed by a visual observation that the soft magnetic alloy powders of the comparative examples shown in Table 11 and Table 12 had reddish-brown color. From this point, it was confirmed that the soft magnetic alloy powders did not have a good corrosion resistance.

Hereinafter, a method of producing the toroidal core according to the present experiment examples is described. First, the soft magnetic alloy powder and the resin (phenol resin) were mixed. The resin was mixed so that the amount of the resin was 2 mass % with respect to the soft magnetic alloy powder. Next, as a stirrer, a general planetary mixer was used to produce a granulated powder having a particle size of 500 μm or so. Next, the granulated powder was pressure compacted to produce a green compact of toroidal core shape having an outer diameter of 11 mmφ, an inner diameter of 6.5 mmφ, and a height of 6.0 mm. A surface pressure was regulated to 2 ton/cm² (192 MPa) to 10 ton/cm² (980 MPa) so that a packing density was 72% to 73% or so. The obtained green compact was cured at 150° C., then the toroidal core was obtained. These cores were produced for the numbers necessary to carry out the below tests.

### <Packing Density>

A density of each toroidal core was calculated from size and mass of the toroidal core. Next, the calculated density of the toroidal core was divided by a true density which is a density calculated from a mass ratio of the soft magnetic alloy powder, thereby the packing density (relative density) was calculated.

### <Relative Permeability>

For each toroidal core, a relative permeability was measured at a measuring frequency of 100 kHz using a LCR meter (LCR428A made by HP) by winding a wire for 12 turns.

### <Iron Loss>

For each toroidal core, a primary wire was wound around for 20 turns and a secondary wire was wound around for 14 turns. Then, iron loss at 300 kHz, 50 mT, under the temperature range of 20° C. to 25° C. was measured using a BH analyzer (SY-8232 made by IWATSU ELECTRIC CO., LTD.).

TABLE 11

| | Example/ | (Fe₍₁₋ₐ₎Coₐ)_{(1-(a+b+c+d-e))}BₐP_{b}Si_{c}C_{d}Crₑ (β = 0) | | | | | |
|---|---|---|---|---|---|---|---|
| Sample | Comparative | | B | P | Si | C | Cr |
| No. | example | a | a | b | c | d | e |
| 167 | Comparative | 0.000 | 0.110 | 0.020 | 0.030 | 0.010 | 0.010 |
| | example | | | | | | |
| 170 | Example | 0.050 | 0.110 | 0.020 | 0.030 | 0.010 | 0.010 |
| 172 | Example | 0.150 | 0.110 | 0.020 | 0.030 | 0.010 | 0.010 |
| 173 | Example | 0.300 | 0.110 | 0.020 | 0.030 | 0.010 | 0.010 |
| 174 | Example | 0.450 | 0.110 | 0.020 | 0.030 | 0.010 | 0.010 |
| 176 | Example | 0.600 | 0.110 | 0.020 | 0.030 | 0.010 | 0.010 |
| 173a | Example | 0.300 | 0.110 | 0.020 | 0.030 | 0.010 | 0.010 |
| 173b | Example | 0.300 | 0.110 | 0.020 | 0.030 | 0.010 | 0.010 |
| 173c | Example | 0.300 | 0.110 | 0.020 | 0.030 | 0.010 | 0.010 |
| 173 | Example | 0.300 | 0.110 | 0.020 | 0.030 | 0.010 | 0.010 |
| 173d | Example | 0.300 | 0.110 | 0.020 | 0.030 | 0.010 | 0.010 |
| 173e | Example | 0.300 | 0.110 | 0.020 | 0.030 | 0.010 | 0.010 |
| 364 | Comparative | 0.000 | 0.140 | 0.000 | 0.050 | 0.020 | 0.000 |
| | example | | | | | | |
| 412 | Example | 0.050 | 0.140 | 0.000 | 0.050 | 0.020 | 0.000 |
| 436 | Example | 0.150 | 0.140 | 0.000 | 0.050 | 0.020 | 0.000 |
| 448 | Example | 0.300 | 0.140 | 0.000 | 0.050 | 0.020 | 0.000 |
| 460 | Example | 0.450 | 0.140 | 0.000 | 0.050 | 0.020 | 0.000 |
| 484 | Example | 0.600 | 0.140 | 0.000 | 0.050 | 0.020 | 0.000 |
| 448a | Example | 0.300 | 0.140 | 0.000 | 0.050 | 0.020 | 0.000 |
| 448b | Example | 0.300 | 0.140 | 0.000 | 0.050 | 0.020 | 0.000 |
| 448c | Example | 0.300 | 0.140 | 0.000 | 0.050 | 0.020 | 0.000 |
| 448 | Example | 0.300 | 0.140 | 0.000 | 0.050 | 0.020 | 0.000 |
| 448d | Example | 0.300 | 0.140 | 0.000 | 0.050 | 0.020 | 0.000 |
| 448e | Example | 0.300 | 0.140 | 0.000 | 0.050 | 0.020 | 0.000 |
| | | | Average | | | | |
| | Mn | | particle | Average | Packing | | |
| Sample | f | Bs | size | Wadell | density | Relative | Iron loss |
| No. | (at %) | (T) | (μm) | circularity | (%) | permeability | (mW/c c) |
| 167 | 0.040 | 1.57 | 18.9 | 0.90 | 72.2 | 31.1 | 1543 |
| 170 | 0.040 | 1.68 | 20.1 | 0.91 | 71.8 | 33.9 | 1589 |
| 172 | 0.040 | 1.68 | 19.1 | 0.94 | 72.3 | 34.2 | 1534 |
| 173 | 0.040 | 1.69 | 21.2 | 0.94 | 72.3 | 34.1 | 1562 |
| 174 | 0.040 | 1.69 | 19.0 | 0.94 | 72.4 | 34.2 | 1543 |
| 176 | 0.040 | 1.62 | 20.6 | 0.93 | 72.5 | 34.6 | 1510 |
| 173a | 0.040 | 1.72 | 1.1 | 0.97 | 72.3 | 32.2 | 1240 |
| 173b | 0.040 | 1.72 | 5.3 | 0.96 | 72.1 | 32.4 | 1340 |
| 173c | 0.040 | 1.72 | 9.8 | 0.95 | 72.3 | 33.3 | 1450 |
| 173 | 0.040 | 1.69 | 21.2 | 0.94 | 72.3 | 34.1 | 1562 |
| 173d | 0.040 | 1.72 | 50.4 | 0.93 | 72.4 | 34.2 | 1890 |
| 173e | 0.040 | 1.72 | 149.8 | 0.89 | 72.3 | 34.3 | 2150 |
| 364 | 0.040 | 1.63 | 20.2 | 0.91 | 72.2 | 30.1 | 1643 |
| 412 | 0.040 | 1.69 | 20.0 | 0.91 | 72.4 | 33.1 | 1632 |
| 436 | 0.040 | 1.73 | 19.6 | 0.94 | 72.3 | 33.4 | 1654 |
| 448 | 0.040 | 1.74 | 20.5 | 0.94 | 72.3 | 33.5 | 1643 |
| 460 | 0.040 | 1.75 | 21.4 | 0.95 | 72.4 | 33.5 | 1644 |
| 484 | 0.040 | 1.61 | 18.7 | 0.93 | 72.1 | 33.1 | 1654 |
| 448a | 0.040 | 1.74 | 0.9 | 0.97 | 72.3 | 32.4 | 1320 |
| 448b | 0.040 | 1.74 | 5.2 | 0.96 | 72.1 | 33.6 | 1350 |
| 448c | 0.040 | 1.74 | 10.2 | 0.96 | 72.3 | 33.3 | 1480 |
| 448 | 0.040 | 1.74 | 20.5 | 0.94 | 72.3 | 33.5 | 1643 |
| 448d | 0.040 | 1.74 | 50.4 | 0.92 | 72.4 | 32.2 | 1910 |
| 448e | 0.040 | 1.74 | 148.8 | 0.90 | 72.3 | 33.3 | 2200 |

TABLE 12

| | Example/ | (Fe₍₁₋ₐ₎Coₐ)_{(1-(a+b+c+d-e))}BₐP_{b}Si_{c}C_{d}Crₑ (β = 0) | | | | | |
|---|---|---|---|---|---|---|---|
| Sample | Comparative | | B | P | Si | C | Cr |
| No. | example | a | a | b | c | d | e |
| 173 | Example | 0.300 | 0.110 | 0.020 | 0.030 | 0.010 | 0.010 |
| 630 | Example | 0.300 | 0.110 | 0.020 | 0.030 | 0.010 | 0.010 |
| 631 | Example | 0.300 | 0.110 | 0.020 | 0.030 | 0.010 | 0.010 |
| 632 | Example | 0.300 | 0.110 | 0.020 | 0.030 | 0.010 | 0.010 |
| 633 | Example | 0.300 | 0.110 | 0.020 | 0.030 | 0.010 | 0.010 |
| | | | Average | | | | |
| | Mn | | particle | Average | Packing | | |
| Sample | f | Bs | size | Wadell | density | Relative | Iron loss |
| No. | (at %) | (T) | (μm) | circularity | (%) | permeability | (mW/c c) |
| 173 | 0.040 | 1.69 | 21.2 | 0.94 | 72.3 | 34.1 | 1562 |
| 630 | 0.040 | 1.69 | 20.4 | 0.94 | 72.4 | 34.2 | 1570 |
| 631 | 0.040 | 1.69 | 20.1 | 0.95 | 72.5 | 34.2 | 1580 |
| 632 | 0.040 | 1.70 | 20.3 | 0.94 | 72.4 | 31.0 | 1620 |
| 633 | 0.040 | 1.72 | 20.3 | 0.94 | 73.2 | 31.2 | 1730 |

According to Table 11, when the toroidal core was produced by using the soft magnetic alloy powder having a composition such as the Co amount (α) with respect to Fe and the like within the predetermined ranges, a higher relative permeability was obtained compared to comparative examples of which the Co amount (α) with respect to Fe was too small. Also, the iron loss tended to increase as the average particle size increased.

According to Table 12, when the amorphous ratio X was 85% or more, the relative permeability was higher and the iron loss was lower compared to the case in which the amorphous ratio X was less than 85%.

Table 1 to Table 12 show the compositions of which the oxygen amount was converted to γ and considered that γ was γ=0. Strictly, the oxygen amount was converted into γ and γ was within a range of 0≤γ<0.030. The soft magnetic alloy ribbon shown in Table 1 to Table 12 exhibited the same Bs as that obtained from the soft magnetic alloy powder having the same composition. Further, all of the soft magnetic alloy ribbons shown in Table 1 to Table 12 can be considered as the soft magnetic alloy ribbons for measurement of the soft magnetic alloy powder having the same composition. When the corrosion potential and the corrosion current density of the soft magnetic alloy ribbons for measurement were good, it was confirmed by visual observation that the soft magnetic alloy powders of examples having the same compositions had gray metallic color. On the other hand, when the corrosion potential and the corrosion current density of the soft magnetic alloy ribbons for measurement were not good, it was confirmed by visual observation that the soft magnetic alloy powders of comparative examples having the same compositions had reddish brown color. From this point, it can be confirmed that the soft magnetic alloy powders of the comparative examples had a poor corrosion resistance.

### Experiment Example 4

In Experiment example 4, the soft magnetic alloy powder having the composition shown in Table 13 was produced. By changing the oxygen concentration in the spraying gas as shown in Table 13, the oxygen amount in the obtained soft magnetic alloy powder was changed and the X1 amount (γ) was changed. Then, the toroidal core was produced. Results are shown in Table 13.

TABLE 13

| | Example/ | ((Fe₁₋ₐCoₐ)_{(1-γ)}X1γ)_{(1-(a+b+c+d-e))}BₐP_{b}Si_{c}C_{d}Crₑ | | | | | | | Mn/ |
|---|---|---|---|---|---|---|---|---|---|
| Sample | Comparative | | B | P | Si | C | Cr | X1 = O | at % |
| No. | example | a | a | b | c | d | e | γ | f |
| 173A | Example | 0.300 | 0.110 | 0.020 | 0.030 | 0.010 | 0.010 | 0.000 | 0.040 |
| 173B | Example | 0.300 | 0.110 | 0.020 | 0.030 | 0.010 | 0.010 | 0.001 | 0.040 |
| 173C | Example | 0.300 | 0.110 | 0.020 | 0.030 | 0.010 | 0.010 | 0.003 | 0.040 |
| 173D | Example | 0.300 | 0.110 | 0.020 | 0.030 | 0.010 | 0.010 | 0.006 | 0.040 |
| 173E | Example | 0.300 | 0.110 | 0.020 | 0.030 | 0.010 | 0.010 | 0.026 | 0.040 |
| 173F | Comparative | 0.300 | 0.110 | 0.020 | 0.030 | 0.010 | 0.010 | 0.066 | 0.040 |
| | example | | | | | | | | |
| 639A | Example | 0.300 | 0.110 | 0.020 | 0.030 | 0.010 | 0.010 | 0.000 | 1.000 |
| 639B | Example | 0.300 | 0.110 | 0.020 | 0.030 | 0.010 | 0.010 | 0.001 | 1.000 |
| 639C | Example | 0.300 | 0.110 | 0.020 | 0.030 | 0.010 | 0.010 | 0.003 | 1.000 |
| 639D | Example | 0.300 | 0.110 | 0.020 | 0.030 | 0.010 | 0.010 | 0.005 | 1.000 |
| 639E | Example | 0.300 | 0.110 | 0.020 | 0.030 | 0.010 | 0.010 | 0.019 | 1.000 |
| 639F | Comparative | 0.300 | 0.110 | 0.020 | 0.030 | 0.010 | 0.010 | 0.048 | 1.000 |
| | example | | | | | | | | |
| 448A | Example | 0.300 | 0.140 | 0.000 | 0.050 | 0.020 | 0.000 | 0.000 | 0.040 |
| 448B | Example | 0.300 | 0.140 | 0.000 | 0.050 | 0.020 | 0.000 | 0.001 | 0.040 |
| 448C | Example | 0.300 | 0.140 | 0.000 | 0.050 | 0.020 | 0.000 | 0.003 | 0.040 |
| 448D | Example | 0.300 | 0.140 | 0.000 | 0.050 | 0.020 | 0.000 | 0.006 | 0.040 |
| 448E | Example | 0.300 | 0.140 | 0.000 | 0.050 | 0.020 | 0.000 | 0.028 | 0.040 |
| 448F | Comparative | 0.300 | 0.140 | 0.000 | 0.050 | 0.020 | 0.000 | 0.063 | 0.040 |
| | example | | | | | | | | |
| 451A | Example | 0.300 | 0.140 | 0.000 | 0.050 | 0.020 | 0.000 | 0.000 | 1.000 |
| 451B | Example | 0.300 | 0.140 | 0.000 | 0.050 | 0.020 | 0.000 | 0.001 | 1.000 |
| 451C | Example | 0.300 | 0.140 | 0.000 | 0.050 | 0.020 | 0.000 | 0.003 | 1.000 |
| 451D | Example | 0.300 | 0.140 | 0.000 | 0.050 | 0.020 | 0.000 | 0.005 | 1.000 |
| 451E | Example | 0.300 | 0.140 | 0.000 | 0.050 | 0.020 | 0.000 | 0.019 | 1.000 |
| 451F | Comparative | 0.300 | 0.140 | 0.000 | 0.050 | 0.020 | 0.000 | 0.044 | 1.000 |
| | example | | | | | | | | |
| | | Oxygen | | | Average | | | | |
| | | concentration | | | particle | Average | Packing | | |
| | Sample | in spraying | Crystal | Bs | size | Wadell | density | Relative | Iron loss |
| | No. | gas (%) | structure | (T) | (μm) | circularity | (%) | permeability | (mW/c c) |
| | 173A | 0 | Amorphous | 1.69 | 20.2 | 0.94 | 72.3 | 34.1 | 1562 |
| | 173B | 0.01 | Amorphous | 1.69 | 20.5 | 0.94 | 72.5 | 34.1 | 1542 |
| | 173C | 0.1 | Amorphous | 1.69 | 20.4 | 0.94 | 72.4 | 34.0 | 1540 |
| | 173D | 0.5 | Amorphous | 1.69 | 20.1 | 0.95 | 72.5 | 33.8 | 1510 |
| | 173E | 1 | Amorphous | 1.69 | 20.3 | 0.94 | 72.4 | 32.9 | 1510 |
| | 173F | 5 | Amorphous | 1.65 | 20.4 | 0.95 | 72.5 | 29.3 | 2050 |
| | 639A | 0 | Amorphous | 1.67 | 19.9 | 0.95 | 72.3 | 34.3 | 1530 |
| | 639B | 0.01 | Amorphous | 1.67 | 20.3 | 0.94 | 72.4 | 34.2 | 1522 |
| | 639C | 0.1 | Amorphous | 1.67 | 20.0 | 0.94 | 72.1 | 34.3 | 1521 |
| | 639D | 0.5 | Amorphous | 1.67 | 20.2 | 0.95 | 72.4 | 33.9 | 1510 |
| | 639E | 1 | Amorphous | 1.67 | 20.1 | 0.95 | 72.2 | 33.0 | 1489 |
| | 639F | 5 | Amorphous | 1.65 | 20.4 | 0.95 | 72.5 | 29.4 | 2020 |
| | 448A | 0 | Amorphous | 1.74 | 20.5 | 0.94 | 72.3 | 33.5 | 1643 |
| | 448B | 0.01 | Amorphous | 1.74 | 20.3 | 0.94 | 72.3 | 33.5 | 1645 |
| | 448C | 0.1 | Amorphous | 1.74 | 20.3 | 0.94 | 72.3 | 33.4 | 1643 |
| | 448D | 0.5 | Amorphous | 1.74 | 20.1 | 0.94 | 72.1 | 33.4 | 1650 |
| | 448E | 1 | Amorphous | 1.74 | 20.5 | 0.94 | 72.4 | 32.3 | 1630 |
| | 448F | 5 | Amorphous | 1.74 | 20.4 | 0.95 | 72.3 | 29.1 | 2100 |
| | 451A | 0 | Amorphous | 1.72 | 20.1 | 0.96 | 72.1 | 33.6 | 1630 |
| | 451B | 0.01 | Amorphous | 1.72 | 20.1 | 0.95 | 72.3 | 33.5 | 1620 |
| | 451C | 0.1 | Amorphous | 1.72 | 20.4 | 0.95 | 72.3 | 33.5 | 1620 |
| | 451D | 0.5 | Amorphous | 1.72 | 20.3 | 0.94 | 72.5 | 33.2 | 1630 |
| | 451E | 1 | Amorphous | 1.72 | 20.2 | 0.94 | 72.3 | 32.1 | 1650 |
| | 451F | 5 | Amorphous | 1.72 | 20.3 | 0.95 | 72.1 | 28.9 | 2300 |

Examples and comparative examples shown in Table 13 all exhibited good Bs. The soft magnetic alloy powders of examples shown in Table 13 were confirmed by visual observation that these had metallic gray color. From this point as well, the soft magnetic alloy powders of examples of Table 13 were confirmed to have good corrosion resistance. On the other hand, the soft magnetic alloy powders of comparative examples in which γ was too large, the reddish brown color was confirmed by visual observation.

Further, when the toroidal core was produced using the soft magnetic alloy powder of the example satisfying 0≤γ<0.030, a higher relative permeability and a lower iron loss were obtained compared to the case of producing the toroidal core having about the same packing density by using the soft magnetic alloy powder of each example in which γ was γ≥0.030.

### Experiment Example 5

In Experiment example 5, the compositions of the soft magnetic alloy powders shown in Table 13 included in the toroidal core were verified by 3DAP, soft magnetic alloy ribbons having the same compositions as the soft magnetic alloy powder shown in Table 13 were produced. Regarding the soft magnetic alloy ribbons, Bs, the corrosion potential, and the corrosion current density were measured. Results are shown in Table 14.

TABLE 14

| | | | | | | | Corrosion |
|---|---|---|---|---|---|---|---|
| | | | | | | Corrosion | current |
| | Example/ | | Mn | | | potential | density |
| Sample | Comparative | X1 = O | f | Crystal | Bs | (Ecorr) | (icorr) |
| No. | example | γ | (at %) | structure | (T) | (mV) | (μA/cm²) |
| 173A2 | Example | 0.000 | 0.040 | Amorphous | 1.69 | −540 | 20.1 |
| 173B2 | Example | 0.001 | 0.040 | Amorphous | 1.69 | −540 | 20.1 |
| 173C2 | Example | 0.003 | 0.040 | Amorphous | 1.69 | −540 | 20.1 |
| 173D2 | Example | 0.006 | 0.040 | Amorphous | 1.69 | −538 | 20.4 |
| 173E2 | Example | 0.026 | 0.040 | Amorphous | 1.69 | −534 | 20.3 |
| 639A2 | Example | 0.000 | 1.000 | Amorphous | 1.67 | −520 | 18.3 |
| 639B2 | Example | 0.001 | 1.000 | Amorphous | 1.67 | −520 | 18.3 |
| 639C2 | Example | 0.003 | 1.000 | Amorphous | 1.67 | −520 | 18.3 |
| 639D2 | Example | 0.005 | 1.000 | Amorphous | 1.67 | −521 | 19.3 |
| 639E2 | Example | 0.019 | 1.000 | Amorphous | 1.67 | −520 | 19.0 |
| 448A2 | Example | 0.000 | 0.040 | Amorphous | 1.74 | −570 | 32.1 |
| 448B2 | Example | 0.001 | 0.040 | Amorphous | 1.74 | −570 | 32.1 |
| 448C2 | Example | 0.003 | 0.040 | Amorphous | 1.74 | −570 | 32.1 |
| 448D2 | Example | 0.006 | 0.040 | Amorphous | 1.74 | −574 | 33.4 |
| 448E2 | Example | 0.028 | 0.040 | Amorphous | 1.74 | −573 | 33.5 |
| 451A2 | Example | 0.000 | 1.000 | Amorphous | 1.72 | −545 | 28.1 |
| 451B2 | Example | 0.001 | 1.000 | Amorphous | 1.72 | −545 | 28.1 |
| 451C2 | Example | 0.003 | 1.000 | Amorphous | 1.72 | −545 | 28.1 |
| 451D2 | Example | 0.005 | 1.000 | Amorphous | 1.72 | −544 | 28.3 |
| 451E2 | Example | 0.019 | 1.000 | Amorphous | 1.72 | −544 | 28.3 |

According to Table 14, all of the soft magnetic alloy ribbons from examples exhibited good Bs, corrosion potential, and corrosion current density.

When the compositions of the soft magnetic alloy powders produced by converting the oxygen amount to γ and varying γ within a range of 0≤γ<0.030 were verified by 3DAP, and the soft magnetic alloy ribbons having the same compositions as the soft magnetic alloy powders were produced, the corrosion potential and the corrosion current density of the produced soft magnetic alloy ribbons did not change significantly which can be seen from Table 14. Further, when the soft magnetic alloy ribbon for measurement was produced by converting the oxygen amount to γ and varying γ within a range of 0≤γ≤0.003, the corrosion potential and the corrosion current density of the produced soft magnetic alloy ribbon did not change.

As discussed hereinabove, the soft magnetic alloy ribbon for measurement for measuring the corrosion potential and the corrosion current density of the soft magnetic alloy powder in which the oxygen amount was converted to γ and γ was within a range of 0≤γ<0.030 was confirmed to be good as a soft magnetic alloy ribbon having the same composition except for γ being within a range of 0≤γ≤0.003. In detail, the corrosion potential and the corrosion current density of the soft magnetic alloy ribbon did not change when the oxygen amount was within a range of 0≤γ≤0.003, hence the corrosion potential and the corrosion current density of the soft magnetic alloy powder which were difficult to directly measure can be measured by using the soft magnetic alloy ribbon having the oxygen amount within the range of 0≤γ≤0.003. Further, when the oxygen amount was converted to γ and γ was within a range of 0≤γ<0.030 as shown in Table 1 to Table 12, it was confirmed that usually there was no problem to consider that oxygen was not included.

1. A soft magnetic alloy comprising Mn and a component expressed by a compositional formula of ((Fe_{(1-(α+β))}Co_{α}Ni_{β})_{1-γ}X1_{γ})_{(1-(a+b+c+d+e>>}BₐP_{b}Si_{c}C_{d}Crₑ (atomic ratio), wherein
Mn amount f (at %) is within a range of 0.002≤f<3.0,
X1 is one or more selected from Ti, Zr, Hf, Nb, Ta, Mo, W, Al, Ga, Ag, Zn, S, Ca, Mg, V, Sn, As, Sb, Bi, N, O, Au, Cu, rare earth elements, and platinum group elements,
a, b, c, d, e, α, β, and γ of the compositional formula are within in ranges of
0.020≤a≤0.200,
0≤b≤0.070,
0≤c≤0.100,
0≤d≤0.050,
0≤e≤0.040,
0.005≤α≤0.700,
0≤β≤0.200,
0≤γ<0.030, and
0.720≤1−(a+b+c+d+e)≤0.900; and
the soft magnetic alloy satisfies a corrosion potential of −630 mV or more and −50 mV or less and a corrosion current density of 0.3 μA/cm² or more and 45 μA/cm² or less which are calculated by Tafel extrapolation method from potential and current measured using LSV method in 0.5 mol/L of NaCl solution when a natural potential is a standard potential, a range of measuring potential is −0.3 V to 0.3 V, and a potential scanning rate is 0.833 mV/s.

2. The soft magnetic alloy according to claim 1, wherein 0.003≤f/α(1−γ){1−(a+b+c+d+e)}≤710 is satisfied.

3. The soft magnetic alloy according to claim 1, wherein 0.050≤α≤0.600 is satisfied.

4. The soft magnetic alloy according to claim 1, wherein 0.100≤α≤0.500 and 0.050≤f/α(1−γ){1−(a+b+c+d+e)}≤8.0 are satisfied.

5. The soft magnetic alloy according to claim 1, wherein 0.001≤e≤0.020 and 1.00≤α(1−γ){1−(a+b+c+d+e)}×e×10000≤50.0 are satisfied.

6. The soft magnetic alloy according to claim 1, wherein 0≤b≤0.050 is satisfied.

7. The soft magnetic alloy according to claim 1, wherein 0.780≤1−(a+b+c+d+e)≤0.890 is satisfied.

8. The soft magnetic alloy according to claim 1, wherein 0.001≤β≤0.050 is satisfied.

9. The soft magnetic alloy according to claim 1, wherein 0≤γ≤0.030 is satisfied.

10. The soft magnetic alloy according to claim 1, wherein an amorphous ratio X shown by below formula (1) is 85% or more.
X=100−(Ic/(Ic+Ia)×100) (1)
Ic: Crystal scattering integrated intensity
Ia: Amorphous scattering integrated intensity

11. The soft magnetic alloy according to claim 1 which is in a form of powder.

12. The soft magnetic alloy according to claim 11, wherein powder particles included in the soft magnetic alloy which is in a form of powder has an average Wadell's circularity of 0.80 or more.

13. A magnetic component made of the soft magnetic alloy according to claim 1.
